(19) United States
(12) Patent Application Publication
(10) Pub. No.: US 2013/0173366 A1
(43) Pub. Date: Jul. 4, 2013

(54) Processing of Electronic Referral Hyperlinks

(71) Applicant: George Cox Beighley, JR., Columbia, SC (US)

(72) Inventor: George Cox Beighley, JR., Columbia, SC (US)

(21) Appl. No.: 13/552,011

(22) Filed: Jul. 18, 2012

Related U.S. Application Data
(60) Provisional application No. 61/508,880, filed on Jul. 18, 2011.
(60) Provisional application No. 61/573,064, filed on Aug. 23, 2011.
(60) Provisional application No. 61/555,628, filed on Nov. 4, 2011.
(60) Provisional application No. 61/589,521, filed on Jan. 23, 2012.

(51) Int. Cl. G06Q 30/02

(52) U.S. Cl. CPC G06Q 30/0214
USPC 705/14.16; 705/26.7

(57) ABSTRACT

A computer-implemented method is performed at a computer of a merchant. A list of one or more items available for referral is displayed. Each item is a product offered by the merchant or associated with the merchant. A first message is received from a referring party indicating that the referring party desires to refer a selected item from the list. A referring party account is created at the computer of the merchant, for the referring party. A referral hyperlink is created for referral of the selected item. The referral hyperlink includes first data identifying the selected item.

### PRIORITY CLAIM

This application claims priority under 35 U.S.C. §119(e) from U.S. Provisional Pat. App. Ser. Nos. 61/508,880 entitled “Method and Apparatus for Computer-Based Processing of Referral and Discount Programs” filed Jul. 18, 2011; 61/573,064 entitled “Apparatus and Method for Computer-Based Referral and Discount Programs” filed Aug. 23, 2011; 61/555,628 entitled “Method and Apparatus for Referring Goods, Services and Intellectual Property” filed Nov. 4, 2011; and 61/589,521 entitled “Electronic Referral System and Methods” filed Jan. 23, 2012, which are hereby incorporated by reference herein in their entireties.

### BACKGROUND

Modern telecommunications networks have transformed the ways in which people interact with one another in various facets of life. Networks such as the Internet have connected people, companies, and institutions in myriad ways and have provided new opportunities for commerce and messaging, among other endeavors. The World Wide Web (“WWW” or “the web”) has ushered in new modalities for consuming, processing, and delivering information. Hypertext, which is the underlying concept defining the structure of the web, is content (typically text, but possibly images or various other types of media) displayed on a computer or other electronic device with hyperlinks to other content that the viewer can access. Hyperlinks connect the web, e.g., in accordance with networking protocols such as HTTP or secure versions thereof, and allow people to surf the web, e.g., from one web page to another, to access various types of content.

The proliferation of technologies such as social networking and social media have also forged new bonds between people who may be located in disparate places on the globe but are able to communicate electronically. Various popular technologies enable users to “blog” about their interests or activities, form friendship-like connections with other users, provide status updates to others or “follow” activities of others, and otherwise remain up-to-date on the details of other people's lives in ways that have not been possible without the Internet.

### SUMMARY

In some embodiments, a computer-implemented method is performed at a computer of a merchant. A list of one or more items available for referral is displayed. Each item is a product offered by the merchant or associated with the merchant. A first message is received from a referring party indicating that the referring party desires to refer a selected item from the list. A referring party account is created at the computer of the merchant, for the referring party. A referral hyperlink is created for referral of the selected item. The referral hyperlink includes first data identifying the selected item.

In some embodiments, a method includes receiving a first electronic message from a first party who desires to obtain discounts from a merchant based on referrals of items offered by or associated with the merchant. The first message includes first identification information for identifying the first party. A referred user account is created for the first party, at a computer of the merchant. The referred user account includes discount information. A second electronic message is received upon activation of a referral hyperlink by the first party. The second message includes first data identifying a second party that sent the referral hyperlink to the first party, second data identifying one or more of the items, and third data specifying a discount. The second message is parsed to determine the first, second, and third data. A third electronic message is received. The third message associates the first party with the referred user account. The referred user account is updated to indicate that the discount is redeemable by the first party, that the referral hyperlink was sent by the second party, and that the items identified by the second data were referred to the first party.

In some embodiments, a computer-implemented method is performed at a computer of a merchant. Information associated with a first referred user account is received from a central depository of information related to referrals. The first referred user account is stored at the central depository. Based on the received information, a second referred user account is created at the computer of the merchant. The second referred user account includes discount information associated with referral of one or more products offered by or associated with the merchant. A message is received from the central depository after activation of a referral hyperlink by a referred user. The message includes first data identifying the referred user and second data specifying a discount offered to the referred user for activation of the hyperlink. The discount information of the second referred user account is updated to indicate that the discount is redeemable by the referred user.

### BRIEF DESCRIPTION OF THE DRAWINGS

The following will be apparent from elements of the figures, which are provided for illustrative purposes and are not necessarily to scale.

FIG. 1 is a block diagram of an electronic referral system in accordance with some embodiments of the present disclosure.

FIG. 2 is a sequence diagram showing interactions between a merchant and a central depository in accordance with some embodiments.

FIG. 3 is a flow diagram showing activities at a central depository in accordance with some embodiments.

FIG. 4 is a sequence diagram showing interactions between a referred and a central depository in accordance with some embodiments.

FIG. 5 is a depiction of an example screenshot in accordance with some embodiments, showing various products available for referral by a referring user.

FIG. 6 is a depiction of an example screenshot in accordance with some embodiments, displayed when a referring user selects a specific product for referral.

FIG. 7 is a depiction of an example screenshot in accordance with some embodiments, showing account management details for a referring user's account at a payment depository.

FIG. 8 is a diagram of a computer system used in accordance with some embodiments.

FIG. 9 is a block diagram of an electronic referral system in accordance with some embodiments of the present disclosure.

FIG. 10 is a block diagram of a referral system in accordance with some embodiments.

FIG. 11 is a flow diagram of a process in accordance with some embodiments.

FIG. 12 is a flow diagram of a process in accordance with some embodiments.

FIG. 13 is a flow diagram of a process in accordance with some embodiments.

### DETAILED DESCRIPTION

This description of certain exemplary embodiments is intended to be read in connection with the accompanying drawings, which are to be considered part of the entire written description.

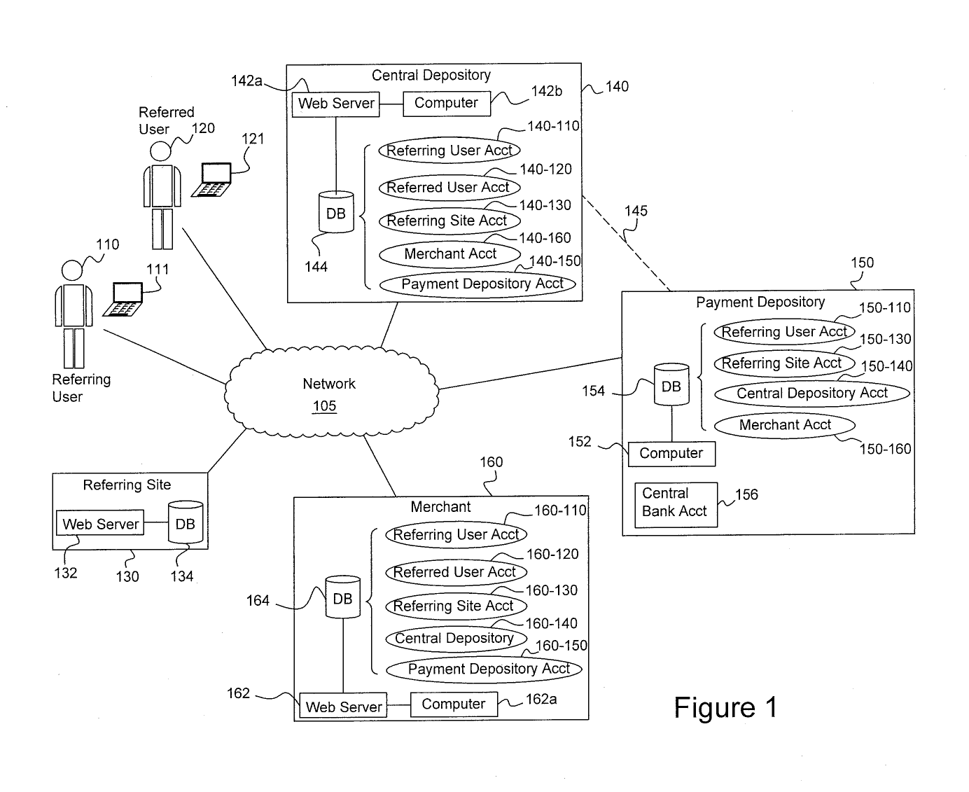

Some embodiments of the present disclosure provide automatic creation and processing of referral hyperlinks or advertisements in an electronic system to leverage many of the benefits of the Internet (e.g., speed, low cost, wide distribution) in the advertising context. A computer network 105 (e.g., the Internet) provides connections for transmitting data between various parties as shown in FIG. 1. Accounts stored at various parties' computer systems keep track of state information (e.g., who various parties are, what products are being sold or referred, who should be paid particular amounts based on product referrals). These accounts are described in greater detail in the section “Account Details” below. Messages are transmitted electronically, including hyperlinks that contain embedded information that can be parsed at a destination computer system. A brief description of various embodiments follows, and then more details on particular subsystems and techniques are provided later.

A merchant 160 offers or is associated with a product, which a referring user 110 or a website 130 (herein termed a “referring site”) refers (advertises) to others. Referring user 110 and referring site 130 may each be called a referring party. It is understood that where the term “referring site” is used in the context of taking an action, that action may be taken by a computer at the website or by a person operating, owning, administering, or controlling the website. Merchant 160 may be any entity that provides a product, which may be any good or service, e.g., a tangible good such as an LCD television, or a service such as a car wash or intangible property. In the case of intellectual property such as trademarks, merchant 160 may have a trademark that the merchant wishes to advertise (e.g., “XYZ TV Company”). In this case, the referring party may refer the trademark associated with the merchant rather than a particular good or service actually sold or offered for sale by the merchant, e.g., so that the referral is a referral of the merchant itself. As used herein, the term “merchant” may refer to an entity, a person associated with that entity, or a computer system associated with that entity; the usage makes clear which of these meanings is relevant. As used herein the term “merchant” specifically includes any website promoting her site by using the referral and discount process performed by the merchant. For example, the website could perform the auto-advertise function disclosed herein for a specific webpage, a site, or content contained on a page to effectively promote the website.

Referrals are implemented in some embodiments using hyperlinks that may have various types of information embedded within them as described further below. An individual 120 who receives such a hyperlink is called a “referred user” because the referring user 110 and/or referring site 130 referred a product to that individual. Referring user 110 and referring site 130 may also be called a “posting user” and “posting site,” respectively, because they can post (e.g., publish) referral hyperlinks. Referred user 120 may also be called a “purchasing user” because she may purchase a product based on a referral she received, although actual purchase is not required in some embodiments. Computers 111 and 121 may be used by referring user 110 and referred user 120, respectively, to access the Internet 105.

In some embodiments, a central depository of information related to referrals (“central depository” or “central depository system”) 140 coordinates various activities and information associated with the electronic referrals. The term “central” does not denote a particular spatial requirement but rather denotes that there may be one such entity that coordinates referral activities and information. A payment depository system (“payment depository”) 150 coordinates various activities and information associated with payments that are disbursed to certain parties based on referrals. In some embodiments, the payment depository 150 is the same as the central depository 140 or is connected to central depository 140 other than through network 105, e.g., as shown by dashed line 145. In some embodiments, the payment depository 150 is the same as the referring site 130.

Various parties or components shown in FIG. 1 may receive benefits based on participation in electronic referrals according to embodiments of the present disclosure. For example, the referring user 110 or referring site 130 may receive a monetary reward (e.g., in the form of a flat fee, a percentage of the price of the product referred, or some other variable reward), the referred user 120 may receive a monetary reward (e.g., a discount on the product referred), the merchant 160 may enjoy increased sales and/or advertising presence through successful referrals, and the central depository 140 and payment depository 150 may receive a monetary reward (e.g., a percentage of transaction revenues or profits). Because the referrals are disseminated electronically, numerous advantages associated with the Internet are available—fast delivery, low cost for reaching a wide audience, and reliable transmission. Referrals in various embodiments may take advantage of social networking, social media, and/or other electronic transmission mechanisms (including email) in which referred user 120 has trust in the referring user 110 and/or referring site 130.

A discount may be available due to an agreement by the merchant to sell a product to the referred user 120 at a price below a standard price applicable to users who do not activate the referral hyperlink. A discount is received by a referred user 120 by activating a hyperlink containing discount data. Thus, the discount rate may be a price reduction relative to retail price for the product, e.g., 10% of the standard retail price. Further, a discount may be a certain dollar amount the referred user 120 is entitled to receive off a purchase with the merchant such as 5 dollars off a purchase from Example Merchant. A referred user may accumulate discounts by activating hyperlinks. Each different actor (the central depository 140, the referring site 130, and the referring user 110) has the ability to provide the referred user 120 a discount. The discounts that each of these actors has the ability to give may be combined with each other to yield a greater discount. Further, discounts offered by multiple referring users and/or multiple referring sites may be combined with each other to yield a greater discount. The discount amount is stored on a central depository database 144 with the appropriate actor's account (e.g., 140-130 or 140-110). Upon activating a hyperlink, the central depository 140 compiles all the discounts the referred user 120 is entitled to for having activated hyperlinks, and stores the total discount associated with the item or merchant at the referred user account 140-120. The central depository 140 sends the total discount along with the referred user's identifying information to the merchant 160.

A referral rate pertains to money paid to referring user 110 or referring site 130 due to the activation of a hyperlink by referred user 120. This may be a percentage of the price of the corresponding product in one example. The payment of such referral rate compensation may occur upon the activation alone of the hyperlink or upon a sale following such activation. The referral rate may be a percentage of the price of the item, a flat fee paid per click, a pay per impression or a variable referral rate that may vary depending on various factors, including how successful referring user 110 has been at referring products. Upon receiving prompt 202, merchant 160 sends the requested information 204 to central depository 140.

Merchant 160, who seeks to advertise a product on the Internet (or possibly advertise the merchant itself, e.g., by advertising a trademark of merchant 160), has an account 140-160 created at the central depository 140. This account may be a collection of data associated with merchant 160. Various other accounts associated with other entities are also shown in FIG. 1.

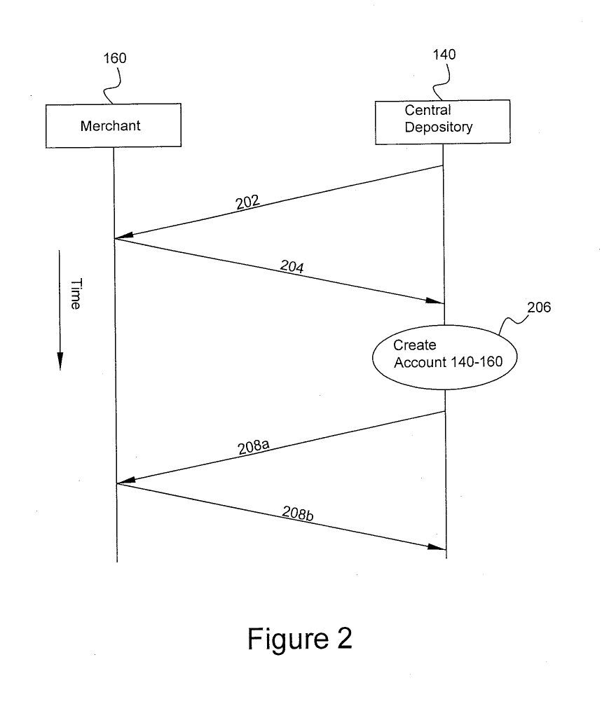

The merchant 160 receives prompt 202 (see FIG. 2) from the central depository 140 to identify one or more of the following: merchant 160, the address (e.g., physical address and/or electronic address such as URL and/or IP address) of merchant 160, the product offered (e.g., for sale or lease) by merchant 160, referral rate paid to referring user 110 or referring site 130 for referring the product, and any discount(s) available to referred user 120 for participating in the referral process (e.g., by activating a hyperlink associated with the referral).

The central depository 140 stores the foregoing information received from merchant 160 in merchant account 140-160 at database 144 connected to the central depository server 142 (see block 206). For this account, the prefix “140” designates that the account is stored at the central depository 140, and the suffix “160” designates that the account includes information regarding the merchant 160.

As shown in FIG. 1, a similar naming convention is used for other accounts stored at the central depository 140, payment depository 150, and merchant system 160. This naming convention helps distinguish between various related accounts stored at different parties' systems. The central depository's database 144 includes a compilation of various products offered by various merchants. Only one merchant (merchant 160) is shown in FIG. 1 for convenience, but any number of merchants may participate; similarly, any number of referring users, referred users, referring sites and payment depositories may participate. In the case of multiple payment depositories, each payment depository may correspond to a different bank or financial institution, for example. The terms “merchants 160”, “referring users 110”, “referred users 120”, and “referring sites 130” are used herein if multiple such parties are designated.

In one embodiment, merchant 160 enrolls with the central depository 160, and a computer program is executed at the central depository (e.g., at computer 142b) to search the merchant's website (e.g., by contacting web server 162) for all products offered by that merchant, i.e., to “crawl” the merchant's website by sending a request 208a regarding available products for referral and receiving a response 208b thereto. Computer 142b may be the same as web server 142a or different. The central depository 160 may compile at database 144 information regarding the proper format for hyperlinking to all products by all participating merchants. The formatting includes an initial operable format for hyperlinks associated with the merchant, instructions on how to make additions to a hyperlink associated with the merchant to embed different variables, and a final operable hyperlink format with different variables included therein.

Thus, central depository 140 compiles a database of products that referring user 110 or referring site 130 can advertise (refer). This database may be the same database 144 that also stores various accounts shown in FIG. 1, or it may be a different database at the central depository 140. Any suitable database implementation may be used. The information in database 144 about available products for referral may be viewed by referring user 110 by viewing a web page served by web server 142a, e.g., at a website www.EXAMPLE-CENTRAL-DEPOSITORY.com (this URL is merely an example). In one embodiment, clicking (by the referring user 110 or referring site 130) a suitable link functions to automatically update a referring party account 140-110, 140-130 with the central depository 140, optionally automatically create a referring party account 160-110, 160-130 with merchant 160, automatically create a targeted referral hyperlink or a routing referral hyperlink to the product, and send the hyperlink electronically to the referring user 110 or referring site 130. If the referring party does not have a central depository account (140-110, or 140-130) clicking the link functions to prompt the referring party to create an account with the central depository prior to automatically creating a referring party merchant account, creating a referral hyperlink, and sending the referral hyperlink to the referring party. In addition to clicking, hyperlinks may be activated by another suitable input mechanism, such as a key press or finger tap; the term “activate” as used herein includes all such options.

Two types of referral hyperlinks may be used: targeted referral hyperlinks and routing referral hyperlinks. A targeted referral hyperlink pertains to a specific product that referring user 110 intends to advertise (refer). For example, referring user 110 may be browsing a website of central depository 140 (e.g., by contacting web server 142a to receive a web page from www.EXAMPLE-CENTRAL-DEPOSITORY.com) and may see a particular product (e.g., a particular television offered by a particular merchant) that she would like to refer. Central depository 140 may send a hyperlink to referring user 110 that she can distribute to others in order to refer that particular product; such a hyperlink is called a targeted referral hyperlink. On the other hand, a routing referral hyperlink, when activated by referred user 120, causes referred user 120 to be directed by central depository 140 to one of several possible web pages; an algorithm is carried out at the central depository 140 to determine which particular web page will be the destination. For example, a routing referral hyperlink may route referred user 120 to the website of the nearest retailer within 20 miles (or some other distance) from referred user 120 that carries a referred product.

In some embodiments, a hyperlink (e.g., text or icon displaying text) having a message to the viewer such as “Advertise this!” is provided adjacent to a product listed on the web page of central depository 140 which referring user 110 or referring site 130 is browsing. If activated and the referring site 130 or referring user 110 has an central depository account 140-110 or 140-130, this hyperlink serves to automatically create a referring user account 160-110 or referring site account 160-130 at the merchant, automatically create a referral hyperlink to the product and send the referral hyperlink to referring user 110 or referring site 130. If the referring site 130 or referring user 110 do not have an account, the central depository prompts the referring site 130 or referring user 110 for account information. In this embodiment, the product name itself is a hyperlink to more information about the product. Clicking on the listed product may serve to perform the “Advertise this!” function.

An account 140-130 may be created at central depository 140 for referring site 130. Referring site 130 may be a social networking website, an electronic discussion board or forum, a search engine, or any other website. An administrator of referring site 130 enters information for identifying the referring site, including name, address (e.g., physical address and/or electronic address such as URL and/or IP address), password, payment information, and other site details. The administrator of referring site 130 may view the central depository list (accessible at a central depository web page) and activate a hyperlink displaying “Advertise This!” The central depository 140 receives this request and downloads the identity of referring site 130, which may be in the form of a referring site identifier from a cookie or, optionally, acquires the identity by requesting the referring site's administrator to login to referring site account 140-130. If the referring site 130 does not have an account 140-130 the central depository 140 prompts the referring site 130 to create an account. The central depository 140 accesses the referring site database 140-130 to acquire the referring site information. The central depository 140 electronically sends the appropriate information about the referring site 130 to merchant 160 in order for merchant 160 to create referring site account 160-130 at the merchant 160.

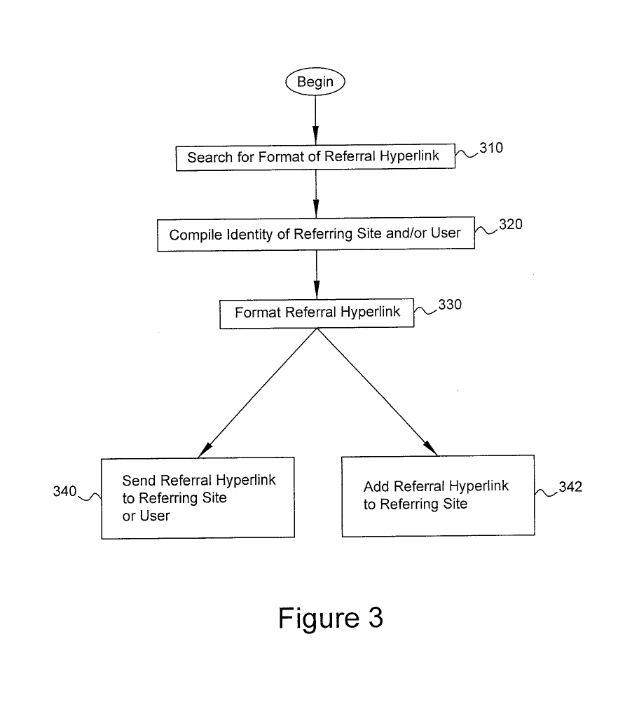

Referring to FIG. 3, a computer at the central depository (e.g., computer 142b) searches (block 310) database 144 for the appropriate format (previously specified by merchant 160) for a referral hyperlink that is to be created. The central depository 140 compiles the identity of the referring site 130 and the appropriate routing instructions to the product that will be referred (block 320). The central depository 140 runs a computer program to automatically format a referral hyperlink (create a referral hyperlink in the appropriate format) (block 330) and send it (block 340) to referring site 130 (e.g., via email or another electronic messaging technique), or, in one embodiment, directly add it to referring site 130 (block 342). The referral hyperlink may be encrypted during the formatting process (block 330).

In addition to accounts for referring sites 130 described above, an account may also be created at central depository 140 for referring user 110. Referring user 110 enters identification information including name, physical address, email address, payment information (e.g., bank or other financial account details), and optionally the identity (e.g., URL) of a referring site (e.g., a site at which the referring user is a member or at which she has an account; this site may be used by the referring user for posting a referral hyperlink). Referring user 110 visits the website of central depository 140, views the central depository's list of available products for referral, and activates a hyperlink such as “Advertise this!” The central depository 140 receives this request and retrieves the identity of referring user 110, which may be in the form of a referring user identifier from a cookie or, optionally, acquires the identity by requesting referring user 110 to login to referring user account 140-110. If the referring user 110 does not have an account 140-110, the central depository 140 prompts the referring user 110 to create an account. In one embodiment, the central depository 140 accesses the referring user database 140-110 to acquire the referring site information. The central depository 140 electronically sends the appropriate information about the referring user 110 to merchant 160 in order for merchant 160 to create referring user account 160-110 at the merchant 160.

Referring again to FIG. 3, the central depository 140 searches (block 310) database 144 for the appropriate format (specified by merchant 160) for a referral hyperlink that is to be created. The central depository 140 sends the appropriate information about the referring user 130 to merchant 160 via electronic transfer in order for merchant 160 to create referring user account 160-110. Upon referring user 110 selecting a product that she wishes to refer, the referral rate and discount associated with referral of that product are stored in database 144 at the central depository 140. The central depository 140 compiles the identity of referring user 110 and the appropriate routing instructions to the product that will be referred, and optionally, the identity of referring site 130 (block 320). The central depository 140 runs a computer program to automatically format a referral hyperlink (block 330) and send it to referring user 110 (e.g., via email or another electronic messaging technique) (block 340), or, in one embodiment, directly sends it to referring site 130 on behalf of referring user 110 with instructions to add the referral hyperlink to the referring user's directed page on the referring site (block 342). Referring user 110 may receive a prompt from central depository 140 to post (publish) the referral hyperlink to referring site 130.

In one embodiment, a computer program operating on the central depository computer 142b searches (e.g., periodically) a website of merchant 160 (e.g., by communicating with web server 162) to identify new products that have not been previously catalogued in a database at central depository 140. Merchant 160 has the option of selecting a standard referral rate for all goods, services, or intellectual property offered by the merchant. If so, then upon the central depository computer program finding a new good, service, or intellectual property (one that has not been previously catalogued by central depository 140), the central depository automatically updates and stores the merchant account 140-160 to reflect the new product. In an alternative embodiment, the merchant 160 manually updates the merchant account 140-160 to reflect new products and referral rates.

Referred user 120 may have an account 140-120 created at central depository 140 so that she can accumulate discounts (earned as a result of participating in the referral process) to be redeemed. Referred user 120 downloads a cookie with referred user account identification from the central depository 140. Each time referred user 120 activates a referral hyperlink for a product of merchant 160, the hyperlink is routed through the central depository 140, and the central depository 140 stores the discount(s) offered by merchant 160 at referred user account 140-120. If the referred user 120 does not have a central depository account 140-120 and activates a referral hyperlink, the central depository 140 prompts the referred user 120 to create an account. The central depository 140 sends referred user 120 a machine readable card. Referred user 120 presents the card when purchasing a product to receive these discounts. In one embodiment, the referred user 120 receives central depository identification which can be transmitted to the merchant 160 electronically using a phone or other electronic device. The central depository 140 stores all discounts accumulated by referred user 120 and sends the applicable discounts in the form of an electronic message to the specified merchant 160, who creates a referred user account 160-120 and stores the discount at that account. Referred user 120 has a single referred user account number stored on at least one card that is used by all merchants. When merchant 160 receives the card upon a purchase by referred user 120, merchant 160 accesses the merchant's own system, allowing merchant 160 to keep all its sales data private and not disclose such data to central depository 140. However, merchant 160 may alternatively send a request to central depository 140 for discount data for that merchant for a particular referred user 120 and receive a response from the central depository 140, as opposed to storing the referred user discount data on the merchant's database 164. The central depository 140 and merchant 160 store in referred user accounts 140-120 and 160-120, respectively, the identity of referring user 110 who referred a product. This way, merchant 160 has the option of paying per sale, paying per click (e.g., with nothing additional paid upon purchase), or paying a variable referral rate which can take into consideration purchase history.

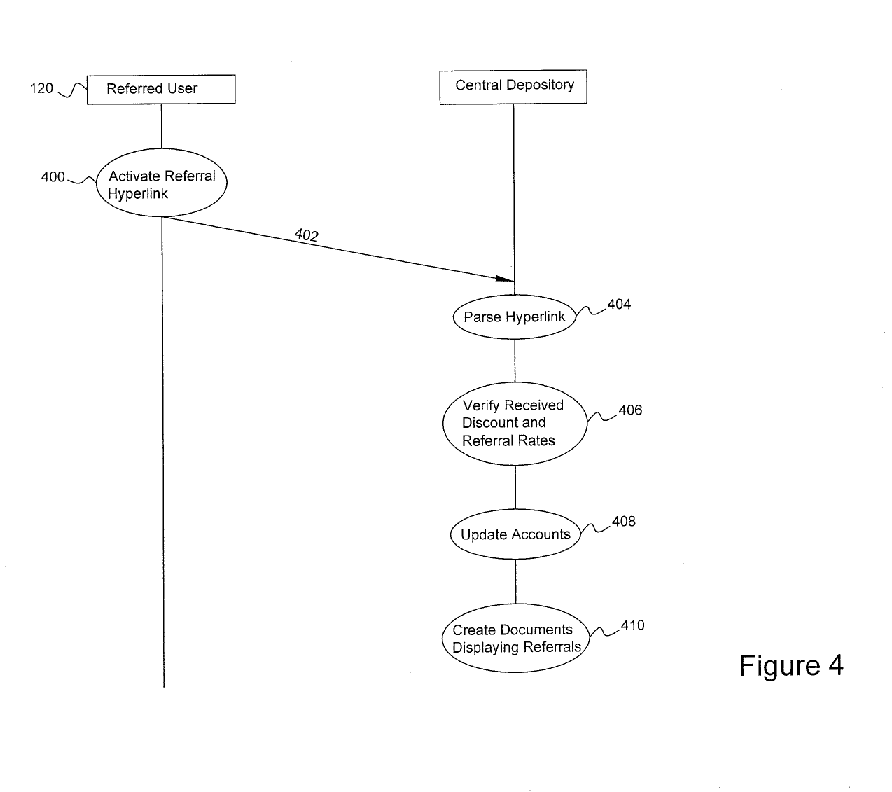

As shown in FIG. 4, referred user 120 is transferred to central depository 140 by activating a referral hyperlink (block 400) that contains embedded information that is parsed by a computer program operated on computer 142b at the central depository 140. The referral hyperlink data is sent to central depository in the form of an electronic message (402). The central depository 140 automatically parses the hyperlink (block 404) to determine embedded parameters and thereby determines routing instructions (406) to the relevant merchant (e.g., the provider of the product that is the subject of the referral), the identity of the referring user 110, the referral rate, the discount rate, the identity of the payment depository 150, and optionally the identity of the referring site 130. The central depository 140 optionally receives the identity of referred user 120 through prompt(s) or through a cookie on the computer of referred user 120.

The central depository 140 verifies the received referral rate and discount rate by comparing them with the respective referral and discount rates found in the referring user account 140-110 stored at database 144. If there is a mismatch in either rate, the central depository 140 uses the corresponding rate stored in referring user account 140-110 and sends a notice of possible impropriety to an administrative server (not shown).

The central depository 140 automatically updates and stores (block 408) the identity of referring user 110, identity of merchant 160, identity of the referred product, identity of referred user 120, and any previously stored referral rate and discount rate on database 144 at referring user account 140-110, referred user account 140-120, and merchant account 140-160. In some embodiments, multiple databases at the central depository 140 are used to store these different accounts. The central depository 140 uses the foregoing information to create documents (e.g., HTML web pages) served by web server 142a, for displaying all the successful referrals by referring user 110 and/or all the referrals to a specific product using the information acquired by the central depository 140 (block 410).

In some embodiments, the central depository 140 serves as a recipient of all referring user click fees. Merchant 160 submits one payment for all referring users to the central depository 140 and also submits the identities of the referring users 110. The central depository 140 pays the referring users 110 for all the click fees accrued for referrals that the referring users made. Optionally, the central depository 140 takes a processing fee from the referring user's click fees.

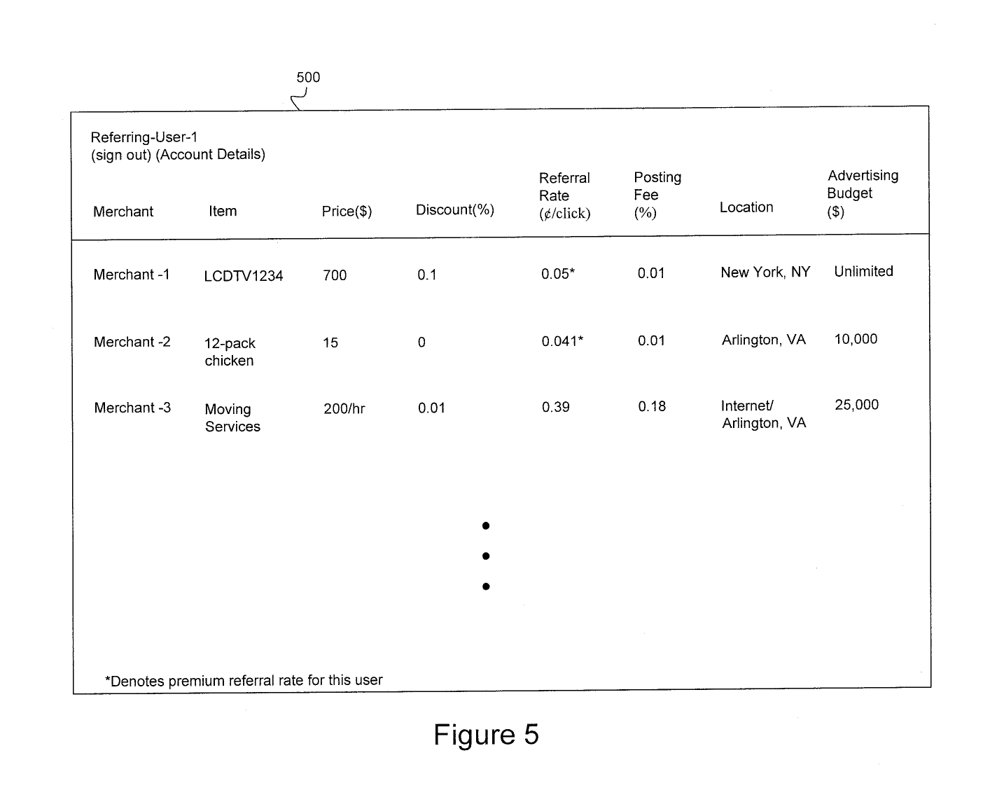

FIG. 5 is a depiction of an example screenshot in accordance with some embodiments, showing various products available for referral by a referring user. Display 500 that is viewable by referring user REFERRING-USER-1 includes information about various items she may select for referral. As shown in FIG. 5, items for referral may include goods as well as services that have a price specified as an hourly rate, for example. The display may be organized by category, such as by televisions or grocery items.

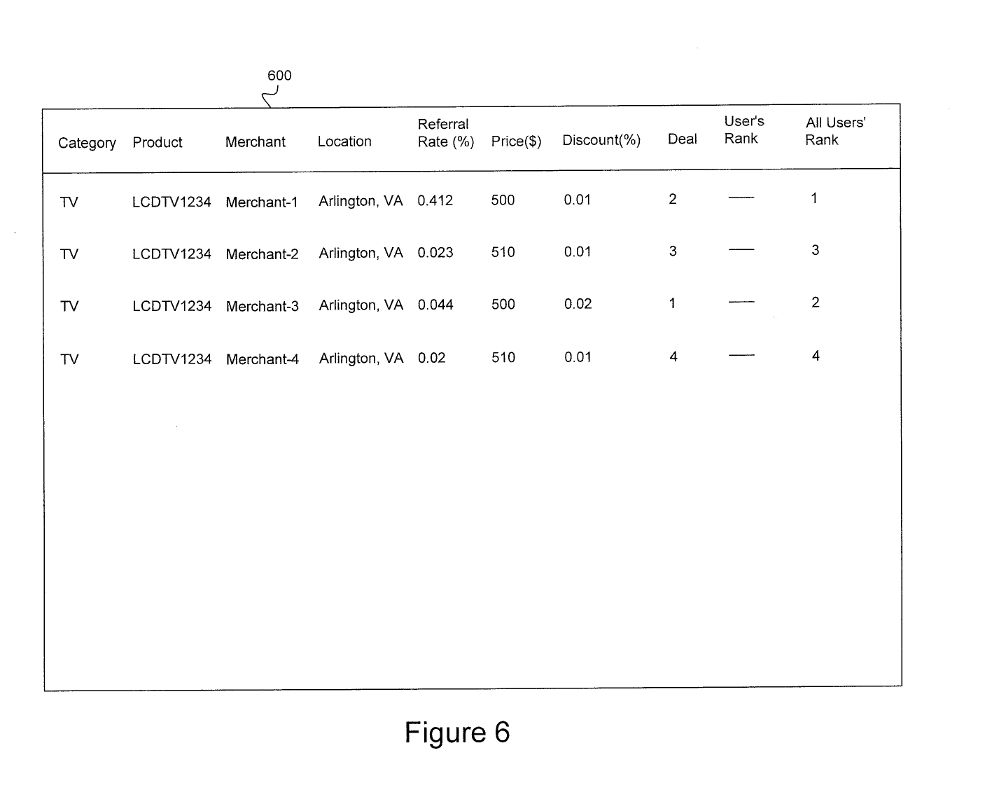

FIG. 6 is a depiction of an example screenshot in accordance with some embodiments, displayed when a referring user selects a specific product for referral. When referring user 110 activates a hyperlink such as “Advertise This!” at central depository 140 for referring a specific product (e.g., LCDTV1234), display 600 may be presented to her. Various merchants offering the selected product are shown, including information such as referral rate, price, discount, and deal ranking of the products. For each product, the cumulative ranking across all referring users is shown, and referring user 110 may enter her ranking of the products (e.g., by entering a number between 1 and 4 for each listed item).

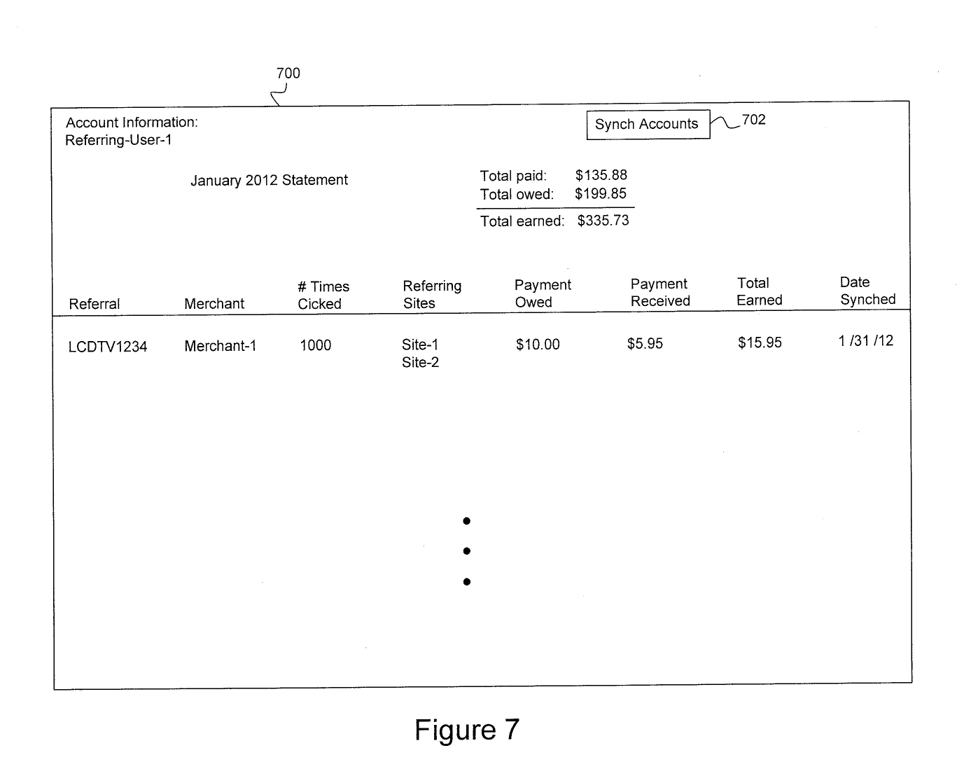

FIG. 7 is a depiction of an example screenshot in accordance with some embodiments, showing account management details for a referring user's account at a payment depository. Referring user 110 who logs into referring user account 150-110 at payment depository 150 may be presented with display 700, which includes information about various referrals she has made and her total monetary amounts paid, owed, and earned. A button 702 may be activated to synchronize account information.

Various subsystems and functionalities are described in greater detail below.

Accounts Creation by Merchant, Referring User/Site, Referred User with Central Depository

To maintain state information associated with the status of referrals and various parties involved with referrals, various accounts (shown in FIG. 1) are created and maintained at the central depository 140, payment depository 150, and merchant system 160. Automatic creation of accounts 140-110, 140-120, 140-130, and 140-160 at central depository 140 is described below.

Merchant Account

Merchant 160 enters necessary information to create a merchant account with the central depository. The central depository creates a merchant account (140-160) with the central depository containing the necessary referral, discount, and product information. In some embodiments, merchant 160 accesses the website of central depository 140 using a conventional web browser (not shown), e.g., which may contact web server 142a. The central depository web server 142a accesses stored HTML documents which can be requested, retrieved, and viewed by merchant 160 using the web browser. Merchant 160, in response to prompts from the central depository 140, enters identifying information, including one or more of: name, URL address(es), physical address, phone number, email address, account password, security questions, any or all alias email accounts, and billing address. Merchant 160 further provides the format instructions for formatting a paid referral or advertisement with the merchant. Each merchant's system may be different; however, using CGI (common gateway interface; discussed further below in section “CGI Details”) or a universal interface, communication is achieved from the central depository 140 to many different merchants 160 with different systems using embedded hyperlink information. An example hyperlink is: http://www.EXAMPLE-CENTRAL-DEPOSITORY.com/cgi-bin/updateandstore.cgi?name=George&discount=.1&intitial+referral+fee=.05&type=c&central+payment+depository=CPD&url=EXAMPLE-MERCHANT.com/lcdtv1234.html

When creating the merchant account 140-160 with the central depository 140, the merchant 160 sends the central depository 140 a listing of products offered by that merchant, referral rates for those products, applicable discounts, and prices. Optionally, the merchant 160 sends the central depository 140 the amount the merchant 160 is willing to pay the referring user 110 or referring site 130 per impression for the merchant's products or for referring the merchant generally. The merchant can further specify an individual site and types or categories of referring sites 130 which will be paid more or less initially.

The merchant 140 provides central depository 140 with data regarding what is required to be submitted from the referring site 130 or referring user 110 to create a referral account (160-130 or 160-110) at the merchant and optionally provides instructions to the central depository 140 on how to automatically create a referring site or referring user account (160-130 or 110) at the merchant. This way, the central depository 140 can later (when referring site 130 or referring user 110 interact with the central depository) elicit sufficient information from referring site 130 or referring user 110 and pass that information on to merchant 160 for merchant 160 to create the corresponding account at the merchant.

A computer program operating on computer 142b at central depository 140 verifies the inputted information is complete and that there are no other merchant accounts with the same identifying information. The central depository 140 assigns the merchant 160 a common merchant identifier, which may be an email account name or may be a number or other randomly generated or user selected identification. The central depository 140 then stores merchant account 140-160 in database 144. For example the database could be a SQL table or ASCII text file, which can be used to easily keep track of the merchants. In some embodiments, the central depository stores the listing of offered product(s), the referral rates, discounts, and prices in separate databases containing listings, referral rates, and discounts for all merchants. The central depository 140 stores the formatting instructions and any encryption associated with the merchant 160 in database 144.

The central depository 140 may create a document (e.g., in HTML format) specifically for the merchant 160. This document includes the merchant's advertisements, the merchant's available discounts, the referring sites 130 that refer that merchant or the merchant's product(s), the formatting instructions for that merchant, the product identification, and optionally the referring users 110 who referred that merchant or the merchant's product(s). The central depository 140 stores such merchant-specific documents on a server connected to the Internet, e.g., server 142a. The merchant 160 can access the merchant's corresponding document by entering the merchant's account information and password at the website of central depository 140.

Referring Site Account

The administrator of referring site 130 or other proprietary owner of the referring site creates an account 140-130 with the central depository 140 using a conventional web browser to monitor with greater accuracy the referrals made by the referral site 130. The central depository web server 142a accesses stored HTML documents which can be requested, retrieved, and viewed by the referring site's administrator using the web browser.

The referring site's administrator, in response to prompts from the central depository 140, enters identifying information including one or more of: name, physical address, phone number, email address, URL address(es), account password, security questions, any or all alias email accounts. In one embodiment, in response to further prompts, the referring site 130 provides a bank account or payment address. Optionally, the referring site 130 provides the identity of the payment depository 150. A computer at the referring site 130 downloads an identification cookie identifying the referring site 130 to the central depository 140 upon future visits.

A computer program operating on computer 142b at the central depository 140 verifies the inputted information is complete and that there are no other accounts with the same identifying information. The central depository 140 assigns the referring site 130 a common referring site identifier, which may be an email account name, a URL address, or may be a number or other randomly generated or user selected identifier. The central depository 140 then stores the referring site account information in database 144. The referring site account 140-130 may be created prior to or following the activation of an “advertise this” link.

The central depository 140 may create a document (e.g., in HTML format) specifically for the referring site 130. This document includes the referring site's referrals, the referral rate, optionally, the amount owed from the merchant 160, optionally the amount owed to referring user 110, the posting fee rate, and optionally the identity of all referring users 110 associated with the referring site 130. A posting fee rate is a fee paid to the referring site for allowing the referring user to post on the site. The posting fee may be a percentage of the referral fee or a separate amount paid to the referring site 130. The referring user 110 may pay a posting fee to post on the referring site 130. Alternatively, the merchant 160 may pay a posting fee to the referring site 130 when the referred user 120 activates a hyperlink posted by the referring user 110.

The referring site 130 receives a request to post by a referring user 110. The referring site 130 alters the referral hyperlink submitted by the referring user 110 to include the amount of the posting fee rate. The referring site 130 sends the central depository 140 notice of the posting fee rate associated with the referring user 110. The central depository 140 automatically updates the referring user account 140-110 to reflect the posting fee associated with a referring site 130. The central depository 140 automatically updates referring site account 140-130 to reflect the posting fee, associated referring user 110, and selected product or merchant. The central depository 140 sends the posting fee rate and associated referring site identity and payment information associated with the referring user 110 to the merchant 160. If the referring site 130 does not have a merchant account 1601-130, the merchant creates one for the referring site 130.

The central depository 140 stores referring site web page documents on web server 142a. The referring site 130 can access the referring site's web page document by entering the referring site's account information and password at the website of central depository 140.

Referring User Account:

The referring user 110 creates an account 140-110 with the central depository 140 using a conventional web browser to monitor with greater accuracy the referrals made by the referring user 110. The central depository web server 142a accesses stored web page documents which can be requested, retrieved, and viewed by the referring user 110 using the web browser.

The referring user 110, in response to prompts from the central depository 140, enters identifying information including one or more of: name, address (physical and/or email), phone number, account password, security questions, and any or all alias email accounts.

The referring user 110 optionally includes the identity (e.g., URL) of one or more referring sites. For example, a referring user who is a member of a social network and who plans to post a referral hyperlink at a website of the social network may list the social network's URL. Further, the referring user 110 also optionally includes demographic information including age, height, weight, interests, wealth, and favorite product(s). In response to further prompts, the referring user may provide a bank account or payment address. Optionally, the referring user may provide the identity of the payment depository 150. The referring user 110 downloads an identification cookie to the referring user's computer identifying the referring user 110 to the central depository 140 upon future visits.

A computer program operating on computer 142b at the central depository 140 verifies the inputted information is complete and that there are no other accounts with the same identifying information. The central depository 140 assigns the referring user 120 a common referring user identifier, which may be an email account name, or may be a number or other randomly generated or user selected identifier. The central depository 140 then stores the referring user account information in database 144. The referring user 120 may create an account with the central depository 140-110 prior to or following the activation of the “Advertise this link.”

The central depository 140 may create a document (e.g., in HTML format) specifically for the referring user 110, including the referring user's referred advertisements or referrals, the referral rate, optionally the amount owed to the referring user, the identity of the referring site(s), and the posting site fee rate. The central depository 140 stores referring user HTML documents on web server 142a. The referring user 110 can access the referring user's HTML document by entering the referring user's account information and password at the website of central depository 140.

If the referring user 120 identifies any referring sites 130, the central depository 140 searches the central depository system for a referring site account 140-130 at the central depository 140 corresponding to the identified referring site. If one is found, the central depository 140 automatically associates the referring site account 140-130 with the referring user's central depository account 140-110. If such an account is not found, the central depository automatically creates a referring site identity associated with a URL address (e.g., the URL provided by the referring user 110). The central depository 140 then sends the referring site 130 the request for payment information and account information electronically. The referring site provides payment information and account details to the central depository 140 electronically. The central depository 140 then creates referring site account 140-130 as described above.

Referred User Account

Referred user 120 creates an account 140-120 with the central depository 140 using a conventional web browser to monitor and store with greater accuracy discounts received from activating hyperlinks.

Referred user 120, in response to prompts from the central depository 140, enters identifying information including one or more of: name, physical address, phone number, email address, account password, security questions, any or all alias email accounts. Further, the referred user 120 optionally includes demographic information including age, height, weight, interests, wealth and favorite product(s). The referred user 120 downloads an identification cookie to the referred user's computer identifying the referred user to the central depository 140 upon future visits.

A computer program operating on computer 142b at the central depository 140 verifies the inputted information is complete and that there are no other accounts with the same identifying information. The central depository 140 assigns the referred user 120 a common referred user identifier, which may be an email account name or may be a number or other randomly generated or user selected identifier. The central depository 140 stores the referred user account information in database 144. The referred user 120 may create a referred user account 140-120 prior to or following the activation of a referral hyperlink.

The central depository may create an HTML document specifically for the referred user 120, including the referred user's collected discounts and activated referral hyperlinks. The central depository 140 stores the referred user HTML documents on a server connect to the Internet, e.g., server 142a. The referred user 120 can access the referred user's HTML document by entering the referred user account information and password at the website of central depository 140.

The central depository 140 sends the referred user 120 a machine readable card containing the referred user's common referred user identifier. The referred user 120 can have a single account 140-120 with central depository 140 to perform both the discount collection and referral activities (e.g., activities the individual performs when referring products). The referred user 120 can also have a single account 160-120 with merchant 160 to perform both the discount collection and referral activities.

Products that are offered by any merchant and that are available to be referred (i.e., referrable) in accordance with various embodiments are displayed so that referring site 130 or referring user 110 may refer them (e.g., by distributing referral hyperlinks about such products to others via the Internet). Techniques for displaying referrable products to referring site 130 or referring user 110 are now discussed.

Displaying Referrable Products to Referring Site

The central depository 140 may display a list of products from participating merchants (e.g., merchant 160) received from database 144. The list includes products offered by the merchants, prices, referral rates, and discounts. Optionally, the list includes payment amount per impression. The list can be organized (e.g., sorted) by highest referral fee paid (i.e., sortable to identify the merchant who will pay the highest referral fee for a product), lowest price (i.e., to identify the merchant offering a product for the lowest price), geographic proximity criteria (identify a nearby merchant offering a product), category, merchant, best deal (discussed below), discount (i.e., sortable to identify the merchant who will provide the highest discount), rankings by referring sites or referring users, or some combination thereof.

The website for central depository 140 has a hyperlink next to each offered product that displays “Advertise this item” or an equivalent message. An administrator of referring site 130 activates that hyperlink and is taken to a web page viewed by the referring site's administrator on a web browser, which document is sent to the referring site 130 from web server 142a. The specific product selected is stored by the central depository 140 temporarily until referring site account 140-130 is created and a referral hyperlink is created. If the referring site 130 already has an account 140-130, the central depository 140 prompts the referring site 130 for login data to log into the referring site account 140-130. If the referring site 130 is already logged in, the central depository 140 performs the automatic creation of a referral hyperlink for the specific product and sends it to the referring site 130. In the logged in case, the referring site 130 automatically creates a merchant account for the referring site 160-130 by sending the necessary referring site information to the merchant 160.

The referring site administrator may select item type and then select if the referring site 130 desires the hyperlink to go to the highest referral rate, lowest price, best location, best deal, or in accordance with a comparison ranking provided by the referring site. If the referring site administrator selects the comparison ranking, the referring site administrator enters initial rankings and price differences she believes makes one product a better value than another product. For example, she may rank product X as best, product Y as second best, and product Z as third best. But, she may indicate that if product Y is at least 10 dollars cheaper than product X, it should be ranked ahead of product X.

The HTML document prompts the referring site's administrator for identifying information and payment information to create an account 140-130 with the central depository 140 and a referral account 160-130 with a merchant 160 through the central depository 140. The central depository 140 accesses instructions for creating a referring site account 160-130 from data previously entered by the merchant (see above). The central depository creates account 140-130 for the referring site 130.

The central depository 140 sends the referring site account 140-130 information to the merchant 160 electronically. In one embodiment, if the referring site 130 selects a type of product, the central depository 140 sends the referring site account 140-130, payment information, and optionally selected product to the selected merchant or all merchants on file with the central depository 140 advertising that type of product. In a second embodiment, if the referring site 130 selects a type of product, the central depository 140 waits until the referral hyperlink is activated by the referred user 120 and upon activation and determination of the appropriate merchant, automatically sends the referring site account 140-130, payment information to the determined merchant 160 so that the merchant can create a referring site account 160-130.

Upon receiving this information from the central depository 140, the referring site account 140-130 information is parsed by a computer operating on the merchant's system 160. The computer program operating on the merchant's system 160 creates referring site account 160-130, and stores the account information on database 164. In one embodiment, if the referring site 130 does not have a common referring site ID with all merchants, merchant 160 creates a referring site referral identification and stores the identification with the referring site's account 160-130. The merchant 160 sends the central depository 140 the merchant specific referring site identification electronically. The central depository 140 runs a computer program to automatically update and store the referring site's account 140-130 at the central depository to reflect the identity of the referring site's account 160-130 identity at the merchant 160.

Following the creation of a referral account, the central depository 140 runs a computer program to automatically format a referral hyperlink in the format articulated below for the selected good(s), service(s), merchant(s), and intellectual property(ies), and sends the referral routing hyperlink electronically to the referring site, which then adds the referral hyperlink to a web page of the referring site. The hyperlink referral may include video, images, text, and/or other media. For example, the hyperlink may be in the form of an activatable image.

Displaying Referrable Products to Referring User

A similar process as described above (for a referring site) is used for displaying products to referring user 110 that she may wish to refer.

The central depository 140 may display a list of products from participating merchants (e.g., merchant 160) received from database 144. The lists includes products offered by the merchants, prices, referral rates, and discounts. Optionally, the list includes payment amount per impression. The list can be organized by highest referral fee paid, lowest price, geographic location, category, merchant, best deal, discount, rankings of referring sites or referring users, or some combination thereof.

The website for central depository 140 has a hyperlink next to each offered item that displays “Advertise this item” or an equivalent message. Referring user 110 activates that hyperlink and is taken to a web page viewed by the referring user 110 on a web browser, which document is sent to the referring user 110 from web server 142a. The specific item selected is stored by the central depository 140 temporarily until the referring user 140-110 account is created and a referral hyperlink is created. If the referring user 110 already has an account 140-110, the central depository prompts the referring user 110 for login data to log into the referring user account 140-110. If the referring user 110 is already logged in, the central depository 140 creates a referral hyperlink for the specific product and sends it to the referring user 110.

The central depository 140 sends the referring user account 140-110 information to the merchant 160 electronically. If the referring user 110 selects a type of product, the central depository 140 sends the referring user account 140-110, payment information, and optionally selected product to the selected merchant or all merchants on file with the central depository 140 advertising that type of product.

The central depository may place an identity cookie on the referring user's computer 110 containing the identity of the referring user for easier future use. In one embodiment, the referring user may select item type and then select if the referring user 110 desires the hyperlink to go to the highest referral rate, lowest price, best location, best deal, or in accordance with a comparison ranking given by the referring user 110. If the referring user 110 selects the comparison ranking, the referring user enters the rankings and price difference the referring user 110 believes makes one product a better value than another product.

The HTML document prompts the referring user 110 for identifying information, payment information, and optionally the identity of a referring site 130 to create an account 140-110 with the central depository and a referral account 160-110 with a merchant 160 through the central depository 140. The central depository 140 accesses instructions for creating a referring user account 160-110 from data entered by the merchant. The central depository creates account 140-110 for the referring user 110.

In one embodiment, the central depository 140 downloads a cookie from the computer of referring user 110 containing the referring user's referring site account identification and password. The central depository 140 sends a request for information about the referring user 110 to the referring site 130. The referring site 130 sends the payment information and referring user identity, e.g., an email address, to the central depository 140.

The central depository 140 creates referring user account 140-110 with the central depository 140 and automatically sends the referring user account 140-110 and, optionally, referring site identity, payment information, and selected product, electronically to the desired merchant 160 to create a referring user account 160-110 with the merchant 160. If a product has been selected, the central depository 140 sends this information to all merchants on file with the central depository 140 offering the product.

The referring user account 140-110 information is parsed by a computer operating on the merchant's system 160, which creates a referring user account 160-110 at the merchant 160, and stores the account information on database 164. In one embodiment, if the referring user 110 does not have a common referring user ID with all merchants, the merchant 160 creates a referring user referral identification and stores the identification with the referring user account 160-110. The merchant 160 electronically sends the central depository 140 the referring user identification. The central depository 140 runs a computer program to automatically update the referring user account 140-110 at the central depository 140 to reflect the referring user's specific merchant account 160-110 identity.

Following the creation of a referral account, the central depository 140 runs a computer program to automatically format a referral hyperlink in the format articulated below or by the merchant for the selected product(s) and sends the referral hyperlink electronically to the referring user 110. The referring user 110 then adds the referral hyperlink to a web page (e.g., her web page at referring site 130) or emails the hyperlink to another person. Alternatively, the central depository 140 receives from the referring user 110 a web address location for the specific page at which the referral hyperlink is to appear. The central depository 140 provides the referral hyperlink to the identified referring site 130, which displays it for the referring user 110. The hyperlink referral may include video, images, text, and/or other media.

A social media site or other type of referring site 130 may perform some of the functions of the central depository 140, including providing a list of merchants selected by the referring site 130. In this embodiment, the referring site 130 selects the approved merchants that can be advertised on the referring site 130 and displays them in the list format articulated above. The social media site or referring site then performs the functions outlined above to create referring user accounts with merchants and create paid referral hyperlinks or advertisements.

In one embodiment, the merchant 160 stores all referring user accounts 160-110 with the associated referring site accounts 160-130 on database 164.

Creation of Referring User Account or Referring Site Account at Merchant

The central depository 140 sends the selected merchant 160 the identity of the referring user 110 or referring site 130 and the necessary information (including payment information) for creating referring user account 160-110 or referring site account 160-130 at the merchant 160. The central depository 140 informs the merchant 160 of the referral accounts using any available method. In one embodiment, an electronic message containing the identity of the referring user 110 or referring site 130, payment information to the referring user 110 or referring site 130, and optionally, product(s) selected is sent to the merchant 160 by the central depository 140. A computer program operating on the merchant's system 160 receives this information, parses the information, creates a referring user account 160-110 or referring site account 160-13, and stores the account on database 164. If merchant 160 requires an individual identity, or the referring user 110 or referring site 160 is not assigned a common referring user or referring site identification by the merchant 160, the merchant 160 assigns the referring user or referring site an identifier and sends this information to the central depository 140. The merchant 160 stores the common referring user or referring site identity with the merchant specific identifier. The central depository 140 runs a computer program to automatically update the referring user account 140-110 or referring site account 140-130 to reflect the identity of the specific referring user account 160-110 or referring site account 160-130.

Alternatively, the central depository 140 sends the referring site or referring user information to all merchants registered with the central depository 140 who offer the product. Then, the merchant 160 creates a referring site account 160-130 or referring user account 160-110 and stores this account information on database 164. If the referring user 110 or referring site 130 is not assigned a common referring user or referring site identification, the merchant 160 assigns the referring user 110 or referring site 130 an identifier and sends this information to the central depository 140. The central depository then automatically updates and stores the referring user's or referring site's account (140-110 or 140-130) to reflect the identity of referring user account 160-110 or referring site account 160-130.

Creation of Referred User Account at Merchant

The referred user 120 activates a hyperlink that is routed through the central depository 140 to a merchant 160 or type of merchant. This hyperlink may contain information about a discount. In one embodiment, the hyperlink may identify a referring site 130 or referring user 110 without identifying a discount. In this embodiment, the central depository accesses the referring site's account 140-130 and/or referring user's account 140-110 to determine the discount the referring party or parties are allowed to give referred users. The central depository stores this total discount with the referred party's account 140-120.

Central depository 140 electronically sends the selected merchant 160 the identity of referred user 120 and the necessary information to create account 160-120 at the merchant 160 for referred user 120. If referred user 120 already has a merchant account 160-120, the central depository receives that information and merchant account identifier 160-120 when creating a referred user central depository account 140-120 or from the merchant 160. The referred user may create a merchant account 160-120 before or after activation of the referral hyperlink.

In one embodiment, the central depository 140 sends an electronic message containing the identity of the referred user 120 and any necessary account information such as address or billing information needed to create a referred user account 160-120 (containing discount information) at the merchant 160. Optionally, the central depository 140 sends some or all of the other information it collected from the referred user 120 to the merchant 160. A computer program operating on the merchant's system 160 receives this information, parses the information, creates referred user account 160-120, and stores the account on database 164. If the merchant 160 requires an individual identity, or the referred user 120 is not assigned a common referred user identification by the merchant 160, the merchant 160 assigns the referred user 120 an identification and sends this information to the central depository 40. The merchant 160 stores the referred user common identity with the merchant specific identity. The central depository 140 automatically updates and stores the referred user account 140-120 to reflect the identity of the specific referred user account 160-120 at the merchant.

Automatic Creation of Referral Hyperlinks

Various techniques for formatting referral hyperlinks are now described. Some of these techniques route the referred user 120 straight to the merchant, and others use the central depository 140 as an intermediary during routing. Hyperlinks may contain embedded information utilizing the Common Gateway Interface (CGI), which is a standard for dynamic generation of web pages by a web server (e.g., web server 142a at central depository 140). Hyperlinks may contain embedded information using alternative interfaces or programming languages which are capable of performing the functions described herein.

CGI Details

In an implementation using CGI, the use of a question mark “?” followed by text allows for information to be transferred to a CGI program using the GET method. A cgi-bin directory is included at the base of a directory tree, and all executable files within that directory are treated as CGI scripts. An example hyperlink using CGI format is:

http://www.EXAMPLE-CENTRAL-DEPOSITORY.com/cgi-bin/routingstorage.cgi?name=George+Beighley&Discount=.1&intitial+referral+fee=.005&central+payment+depository=CPD&URL=EXAMPLE-MERCHANT.com/lcdtv1234.html

The hyperlink includes the following: address of the central depository 140; identification of CGI base directory; routing storage program identification; use of question mark to transfer information; referring user 110 identity; discount rate for referred user 120; initial referral fee (as opposed to taking a percentage of the sale, the referring user 110 may be paid an initial click fee for the referral of the product, which can be less than $0.01); identity of payment depository 150; web address of the referred product page, which the central depository 140 transfers the referred user 120 to following the automatic update and storage of the referral information by the central depository 140. Thus, the format of the hyperlink is laid out as follows: http://www.<Address of the central depository>/<Identification of CGI base directory>/<Identification of storage routing program>?<Referring user identity>&<Discount rate for referred user>&<Initial referral fee>&<Web address of the product page>

Optionally, the hyperlink may have the following layout: http://www.<Address of the central depository>/<Identification of CUT base directory>/<identification of storage routing program>?<Referring user identity>&<Discount rate for referred user>&<referring site identity>&<Initial referral fee>&<Web address of the product page>

Other hyperlink formats may be used as well. Alternative formats using Apache Modules, Netscape Plug-ins, IIS ISAP Plug ins., Simple Common Gateway Interface of SCGI, or using Java platforms may also be used. The CGI GET method for sending information using a URL can be harmful because a user (e.g., referring user 110) can tamper with the URL. Therefore, some embodiments use known hash checking techniques (e.g., MD5 or SHA-2) to ensure data integrity (non-modification, i.e., successful communication of data without it being tampered with). Additional security is ensured by the central depository sending information regarding the referral stored with the referring party's central depository account (140-110, 140-130) directly from the central depository 140 to the merchant 160 via email or other form of secure electronic transfer.

Referral Hyperlink Routed Directly to Merchant for Referring Site

In one embodiment, the central depository 140 creates a paid referral hyperlink for the referring site 130. The paid referral hyperlink contains the following embedded information: the identity of the referring site, the merchant identity, the referral rate, the product offered, any discounts associated with the product, and optionally the identity of the payment depository 150. In one embodiment, only the identity of the referring site and the merchant and product identity are included. In this embodiment, the merchant finds the referral rate, discount rate, payment information by accessing the referring site's account 160-130 with the merchant where the merchant stores that information.

An example targeted referral hyperlink is: http://www.EXAMPLE-MERCHANT.com/lcdtv1234.html/cgi-bin/updateandstore.cgi?name=tvmagazine&discount=.1&intitial+referral+fee=.05&type=c&central+payment+depository=EXAMPLE-CENTRAL-DEPOSITORY.com

The hyperlink contains the following information. The routing instructions are to the merchant's product or “www.EXAMPLE-MERCHANT.com/lcdtv1234.” The hyperlink contains the referring site identity or “Tvmagazine.” The hyperlink contains a discount for the referred user of “.10.” The hyperlink contains the identity of the initial fee of “.05” The hyperlink contains the identity of the merchant: “EXAMPLE-MERCHANT.” The hyperlink contains the identity of the good: “lcdtv1234.” The hyperlink contains the identity of the payment depository 150 “EXAMPLE-CENTRAL-DEPOSITORY.com” (here, the payment depository 150 is the same as the central depository 140).

The central depository 140 uses the common referring site identification received from the referring site account 140-110, from a referring site cookie, or from manual entry. If there is no common referring site identity, then the central depository 140 receives the referring site identity for a specific merchant 160 from referring site account 140-110 which stores that information. The central depository 140 uses the merchant's format instructions for creating a paid referral hyperlink, received from the merchant 160 when creating merchant account 140-160 with the central depository 140. The central depository 140 uses the common product identification to identify the product. The common product identification can be a random number assigned, or a specific name and title. The central depository 140 receives any information regarding discount and/or referral rate from database 144, which contains discount and/or referral rate information entered by the merchant 160. The central depository 140 may serve as payment depository 150 as well in some embodiments. If another entity serves as the payment depository 150, then the identity of the payment depository 150 is stored in account 140-150 by the central depository. In this embodiment, the central depository 140 stores the payment depository's identity in database 144.

The central depository 140 updates the referring site's account 140-130 to reflect the creation of the referral hyperlink. The central depository 140 stores the referring site updated account on a database 144 connected to the central depository system. The central depository updates the merchant account 140-160 to reflect the creation of the referral hyperlink. The central depository 140 sends the referral hyperlink to the referring site 130 electronically. The referring site 130 then adds the referral hyperlink to a web page of the referring site 130.

In some embodiments, the referral hyperlink includes the identity of the central depository 140, which may be included in addition to the payment depository 150. Upon receiving the activation of the referral hyperlink by the referring site 130, the merchant 160 electronically sends the identity of the referring site 130 to the central depository 140. The central depository 140 then stores this information in referring site account 140-130. The central depository 140 creates a web page containing information about the referring site's merchant accounts 140-130 which can be displayed to referring sites from web server 142a.

In one embodiment, the central depository 140 sends the referral hyperlink to the referring site 130 via electronic message. The central depository 140 sends the referring site central depository or merchant identifier, the referral rate at the time of sending, the discount rate that the referring site 130 is entitled to give referred users 120 that click on the referral hyperlink at time of sending, the merchant identity, the product identity to the referring site 130 via electronic message. Optionally, the central depository 140 sends an additional discount rate associated with all referred users 120. The referring site 130 stores the information received from the central depository 140 on a database connected to the referring site's system 134. The referring site then adds the referral hyperlink to the referring site.

In one embodiment, the referring site 130 sends the discount associated with the referring site, the referring site identity, the referral rate, the central depository identity, the merchant identity, the identity of the product, the specific web-address of the referred item to the merchant 160. The merchant 160 creates a referring site account 160-130 on the merchant's database 164 containing the discount associated with referring site, the referring site identity, the referral rate, the central depository identity, the merchant identity, the identity of the product, the specific web-address of the referred item information to the merchant 160. The merchant 160 creates a referring site account 160-130 on the merchant's database 164 containing this information. The merchant 160 stores this information with the referring site account 160-130.

The referring site 130 may send this information to the merchant 160 after activation of the referral hyperlink. In this case, the referring site 130 also sends the discounts associated with the referred user 120 and the referred user 120 identity. The discount associated with the referred user includes the discount the referring site 130 was entitled to give the referred user 120 by clicking on the referral hyperlink, and any other discounts for the merchant 160 the referred user has accumulated. In this embodiment, the referring site 130 receives from the central depository 140 all discounts the referred user 120 has accumulated and the referring site 130 sends the total discount for the referred user 120 to the merchant 160.

Referral Hyperlink Routed Directly to Merchant for Referring User and Site

The central depository 140 may create a referral hyperlink for the referring user 110. The referral hyperlink contains the following embedded information: the identity of the referring user 110, the identity of the merchant 160, the specific product to be referred, any discounts associated with the product, the referral rate, and optionally, the identities of the referring site 130 and payment depository 150. In one embodiment, only the identity of the referring user and the merchant and product identity are included. In this embodiment, the merchant finds the referral rate, discount rate, payment information by accessing the referring user's account with the merchant 160-110 where the merchant stores that information.

An example targeted referral hyperlink is: http://www.EXAMPLE-MERCHANT.com/lcdtv1234.html/cgi-bin/updateandstore.cgi?name=Phyllis&posting+site=tvmagazine&discount=.1&intitial+referral+fee=.05&type=c&central+payment+depository=EXAMPLE-CENTRAL-DEPOSITORY.com

The hyperlink contains the following information. The routing instructions are to the merchant's product or “www.EXAMPLE-MERCHANT.com/lcdtv1234.” The hyperlink contains the referring site identity or “Tvmagazine.” The hyperlink contains a discount for the referred user of “.1.” The hyperlink contains the identity of the referral rate of “.05.” The hyperlink contains the identity of the merchant: “EXAMPLE-MERCHANT.” The hyperlink contains the identity of the product: “lcdtv1234.” The hyperlink contains the identity of the referring user: “Phyllis.” The identity of the payment depository 150 is “EXAMPLE-CENTRAL-DEPOSITORY.com.”

The central depository 140 uses the common referring user identifier received from referring user account 140-110, from a referring user cookie, or from manual entry. If there is no common referring user identity, then the central depository 140 receives the referring user identity for a specific merchant from the referring user account 140-110 which stores that information. The central depository 140 uses the merchant's format instructions for creating a referral hyperlink, received from the merchant 160 when creating merchant account 140-160 with the central depository. To identify the product, the central depository 140 uses the common product identifier, which may be a random number assigned, or a specific name and title. The central depository 140 receives any discount or referral rate information from a database which contains discount or referral rate information entered by the merchant. Optionally, the central depository 140 receives the referring site identity from referring site account 140-110 or alternatively from manual entry from the referring user 110. If there is no common referring site identity, then the central depository 140 receives the referring site identity for a specific merchant 160 from the referring site account 140-130. If the central depository 140 and payment depository 150 are not the same, then the identity of the payment depository 150 is stored in account 140-150.

The central depository 140 sends the paid referral hyperlink to the referring user 110 electronically. The central depository 140 updates the referring user's account 140-110 to reflect the creation of the referral hyperlink. The central depository 140 stores the referring user's updated account on database 144. The central depository updates the merchant account 140-160 to reflect the creation of the referral hyperlink The referring user 110 then adds the paid referral hyperlink to the referring site 130.

In an alternative embodiment, the central depository 140 sends the referral hyperlink to the referring site 130 with the associated referring user identity. The central depository 140 sends to the referring site 130 the referring user central depository or merchant identifier, the referral rate at the time of sending, the discount rate at time of sending, the merchant identity, the product identity via electronic message. If the referring user does not already have a referring site account 130-110 the referring site creates an account 130-110 to store the referral information. The referring site 130 stores the information received from the central depository 140 on a database connect to the referring site's system 134. The referring site then adds the referral hyperlink associated with the referring user to the referring site.

In one embodiment, the referring site 130 sends the discount associated with the referring user and/or referring site, the central depository identity, the referring user identity, and/or the referring site identity, the referral rate, the merchant identity, the identity of the product, the specific web-address of the referred item information associated with the referring user 110 to the merchant 160. The referring site 130 may be entitled to give a referred user 120 a discount for the merchant, when a referring user 110 posts on a referral hyperlink on the referring site and the referred user 120 activated the referral hyperlink. Further, the referring user 110 may be able to give the referred user 120 an additional discount for activating a referral hyperlink in addition to the discount given by the referring site or any other discounts the referred user has accumulated. The merchant 160 creates a referring user account 160-110 on the merchant's database 164 containing this information. The merchant 160 stores this information with the referring user account 160-110.

The referring site 130 may send this information associated with the referring user 110 to the merchant 160 after activation of the referral hyperlink. In this embodiment, the referring site 130 also sends the discounts associated with the referred user 120 and the referred user 120 identity to the merchant. The discount associated with the referred user includes the discount the referring site 130 was entitled to give the referred user 120 by clicking on the referral hyperlink, the discount the referring user 110 was entitled to give the referred user 120 by clicking on the referral hyperlink, and any other discounts for the merchant 160 the referred user has accumulated. In this embodiment, the referring site 130 receives from the central depository 140 all discounts the referred user 120 has accumulated. The referring site 130 sends the total discount for the referred user 120 to the merchant 160.

Hyperlink formatting techniques that use central depository 140 as a routing intermediary are now described.

Routing Referral Hyperlink Through Central Depository for Referring Site

The central depository 140 may create a referral routing hyperlink for the referring site 130. The referral hyperlink contains the following embedded information: the identity of the referring site 130, the identity of the specific merchant 160, the product(s) to be referred, any discounts associated with the product, optionally, the referral rate, routing instructions to send the referred user 120 to the central depository 140 and then to the specific product's web page at the merchant 140. In one embodiment, only the identity of the referring site, central depository, and the merchant and product identity are included. In this case, the central depository finds the referral rate, discount rate, payment information by accessing the referring site's account with the central depository 140-130.

An example targeted referral hyperlink for this embodiment is: http://www.EXAMPLE-CENTRAL-DEPOSITORY.com/cgi-bin/updateandstore.cgi?name=EXAMPLE-REFERRING-SITE&discount=.1&intitial+referral+fee=.05&type=c&central+payment+depository=CPD&url=EXAMPLE-MERCHANT.com/lcdtv1234.html

The central depository 140 uses the common referring site identifier received from referring site account 140-130, from the referring site cookie, or from manual entry. If there is no common referring site identity, then the central depository 140 receives the referring site identity for a specific merchant 160 from the referring site account 140-130. The central depository 140 uses the merchant's format instructions for creating a paid referral hyperlink, received from the merchant 140 when creating a account 140-160. The central depository uses the common product identification to identify the product. The common product identification can be a random number assigned, or a specific name and title. The central depository receives any discount or referral rate information from database 144. If the central depository 140 and payment depository 150 are not the same, then the identity of the payment depository 150 is stored in account 140-150 by the central depository.

The central depository 140 sends the paid referral hyperlink to the referring site 130 via electronic message. The referring site 130 then adds the paid referral hyperlink to the referring site's web page 130. The central depository 140 updates the referring site's account 140-130 to reflect the creation of the referral hyperlink. The central depository 140 stores the referring site updated account on database 144. The central depository updates the merchant account 140-160 to reflect the creation of the referral hyperlink

The referred user 120 is transferred to the central depository 140 by activating a referral hyperlink. The activated referral hyperlink is parsed by a computer program operated on the central depository 140. The central depository 140 automatically parses the hyperlink received from the referred user 120 and determines the routing instructions to the specific merchant 140, the identity of the referring site 130, the referral rate, the discount rate, and the identity of the payment depository 150. The central depository 140 optionally receives the identity of the referred user 120 through prompts, or a cookie on the referred user's computer, which cookie the referred user 120 downloaded to the referred user's computer upon creating referred user account 140-120.

The central depository 140 compares (verifies) the received referral rate with the referral rate stored at referring site account 140-130. A computer program operating on central depository system 140 accesses referring site account 140-130 to find the stored referral rate for the specific item the referring site 130 has advertised. If the stored referral rate is different than the received referral rate, the central depository 140 uses the referral rate from referring site account 140-130 and sends a notice of possible impropriety to an administrative server. The central depository 140 similarly verifies the discount rate. A computer program operating on central depository system 140 accesses referring site account 140-130 to find the stored discount rate for the specific item the referring site 140-130 has advertised. If the stored discount rate is different than the received discount rate, the central depository 140 uses the discount rate from referring site account 140-130 and sends a notice of possible impropriety to the administrative server.

The central depository 140 automatically updates and stores the referring site identity, merchant identity, product identity, referred user identity, and previously stored referral rate, and discount rate at the referring site account 140-130, the referred user account 140-120, and the merchant account 140-160. The central depository 140 then uses this information to create web page documents that show the successful referrals by the referring site 130, the referrals to a specific product, and other categories such as referrals to a particular merchant, product type, or region, using the information acquired by the central depository 140. The central depository 140 may send to the referred user 120 an electronic message containing the referred user's 120 account information and selected discounts.

The central depository 140 runs a program to create a referral hyperlink to a particular product. The central depository 140 sends the referred user's web browser the referral hyperlink to the merchant with the same embedded information. The referred user's browser then automatically transfers the referred user 140 to the merchant 160.

In one embodiment, the central depository sends the referral information to the merchant 160 via electronic transfer of data such as email. The merchant sends the referred user identity, the referred site identity, the referral rate, the discount rate, the specific product selected, and optionally, the number of views the referring site has received.

In an alternative embodiment, the administrator of referring site 130 selects a general type of product from a list at a web page of the central depository 140 by viewing and inputting information to HTML documents from web server 142a. The administrator of referring site 130 then selects whether the hyperlink should go to the best deal, lowest price, highest referral rate, best geographic location, or pre-determined rankings.

The central depository 140 formats the routing referral hyperlink as for example: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route=hrr

The hyperlink contains the following information. The routing instructions are to the central depository or “www.EXAMPLE-CENTRAL-DEPOSITORY.com.” The hyperlink contains the referring site identity or “Tvmagazine.” The hyperlink contains a discount for the referred user of “.1%.,” which could be offered by all merchants or by the central depository. The hyperlink contains the routing instructions “hrr” or highest referral rate. The hyperlink contains the item type: “lcdtv.” The hyperlink contains the identity of the central payment depository, “CPD.”

Optionally, the administrator of referring site 130 enters identifying information about which products the referring site likes in a ranking format by category. The referring site selects, when ranking, the appropriate referral rate, price, or deal to rank one item over another. Basically, this is how low the price on one product (e.g., television) would have to be for it to be ranked ahead of another product that would otherwise be higher, or how high the referral rate would have to be to rank one television over another. The central depository 140 compares the ranks given by the referring site 130 with the highest referral rate, lowest price, best deal best geographic location, and routes the referred user 120 to that merchant. This can be accomplished by adding an additional instruction of “rank” to the hyperlink as follows.

http://www.EXAMPLE-CENTRAL-DEPOSITORY.com/cgi-bin/updateandstore.cgi?name=tvmagazine&discount=.1&intitial+referral+fee=.05&type=c&central+ral+payment+depository=CPD&item=lcdtv&route1=rank&route2=geo20

Here, Route2 is a field name identifying to the program to perform instructions, in this case to find the highest ranked product within a distance of 20 miles from the referred user 120. The central depository searches the central depository database to find a list of merchants within 20 miles of the referred user 120. The central depository then searches the list of merchants within 20 miles of the referred user 120 to find the merchant with the highest ranked item as determined by the referring site 130. The central depository 140 sends the referral hyperlink to the referring site 130 via electronic message. The referring site 130 then adds the referral hyperlink to the referring site 130.

Routing Referral Hyperlink Through Central Depository for Referring User

In an alternative embodiment, the central depository 140 creates a routing referral hyperlink for the referring user 110. The routing referral hyperlink contains the following embedded information: the identity of the referring user, the specific merchant identity, the specific product web address, any discounts associated with the product, routing instructions to send the referred user 120 to the central depository 140 and then to the specific product address page, and the identity of the payment depository 150. In one embodiment, only the identity of the referring user, central depository, the merchant and product identity are included. In this embodiment, the central depository finds the referral rate, discount rate, payment information by accessing the referring user's account with the central depository 140-110 where the central depository stores that information.

An example routing referral hyperlink is: http://www.EXAMPLE-CENTRAL-DEPOSITORY.com/cgi-bin/updateandstore.cgi?name=George&posting+site=Social+Media+Site&discount=.1 &intitial+referral+fee=.05&type=c&central+payment+depository=CPD&url=EXAMPLE-MERCHANT.com/lcdtv1234.html

The hyperlink contains the following information. The routing instructions are to the central depository or “www.EXAMPLE-CENTRAL-DEPOSITORY.com.” The hyperlink contains the optional referring site identity or “Social_Media_Site.” The hyperlink contains the referring user identity or “George.” The hyperlink contains a discount for the referred user of “.1.” The hyperlink contains the identity of the referral rate of “.05.” The hyperlink contains the identity of the merchant: “EXAMPLE-MERCHANT.” The hyperlink contains the identity of the product: “lcdtv1234.” The hyperlink contains the specific web address of the desired product and merchant “EXAMPLE-MERCHANT.com/lcdtv1234.html” The hyperlink contains the identity of the central payment depository, “CPD.”

The central depository 140 uses the common referring user identifier received from referring user account 140-110, from the referring user cookie, or from manual entry. If there is no common referring user identity, then the central depository 140 receives the referring user identity for a specific merchant from the referring user account 140-110.

The central depository 140 uses the merchant's format instructions for creating a paid referral hyperlink, received from the merchant when creating merchant account 140-160. To identify the product, the central depository 140 uses the common product identifier, which may be a random number assigned, or a specific name and title. The central depository 140 receives any discount or referral rate information from account 140-160. Optionally, the central depository receives the referring site identity from referring site account 140-130 after manual entry from the referring user 140-110. If there is no common referring site identity, then the central depository receives the referring site identity for a specific merchant from the referring site account 140-130. If the central depository 140 and payment depository 150 are not the same, then the identity of the payment depository 150 is stored in account 140-150.

The central depository 140 updates the referring user's account 140-110 to reflect the creation of the referral hyperlink. The central depository updates the merchant account 140-160 to reflect the creation of the referral hyperlink The central depository sends the paid referral hyperlink to the referring user 110 via electronic message. The referring user 110 then adds the paid referral hyperlink to the referring site 130.

In an alternative embodiment, the central depository 140 sends the paid referral hyperlink to the referring site 130 with the associated referring user identity. The central depository 140 sends to the referring site 130 the referring user central depository or merchant identifier, the referral rate at the time of sending, the discount rate at time of sending, the merchant identity, the product identity via electronic message. If the referring user does not already have a referring site account, the referring user creates an account 130-110 to store the referral information. The referring site 130 stores the information received from the central depository 140 on a database connect to the referring site's system 134. The referring site then adds the referral hyperlink associated with the referring user to the referring site.

In one embodiment, the referring site 130 sends the following information associated with the referring user 110 to the merchant 160: the discount associated with the referring user and referring site, the central depository identity, the referring user identity, and/or the referring site identity, the referral rate, the merchant identity, the product identity, the web address of the referred item. The merchant 160 creates a referring user account 160-110 on the merchant's database 164 containing this information. The merchant 160 stores this information at the referring user account 160-110.

The referring site 130 may send the referral and discount information associated with the referring user 110 to the merchant 160 after activation of the referral hyperlink. In this embodiment the referring site 130 additionally sends the referred user identity and any discounts associated with the referred user to the merchant 160. The discount associated with the referred user includes the discount the referring site 130 was entitled to give the referred user 120 by clicking on the referral hyperlink, the discount the referring user 110 was entitled to give the referred user 120 by clicking on the referral hyperlink, and any other discounts for the merchant 160 the referred user has accumulated. In this embodiment, the referring site 130 receives from the central depository 140 all discounts the referred user 120 has accumulated. The referring site 130 sends the total discount for the referred user 120 to the merchant 160.

Upon activation of the routing referral hyperlink by the referred user 120, the hyperlink is parsed to determine the referral information and routing instructions to the particular product at a particular merchant's web page. The central depository 140 automatically updates and stores the referring user identity, merchant identity, product identity, referred user identity, and previously stored referral rate, and discount rate at the referring user account 140-110, the referred user account 140-120, the referring site account 140-130, and the merchant account 140-160. The central depository 140 then uses this information to create web page documents that show the successful referrals by the referring user 110, the referrals to a specific product, and other categories such as referrals to a particular merchant, product type, or region, using the information acquired by the central depository 140. The central depository 140 may send to the referred user 120 an electronic message containing the referred user's 120 account information and accumulated discounts.

The central depository 140 directs the referred user to the merchant's web page, which displays to the referred user 120 after hyperlink activation the information associated with the selected product.

The central depository may send the referral information to the merchant 160 electronically. The merchant sends the referred user identity, the referring user identity, the referral rate, the discount rate, the specific product selected, and optionally, the referred site identity and the number of views the referring site has received.

In an alternative embodiment, the referring user 110 selects a general type of product from a list provided by the central depository by viewing and inputting information to HTML documents provided by web server 142a. The referring user 110 then selects whether the referring user 110 desires to have the hyperlink go to the best deal, lowest price, highest referral rate, best geographic location, or pre-determined rankings.

The central depository 140 formats the referral routing hyperlink as for example: http://www.EXAMPLE-CENTRAL-DEPOSITORY.com/cgi-bin/updateandstore.cgi?name=George&Posting+Site=Social+Media+site&discount=.1&intitial+referral+eferral+fee=.05&type=c&central+payment+depository=CPD&item=lcdtv&route=hrr

The hyperlink contains the following information. The routing instructions are to the central depository or “www.EXAMPLE-CENTRAL-DEPOSITORY.com.” The hyperlink contains the optional referring site identity or “Social_Media_Site.” The hyperlink contains the identity of the referring user or “George.” The hyperlink contains a discount for the referred user of “.1%.,” which could be offered by all merchants or by the central depository 140. The hyperlink contains the routing instructions “hrr” or highest referral rate. The hyperlink contains the general identity of the product (i.e., the product type): “lcdtv.”

Optionally, the referring user 110 enters identifying information about which products the referring user likes in ranking format by category. Similar to the ranking described above in the context of referring site 130, the referring user 110 selects, when ranking, the appropriate referral rate, price, or deal to rank one item over another. The central depository 140 compares the ranks given by the referring user 110 with the highest referral rate, lowest price, best deal best geographic location, and routes the referred user 120 to that merchant. This can be accomplished by adding an additional instruction of “rank” to the hyperlink as follows. http://www.EXAMPLE-CENTRAL-DEPOSITORY.com/cgi-bin/updateandstore.cgi?name=phyllis&posting+site=Tvmagazine&discount=.1&intitial+referral+fee=.05&type=c&central+payment+depository=CPD&item=lcdtv&route1=bd&route2=geo20

The computer program at the central depository 140 routes the referred user to the highest ranked lcdtv within 20 miles. The central depository 140 sends the referral hyperlink to the referring user 110 electronically. The referring user 110 then adds the referral hyperlink to the referring site 130. In an alternative embodiment, the central depository 140 sends the referral hyperlink to the referring site 130, which automatically formats the hyperlink and adds the hyperlink to the referring user's web page on the referring site 130.

Encryption

To address the possibility of attempted abuse, in some embodiments all the referral data is stored on database 144 at the central depository 140, not in a hyperlink which the referring user 110 can fraudulently alter. Encryption may be used using any of various known encryption techniques. Upon activating the “Advertise this!” (or similar) button, the central depository 140 creates an encrypted advertising hyperlink for the referring user 110 containing the referring user's identity, product identity, web address identity, referral rate identity, and discount identity encrypted in the hyperlink. The encrypted hyperlink does not contain an easily understandable identification of the foregoing categories.

The referring user 110 posts the advertising hyperlink. When the hyperlink is activated by referred user 120, the central depository 140 decodes the advertising hyperlink and finds the identity of referring user 110. The central depository 140 searches the referring user account 140-110 to find the referral. The central depository 140 then compares the referral information on its server with the referral information sent from the referred user 120 to verify accuracy of the latter. If there is a discrepancy, the server's information is used, and fraud is reported.

A computer program operating on the central depository 140 sends an encrypted electronic message to a server operating on the merchant's system 160. The message contains the referral information, the time at which the referred user 120 was sent to merchant 160, and necessary account information for the merchant 160 to create a referring user account 160-110 and optionally for the merchant to create a referred user account 160-120 via a secure connection. This information does not travel through the computer of referred user 120 and is sent privately and directly from the central depository 140 to the merchant 160. The merchant creates and updates the referred user account 160-120 to reflect the referral either by product or merchant generally.

The central depository 140 creates an encrypted query string hyperlink containing the referral information. The central depository 140 automatically routes the referred user 120 to the merchant 160 with a hyperlink that contains query string information. The merchant 160 receives the referred user 120 from the central depository 140 with the query string information. The merchant 160 decodes the encrypted query string information. Optionally, the merchant 160 uses the decrypted query string information to search the merchant server for the referral information to more easily create dynamic web pages. Optionally, the merchant 160 checks the query string information with the backend information to determine if the hyperlink has been altered. The merchant 160 can check the query string information including the referred user identity as a method of confirming the accuracy of the information received directly and privately from the central depository 140. For payment purposes, the direct communication between the central depository 140 and merchant 160 determines the amount the merchant pays. The query string helps to create faster referred user generated dynamic web pages and to help determine if referring user 110 altered a hyperlink.

CGI or other programming languages may be used to perform this function and to create the encrypted hyperlinks. In some embodiments, magnet links are used. A magnet link is a link which identifies a file not by location but by the contents' cryptographic hash value.

When the referred user 120 makes a purchase, the merchant 160 accesses the referred user account 160-120 for the referral information which has been updated by the direct communication with the central depository 140. Optionally, no query string information is sent, and the referred user 120 is merely routed directly to the web page, and the entire referral information is determined by the direct communication. This is not preferable, because the identity of the referred user is preferred by the merchants for dynamic web pages.

Referring Site to Central Depository

In one embodiment, the central depository 140 gives the referring user 110 an encrypted advertising hyperlink. The referring user 110 distributes (e.g., emails or posts) the advertising hyperlink. The referred user 120 activates the hyperlink. The referred user 120 is transferred to the central depository 140. The central depository 140 decodes and parses the hyperlink to determine the referral information and identity of referring user 110. The central depository 140 searches referring user account 140-110 for the referral information, and verifies the referral information for that user.

Central Depository to Merchant

The central depository 140 sends a CGI GET message to the merchant 160 in the form of a URL in the browser of referred user 120. In addition a computer program operating on the central depository 140 sends an encrypted electronic message to a server operating on the merchant system 160. The message contains the referral information, the time at which the referred user 120 was sent to merchant 160, and necessary account information for the merchant 160 to create referring user account 160-110 and optionally for the merchant to create referred user account 160-120 via a secure connection. The referral information includes the identity of the referring user, the identity of the referring site, the identity of the product, the referral rate, the discount rate, and the identity of the referred user.

The central depository 140 automatically routes the referred user 120 to the merchant 160 with a hyperlink that contains CGI information. The merchant 160 receives the referred user 120 from the central depository 140 with the CGI information. The merchant 160 uses the encrypted CGI information to search the merchant server 160 to create dynamic web pages. Optionally, the merchant 160 checks the CGI information with the backend information to determine if the hyperlink has been altered.

Time Stamping

In some embodiments, time stamp information may be encrypted as follows. Referring user 110 may activate an “Advertise this!” button for an item listed on the website of central depository 140. Central depository 140 accesses referring user account data from cookie or referring user 110 manually creates an account 140-110 or enters her password to access an existing account. The central depository creates a hyperlink containing the time the hyperlink was created and the identity of the referring user 110. The central depository may record small enough increments of time such that each hyperlink is created at a different point in time. In this embodiment, the central depository creates a hyperlink containing merely the time the link was created. An example of the hyperlinks described above is:

http://www.EXAMPLE-CENTRAL-DEPOSITORY.com/cgi-bin/updateandstore.cgi?time=12:31:031268&name=George

Once the computer program finds the time stamp, the computer program searches all records (if more than one were created at that time stamp) for the identity of the referring user 110. Once the identity of referring user 10 is found, the computer program accesses the referring user account 140-110 to determine the referral hyperlink created at the time with the associated referral information. Optionally, the computer program searches the time stamp database to find the identity of all of the referral information created at a single point in time by using a small enough window of time so that each different advertising hyperlink is created at a different point in time. The computer program updates referring user account 140-110 to reflect a successful referral and updates referred user account 140-120 to reflect any discount.

A computer program operating on the central depository 140 may create a CGI-based referral hyperlink to the specific web address of the merchant and product desired with the referral information included and sends the link to the referred user's interne browser. Using this method, the central depository 140 routes the referred user 120 to the specific merchant 160 with this hyperlink. Additionally, the central depository 140 sends the referral information electronically to the merchant directly 160. The merchant 160 receives the referral information directly from the central depository 140 and automatically updates the referral information with the appropriate central depository 160-140, payment depository 160-150, referring user 160-110, referring site 160-130, and referred user accounts 160-120. In addition, the merchant 160 receives the referral hyperlink and parses the CGI referral information. The merchant 160 verifies the referral information with the referring user account 160-110 and the referred user account 160-120.

Encryption Example

The section below describes the encryption process for a time stamp link. The same process can be applied to non-time stamped links disclosed above.

Central depository 140 runs an encryption program to encrypt the following information in a hyperlink: the time the advertising hyperlink was created, the identity of the referring user 110, the identity of the merchant 160, the identity of the product. The encryption works using available encryption methods or by doing the following. At the time the referring user 110 activates the “Advertise this!” hyperlink, the name of referring user 110 will be encoded, e.g., as a series of random numbers, symbols and/or letters. For example, the referring user name may be encoded at 1:00 pm, May 9, 2012 as: a13rw*oa98. However, at 1:01, May 9, 2012 the name will be encoded as &n24kanfo1ahg8. All numbers, symbols, and letters are assigned randomly in this example.

At this time, the identities of merchant 160, the specific product, the payment depository 150, the specific web address, the specific referral rate, and any discounts are encoded in the same way. At the same time, the central depository 140 encodes the time of the creation of the hyperlink somewhere within the hyperlink in the same way. An example encrypted hyper link is: http://www.EXAMPLE-CENTRAL-DEPOSITORY.com/cig-bin/updateandstore.cgi?1huokhf$$aknakjf90&8houhnk1̂*1h8&9ahiu9812hnhok&̂ihua1

Here, 1huokhf$$aknakjf90 is a time stamp indicating 1:00 pm, May 9, 2012; 8houhnk1̂*1h8 is the identity of referring user 110; 9ahiu9812hnhok is the merchant identity; ̂ihua1 is the product identity. This random generated value encryption process can be implemented for any additional values necessary to communicate the referral or routing information to the central depository or merchant. The central depository 140 stores the encrypted information with the true values at the referring user account 140-110. The central depository 140 stores the time the hyperlink was created with the associated referring user encryption on a master database (e.g., database 144) operating on the central depository system. When the encrypted hyperlink is activated, the hyperlink is parsed by a computer program operating at the central depository, which searches the hyperlink for the time stamp or 1huokhf$$aknakjf90. The time stamp can be any combination of a predetermined number of characters. Once the computer program operating on the central depository system 140 finds the time stamp the central depository 140 performs the update, storage, and routing functions articulated above.

Routing Details

After the referred user 120 activates a hyperlink (e.g., that she received in an email from referring user 110, or that she saw at referring site 130) and the referral data is sent to the central depository 140, the central depository 140 runs a computer program to determine the appropriate routing instructions. The central depository receives the referred user 120 identity from a cookie contained on the referred user computer 121. If the referred user 120 does not have a cookie, the central depository 140 prompts the referred user 120 to log into the referred user account 140-120. If the referred user does not have an account the central depository 140 prompts the referred user 120 to create an account. Prior to or while routing the referred user 120 to the merchant 160 the central depository 140 sends the referred user identity to the merchant via electronic transfer of data such as email. Additionally, the central depository edits the referral hyperlink, which sends the referred user 120 to the merchant 160, to reflect the identity of the referred user. This hyperlink would appear as follows: http://www.EXAMPLE-MERCHANT.com/lcdtv1234.html/cgi-bin/updateandstore.cgi?name=tvmagazine&referred+user=George&discount=.1&intitial+referral+fee=.05 &type=c&central+payment+depository=EXAMPLE-CENTRAL-DEPOSITORY.com

In this instance the category “referred+user” and the value “George” has been included. In this example George is the referred user's account identifier associated with the referred user merchant account 160-120 and optionally the referred user central depository account 140-120. If the merchant does not have a referred user account 160-120, the merchant 160 uses information sent from the central depository 140 to create that account.

The routing instructions are determined by the referring user 110 and can be for routing to an information page about a particular product, or routing based on a highest ranking according to one or more criteria, e.g., to the lowest price for a particular product, to the highest referral rate for a particular product, the best deal for a particular product, the best geographic location of a particular product, a predetermined user-supplied ranking list, some combination thereof, or directly to a particular merchant.

Display Information Page

If the central depository 140 displays an information page, the routing instructions informing the central depository system 140 to do so are attached to the routing referral routing hyperlink received by the referring site 130 or referring user 110. This could be as follows: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route=infop

Here, “infop” instructs a computer program operated by the central depository 140 to display specific information (e.g., using an HTML page) about LCD televisions from a collection of HTML documents servable by web server 142a. Upon receiving and parsing the hyperlink, the central depository 140 displays an information page about the product, with additional hyperlinks to the lowest prices for the product. If the referred user 120 has selected a particular merchant, then the central depository 140 displays the product(s) offered by that merchant and optionally the price rank for similar or identical products. Optionally, the central depository 140 displays the location of the store for each product. The referring user 110 and/or the referring site 130 identity may be inserted in the referral routing hyperlink as described above.

Route to Lowest Price

If the central depository 140 routes the referred user 120 to the lowest price, the routing instructions informing the central depository system 140 to do so are attached to the referral routing hyperlink received by the referring site 130 or referring user 110. This may be as follows: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route=lp

Here, “lp” instructs a computer program operated by the central depository 140 to route the referred user 120 to the merchant with the lowest price. The central depository 140 runs a computer program to determine the lowest price for the product selected by the referred user 120. The computer program searches the price list at database 144 to determine the lowest price. In one embodiment, the central depository 140 runs a computer program to average the merchant's prices compared to other merchants to determine the merchant's price level. If a type of business is selected, the central depository 140 sends the referred user 120 to the merchant with the lowest average price of products. The computer program associates the lowest price with a web-address of the product offered by the merchant. In some embodiments, the central depository 140 receives confirmation that the web page is operable before sending the referred user 120 to the website. The central depository does this by receiving data from the website that indicates the site is operational. If the site is not operational then the program repeats the process for the next lowest price site, etc., until it has found an operational site. The computer program sends the referred user 120 to the first operational site with the lowest price. The referring user 110 and/or referring site 130 identity could be inserted in the referral routing hyperlink.

Route Based on Geographic Criteria

In some embodiments, the computer program at the central depository 140 routes the referred user 120 based on geographic proximity, e.g., searches the nearest store location and price and finds the lowest price within 5 miles, within 10 miles, with 25 miles, within 100 miles, or any other distance. The referring site receives from the central depository a referral routing hyperlink with instructions to find the lowest price for geographic location. This could be as follows: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route1=lp&route2=geo10

Here, “lp” and “geo10” instructs a computer program operated by the central depository 140 to route the referred user 120 to the merchant with the lowest price for led televisions for the geographic location within 10 miles of the referred user 120. The lowest price is determined from database 144. The central depository 140 obtains the location of the referred user 120 when the referred user 120 enters her address or location when creating account 140-120 and can be changed by the referred user 120 accessing the referred user's account settings. The central depository 140 obtains the locations of various merchants from the merchant accounts (i.e., an account similar to account 140-160 for respective merchants), which identify the address(es) or location of the merchants. The central depository 140 then routes the referred user 120 to the merchant 160 with the lowest price within the specified geographic location. The geographic location can also be determined from a device (e.g., a mobile device such as a smart phone) with geographic location (geolocation) functionality. In this embodiment, the referred user account 140-120 is updated by the geolocation of the phone. The identity of referring user 110 and/or referring site 130 may be inserted in the referral routing hyperlink.

Route to Highest Referral Rate

If the central depository 140 routes the referred user 120 to the highest referral rate, the routing instructions informing the central depository system 140 to do so are attached to the referral routing hyperlink received by the referring site 130. The highest referral rate is the amount paid by the merchant to the referring site or the referring user for referring the product. This could be as follows: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route=hrr

Here, “hrr” instructs a computer program operated by the central depository 140 to route the referred user 120 to the merchant with the highest referral rate. The central depository 140 runs a computer program that searches database 144 to determine the highest referral rate for the product selected by the referred user. If a type of merchant (as opposed to a specific merchant) is selected, the central depository sends the referred user 120 to the merchant with the highest referral rate for referring the merchant generally. The computer program associates the highest referral rate with a web-address of product offered by the merchant. In some embodiments, the central depository 140 receives confirmation that the web page is operable before sending the referred user 120 to the website. The central depository does this by receiving data from the website that indicate the site is operational. If the site is not operational then the program repeats the process for the next highest referral rate site, until it has found an operational site. The computer program sends the referred user 120 to the first operational site with the highest referral rate. The identity of referring user 110 or referring site 130 may be inserted in the routing referral hyperlink as described above.

Optionally, the computer program searches based on store proximity and price and finds the lowest price within 5 miles, within 10 miles, with 25 miles, within 100 miles, or any other distance. The referring site 130 receives from the central depository 140 a referral routing hyperlink with instructions to find the highest referral rate at the specified distance from a geographic location. This may be as follows: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route1=hrr&route2=geo20

Here, “hrr” and “geo20” instructs a computer program operated by the central depository 140 to route the referred user 120 to the merchant with the highest referral rate for lcd televisions within 20 miles from the referred user 120. The highest referral rate is determined from database 144. The locations of referred user 120 and various merchants are determined as described above regarding routing based on geographic criteria. The central depository 140 then routes the referred user 120 to the merchant with the highest referral rate meeting the specified geographic criteria. The geographic location can also be determined from a device (e.g., a mobile device such as a smart phone) with geographic location (geolocation) functionality. In this embodiment, the referred user account 140-120 is updated by the geolocation of the phone. The identity of referring user 110 or referring site 130 may be inserted in the referral hyperlink.

Route to Best Deal (Route Based on Valuation Metric)

If central depository 140 routes the referred user 120 to the best deal, the routing instructions informing the central depository system 140 to do so are attached to the referral routing hyperlink received by the referring site. This could be as follows:

http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route=bd

Here, “bd” instructs a computer program operated by the central depository 140 to route the referred user 120 to the merchant with the best deal according to a valuation metric. The central depository runs a computer program that searches price list information and referral rate information at database 144 to determine the best deals for the good, service, merchant, or intellectual property selected by the referred user. The best deal is calculated by considering the price of the product, any discount(s) to the referred user 120 and the amount of the referral rate to the referring user 110. The computer program operating on the central depository system 140 then sorts the referral list to create a best deal list based on the following valuation metric: Price−(Referral Rate+Discount). The computer program associates the best deal with a web-address of the product offered by the merchant. In some embodiments, the central depository 140 receives confirmation that the web page is operable before sending the referred user 120 to the website. The central depository does this by receiving data from the website that indicate the site is operational. If the site is not operational then the program repeats the process for the site with the next best deal, until it has found an operational site. The computer program sends the referred user 120 to the first operational site with the best deal. The identity of referring user 110 or referring site 130 may be inserted in the routing referral hyperlink.

Optionally the computer program searches based on store proximity and best deal and finds the lowest price within 5 miles, within 10 miles, with 25 miles, within 100 miles, or any distance. The referring site 130 receives from the central depository 140 a referral routing hyperlink with instructions to find the best deal at the specified distance from a geographic location. This could take the form of the following hyperlink: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route1=bd&route2=geo20

Here, “bd” and “geo20” instructs a computer program operated by the central depository 140 to route the referred user 120 to the merchant with the best deal on led televisions for the geographic location within 20 miles of the referred user 120. The best deal is determined from a computer program operating on the central depository system 140 searching price list information and referral rate information at database 144 as described previously. The locations of stores and of the referred user 120 may be determined as described above and may include geographic location of a device of the referred user 120.

Routing Based on User-Supplied Rankings

In some embodiments, the referring site 130 or referring user 110 can enter identifying information about which product(s) the referring site 130 or referring user 110 likes in ranking format by category (such a ranking may be called a user-supplied ranking). For example, suppose the referring site 130 has a ranking of a particular type of product (e.g., televisions). The referring site 130 may enter information about which televisions are the best, second best, third best, etc. The referring site 130 enters this information in response to prompts from the central depository 140 received by the referring site 130 as HTML documents (i.e., the referring site 130 may provide such inputs on web forms). The referring site 130 then enters the price difference between the first best, second best, third best, and so on to make a lower ranked television preferable to a higher ranked television. Further, the referring site 130 may enter the referral rate difference between the first best, second best, third best and so on to make a lower ranked television preferable to a higher ranked television. Further, the referring site 130 may enter the best deal difference between the first best, second best, third best and so on to make a lower ranked television preferable to a higher ranked television. Further, the referring site 130 may enter the recommended distance to store offering the television to rank a lower ranked television over a higher ranked television. This can be accomplished by adding an additional instruction of “rank” to the hyperlink as follows. http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route1=rank&route2=geo20

The “rank” when parsed would instruct the computer program operating on the central depository's system to route the user to the highest ranked lctv as determined by the referring site 130 within 20 miles. The referring site 130 can optionally select which merchant the referring site 130 desires the referred user 120 to be sent to for a product. See the following example hyperlink: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&url=EXAMPLE-MERCHANT.com/lcdtv1234.html

The hyperlink contains the following information. The initial routing instructions are to the central depository 140 or “www.EXAMPLE-CENTRAL-DEPOSITORY.com.” The hyperlink contains the specific web address of the desired product and merchant “EXAMPLE-MERCHANT.com/lcdtv1234.html.” Upon being transferred to the central depository 140, the hyperlink is parsed to determine the referral data, discount data, and routing instructions to send the referred user to the central depository and then to the specific product at a particular merchant's web page (in this instance to www.EXAMPLE-MERCHANT.com/lcdtv1234.html).

Referring user 110 may, instead of referring site 130, perform the above instructions to determine routing.

Limited Advertising Budget Routing

In some embodiments, central depository 140 keeps track of the advertising budgets of various merchants and publishes the advertising budget in the form of a list accessible to Internet users via the web. The advertising budget is the amount the merchant is willing to pay to all referring users 110 before paying nothing to all users or a certain group of users. The advertising budget can be unlimited or limited to initial referral fees or other fee categories if a variable referral rate is used. The central depository 140 receives an advertising budget by sending a request to merchant 160 electronically. The merchant 160 replies electronically with an automatic update of the advertising budget for that merchant. A computer program operating by the central depository 140 receives the merchant's reply and causes the updated advertising budget to be displayed to Internet users by web server 142a. The merchant 160 has the option of not displaying the advertising budget.

In performing the routing function, the central depository 140 may search the advertising budget of merchant 160 and provide routing on the basis of the advertising budget, or based on the advertising budget and also price, best deal, highest referral rate, location, category, or rankings.

In the event that the central depository 140 routes the referred user 120 to the highest advertising budget, the routing instructions informing the central depository 140 to do so are attached to the routing referral hyperlink received by the referring site 130 or referring user 110. This could be as follows: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route=hab

Here, “hab” instructs a computer program operated by the central depository 140 to route the referred user 120 to the merchant 160 with the highest advertising budget. The central depository 140 runs a computer program to determine the highest advertising budget for the product selected by the referred user. The computer program searches the advertising budget list at database 144 to determine the highest advertising budget for the selected product. The computer program associates the highest advertising budget with a web-address of the product. In one embodiment, the central depository 140 receives confirmation that the web page is operable before sending the referred user 120 to the website. The central depository 140 does this by receiving data from the website that indicate the site is operational. If the site is not operational, then the program repeats the process for the next highest advertising budget site, etc., until it has found an operational site. The computer program sends the referred user 120 to the first operational site with the highest advertising budget. The identity of referring user 110 may be inserted in the routing referral hyperlink.

For a combination of highest advertising budget and lowest price the hyperlink may be as follows: http://www.EXAMPLE-CENTRAL-DEPOSITORY.com/cgi-bin/updateandstore.cgi?name=tvmagazine&discount=.1&intitial+referral+fee=.05&type=c&central+payment+depository=CPD&item=lcdtv&route1=lp&route2=hab

Here, lp corresponds to lowest price; hab corresponds to highest advertising budget; Tvmagazine is the referring site; .05 is the referral rate; lcdtv is the product category; CPD designates routing instructions to the central payment depository to route funds; and EXAMPLE-CENTRAL-DEPOSITORY.com is the central depository. The central depository has a minimum advertising budget to be considered which can be determined by the referring site through entry to the central depository. Upon activation of the hyperlink the central depository searches a list of all merchants with the minimum advertising budget selling the desired product. Then the central depository searches the lowest price for all those listed merchants with at least the minimum advertising budget.

Online Merchant Discount Process:

Upon activating a hyperlink, the referred user 120 is transferred to the central depository 140. The central depository receives the referred user 120 identity from a cookie, or manual entry. The central depository accesses the database 144 to determine the discount information that the referring site 130 and/or referring user 110 were entitled to give the referred user 120. The central depository stores the item selected, merchant, and total entitled discounts with the referred user's account 140-120. Optionally, the central depository 140 stores the referring user identity, the referring site identity, the referral rate, routing instructions with the referred user's account 140-120. The merchant may elect to give certain referred users an additional discount. In this embodiment the merchant sends the central depository the referred user account identifier and the additional discount amount the referred user 120 is entitled to receive from the merchant. This additional discount is in addition to the discount the referred user is entitled to receive from the referring party or central depository by activating a referral hyperlink.

The central depository 140 automatically sends the referred user identity and discount information to the merchant 160 upon activation of the referral hyperlink, which is routed through the central depository 140. Upon receiving this information, the merchant 160 creates referred user account 160-120, or searches database 164 for pre-existing referred user account 160-120. The merchant 160 automatically updates and stores the discount with the associated referred user at account 160-120. The merchant 160 stores some or all information received from the central depository with the account 160-120. The referred user 120 selects an item for purchase from the merchant 160. Upon finding the referred user account 160-120, the merchant processes all discount(s) associated with that account. The merchant 160 sells the item to the referred user 120 with the discounts.

In an alternative embodiment, the merchant 160 does not receive the discount information from the central depository upon activation of the referral hyperlink. After the referred user 120 selects an item for purchase from the merchant 160, the merchant 160 sends a request to the central depository 140 for the discount information associated with the referred user's identity. The referred user 120 enters the referred user's central depository account identifier so that the central depository may access the referred user's central depository account 140-120. The central depository 140 searches database 144 to find referred user account 140-120. The central depository 140 then searches referred user account 140-120 for the specific merchant using the common merchant identification that was provided to the central depository 140 by that merchant when creating account 140-160 and again when making the request for discount information. The central depository 140 then sends the merchant 160 the referred user discount information associated with the merchant electronically. The merchant 160 receives the discounts associated with the referred user 120 for the merchant 160 from the central depository. The merchant 160 processes all relevant discount(s) for the referred user 120. The merchant 160 sells the item to the referred user 120 with the discounts.

Machine Readable Card Process for Referred User Discount

In some embodiments, the central depository 140 sends the referred user 120 a machine readable card containing the referred user account 140-120 information. The referred user 120 may receive central depository identification which can be transmitted to the merchant 160 electronically using a phone or other electronic device. The central depository 140 automatically sends the referred user identity and discount information to the merchant 160 upon activation of the referral hyperlink, which is routed through the central depository 140. Upon receiving this information, the merchant 160 creates referred user account 160-120, or searches database 164 for pre-existing referred user account 160-120. The merchant 160 automatically updates and stores the discount with the associated referred user at account 160-120.

The referred user 120 travels to the place of business of merchant 160. The referred user provides her machine readable card or other form of central depository identity to merchant 160. The merchant 160 enters the machine readable card into the system. In an alternative embodiment, the merchant receives the electronic transfer of the referred user's identity 120 from an electronic device. One of two processes occurs next.

In one case, the merchant 160 receives the referred user's common referred user identity from the machine readable card or electronic device. The merchant 160 searches the merchant database 164 for the referred user account 160-120. Upon finding the referred user account 160-120, the merchant processes all discount(s) associated with that account. The merchant 160 sells the item to the referred user 120 with the discounts.

In another case, the merchant 160 receives the referred user's common referred user identity from the machine readable card or electronic device and sends a request to the central depository 140 for discount information regarding the referred user 120. The central depository 140 searches database 144 to find referred user account 140-120. The central depository 140 then searches referred user account 140-120 for the specific merchant using the common merchant identification that was provided to the central depository 140 by that merchant when creating account 140-160 and again when making the request for discount information. The central depository 140 then sends the merchant 160 the referred user discount information electronically. The merchant 160 processes all relevant discount(s) for the referred user 120. The merchant 160 sells the item to the referred user 120 with the discounts. Optionally, the merchant 160 updates and stores the referred user account 160-120 to reflect the discounts.

Account Routing Feature

If the referring site 130 and/or referring user 110 has selected a product with routing instructions, then upon receiving the activation of the routing referral hyperlink by the referred user and determination of the appropriate routing merchant 160 by the central depository 140, the central depository 140 automatically sends referring user account 140-110 information and/or referring site account 140-130 information to the routing merchant 160 electronically. If the referring user 110 and/or referring site 130 is not assigned a common referring user and/or referring site identification, the merchant 160 assigns the referring user 110 and/or referring site 130 an identification and sends this information to the central depository 140. The central depository 140 then automatically updates the referring user account 140-110 and/or referring site account 140-130 to reflect the specific referring user and/or referring site merchant referral identity. The central depository 140 then sends the referring user and/or referring site merchant identification back to the merchant 160 along with the activated advertisement information.

Automatic Search and Update of New Products by Central Depository

A computer program operating on the central depository system 140 may search the website of merchant 160 for new products offered by that merchant and the associated referral rates. Such a search may occur periodically or aperiodically. The merchant 160 has the option of selecting a standard referral rate for all products offered by the merchant. If so, then upon the central depository computer program finding a new product (one that was not already catalogued by the central depository 140), the central depository 140 automatically updates merchant account 140-160 to reflect the new product and associated referral rate. In an alternative embodiment, the merchant 160 informs central depository 140 to update merchant account 140-160 to reflect new products and referral rates.

Merchant Receives Information; Receive Payment from Merchant.

Upon the referred user 120 activating the hyperlink, the central depository 140 sends the merchant 160 the following data: identity of the referring site 130, the identity of the central depository 140, the identity of the specific product requested, the identity of the general product or merchant selected, any appropriate discounts, and, optionally the identity of the referring user 110 the identity of the payment depository 150, the amount of the referral rate and the identity of the referred user 120. The identities of the referring site 130, referring user 110, and referred user 120 can be merchant-specific identities or a common referring site or referring user identity. This information can be displayed in the form of a dynamic web page operating on the merchant system 160 which contains the above information. An example hyperlink is: http://www.EXAMPLE-MERCHANT.com/lcdtv1234.html/cgi-bin/routingstorage.cgi?type=c&name=Phyllis&Posting+Site=tvmagazine.com&Discount=.1&intitial+referral+fee=.005&central+payment+depository=EXAMPLE-CENTRAL-DEPOSITORY.com&Purchasing+User=George

In this example the web address is www.EXAMPLE-MERCHANT.com/lcdtv1234. Lcdtv1234 is a specific type of TV. “.005” is the referral rate. “EXAMPLE-CENTRAL-DEPOSITORY.com” is the identity of the central depository 140. “Tvmagazine” is the identity of the referring site 130. “Phyllis” is the identity of the referring user 110. “.1” is the amount of the discount.

For a product type rather than a specific product, the an example hyperlink is: http://www.EXAMPLE-MERCHANT.com/lcdtvs.html/cgi-bin/routingstorage.cgi?type=c&name=Phyllis&Posting+Site=tvmagazine.com&Discount=.1&intitial+referral+fee=.005&central+payment+depository=EXAMPLE-CENTRAL-DEPOSITORY.com&Purchasing+User=George

Upon receiving this information from the central depository 140, a computer program operating on the merchant system 160 parses this information and determines the identity of the referring site 130 or referring user 110. The merchant 160 creates a referring user account 160-110 and stores this information with the referring user account. The merchant 160 creates a referring site account 160-130 and stores this information with the referring site account. The merchant creates a referred user account 160-120 and stores this information with the referred user account. The merchant updates a central depository account 160-140 to reflect this information.

The merchant 160 sends the referred user 120 a web page of the merchant containing more details about the item.

The merchant pays the referring site 130 and optionally, the central depository 140 a processing fee. In one embodiment, the merchant 160 pays the referring user 110 or referring site 130 after a predetermined monetary obligation is met or after a certain number of successful referrals. Payment can be made automatically via current electronic payment methods. The merchant pays the referring user a referral fee. The referral fee can be in the form of discounts on future purchases, money, or other incentives. The referring user may receive monetary compensation. In one embodiment, the merchant pays the referring site a fee with instructions to pay the referring user a percentage of the fee. If the referring user with referring site method is employed the referring site takes a percentage of the referring user click fee as a posting fee. Payment is made using any payment method, e.g., using an automated clearinghouse to directly deposit funds in the referring user's or referring sites' bank account, mailing the referring user or referring site a check, or giving the referring user or referring site a store credit or any other avenue for payment.

The payment depository 150 may receive payment and an electronic message from the merchant 160 identifying the posting user 110 or posting site 130 and the amount owed. The payment depository 150 parses the electronic message, automatically updates referring user account 150-110 or referring site account 150-130 to reflect the amount owed. Thus, the payment depository 150 is able to effectively associate referring users or referring sites with income received. If the central depository serves as the payment depository and the hyperlink is routed through the central depository, the amount owed to the referring user 110 or referring site 130 is determined by the number of times the referral hyperlink has been activated and the associated referral rates for each activation. In one embodiment, the central depository 140 sends the activation data and amount owed to the referring user or referring site to the payment depository 150 via electronic transfer 145. In one embodiment the central depository 140 sends payment request to the merchant 160 to pay the referring site 130 or referring user 110.

In one embodiment, referring site 130 electronically sends payment depository 150 the outgoing data or the successful activation of a hyperlink posted by posting user 110. This is to efficiently monitor and receive the payment of posting fees. The payment depository 150 receives this information and automatically updates referring user account 150-110 and referring site account 150-130 to reflect the activation and amount owed as either a referral fee or a posting fee. This enables verification that the merchant 160 did in fact pay what it was supposed to and provides a cost efficient method for referring site 130 to collect posting fees.

In one embodiment, the merchant 160 pays the payment depository 150 for all referring users 110 accumulated over a given time period, such as a day, hour, minute, or per a certain number of transactions. Upon reaching a sufficient level or amount owed to all referring users 110 or referring sites 130 with the payment depository 150, the payment depository 150 sends the merchant an electronic message notifying the merchant that payment is due and the amount of payment. This allows the central depository 150 to collect payment for massive amounts of users and prevents the merchant 160 from having to pay each referring user 110 individually. This saves the referring user 110 and the merchant 160 in terms of processing fees by grouping the transactions into one bulk transaction to the payment depository 150. This allows referring users 110 to post on various websites and receive their entire click fee earnings in one central location. Merchant 160 pays payment depository 150 using any payment method.

The payment depository 150 then stores the amount owed to referring user 110 at referring user account 150-110. The payment depository 150 displays all the successfully activated paid referral hyperlinks and the amount owed from the merchant 160. The payment depository 150 displays whether payment has been made to the payment depository 150 by the merchant 160. The payment depository may charge merchant 160 a processing fee for making the transaction. In some embodiments, the referring user 110 can request payment at any time and is paid the processing fee by the payment depository 150. In some embodiments, the referring user 110 may be paid upon a certain amount collected from all merchants, e.g., 10, 100, or 200 dollars. The payment depository 150 pays the referring user 110 using any available payment method.

The payment depository 150 may be used to pay referring sites 110, which operate various commonly owned sites. The payment depository 150 performs the same functions described above regarding referring sites. In one embodiment, the payment depository 150 is used to pay the central depository 140 a processing fee.

Payment Details

As described above, several techniques are available in various embodiments for merchant 160 to pay a referring user 110: pay upon sale, pay per click, pay per impression, and a variable referral rate. An online pay per sale technique involves merchant 160 receiving the referring user and referred user data via electronic message in the form of an embedded web address, tracking the referred user 120 from entry to the merchant's website to purchase, submitting payment to the payment depository 150 for the referring user and/or referring site upon a sale. The central depository 140 receives the referring user and/or referring site referral information and payment.

Details of Pay Per Sale Online Approach

The online pay per sale technique is now described in more detail. The central depository 140 or the merchant 160 sends an initial hyperlink with the referral amount to the referring user 110. An example of the hyperlink is: http://www.EXAMPLE-CENTRAL-DEPOSITORY.com/cgi-bin/routingstorage.cgi?type=s&name=George+Beighley&Discount=.1&intitial+referral+fee=.005&central+payment+depository=CPD&URL=EXAMPLE-MERCHANT.com/lcdtv1234.html

The referral amount is the “.005” mentioned in the above hyperlink. This means the referring user is paid 0.5% of the sale price. The “s” allows the merchant and central depository to know that the referral fee is paid only upon a sale. The referring user 110 posts the hyperlink with the discount, e.g., by posting via social networks. The referred user 120 activates the hyperlink with the discount. The hyperlink is parsed by the central depository 140. If the referring user 110 posts on a referring site 130 that automatically inserts the identity of the referring site 130 into the hyperlink before displaying the hyperlink to potential referred user. The hyperlink may look like the following when received by the central depository: http://www.EXAMPLE-CENTRAL-DEPOSITORY.com/cgi-bin/routingstorage.cgi?type=s&name=George+Beighley&Posting+Site=Example-Referring-Site&Discount=.1&intitial+referral+fee=.005&central+payment+depository=CPD&URL=EXAMPLE-MERCHANT.com/lcdtv1234.html

The hyperlink may be encrypted and the referring site identity may be encrypted when added to the hyperlink by the referring site.

Here, www.EXAMPLE-CENTRAL-DEPOSITORY.com is the central depository identity; Cgi-bin is the identity of the common gate way interface directory for EXAMPLE-CENTRAL-DEPOSITORY.com; “?” indicates that information will follow; Type is the variable name indicating type of payment; S is the value meaning pay per sale; Name corresponds to the referring user 110; George+Beighley is the value identity of the referring user; Example-Referring-Site is referring site 130; .1 is the discount; .005 is the initial referral fee (i.e., 0.5%); CPD is the payment depository 150; EXAMPLE-MERCHANT.com/lcdtv1234.html is the routing URL address (web address of the referred product).

The central depository 140 acquires the referred user identity from a cookie downloaded from the central depository to the referred user 110 at an earlier session or from manual entry by the referred user to the central depository. The central depository 140 stores the referral information with the referring user's and referred user's accounts 140-110 and 140-120, respectively, on database 144. The central depository 140 then reassembles the parsed information in the form of a second hyperlink which contains the discount embedded within it. An example of the second hyperlink is: http://www.EXAMPLE-MERCHANT.com/lcdtv1234.html/cgi-bin/routingstorage.cgi?type=s&name=George+Beighley&Posting+Site=facebook.com&Discount=.1&intitial+referral+fee=.005&central+payment+depository=CPD&Purchasing+User=Phyllis

Here, the referral rate remains “.005” or 0.5% of the sale price. The central depository 140 acquires the referred user identity from a cookie downloaded from the central depository to the referred user 120 at an earlier session or from manual entry. The referred user 120 is Phyllis in this example.

The central depository 140 automatically sends the second hyperlink to the referred user's browser, which transfers the referred user to the merchant 160. The central depository 140 sends the merchant 160 all information necessary to create a referred user account 160-120, referring site account 160-130, and referring user account 160-10 in the form of electronic transfer of data (e.g., email or CGI-GET or POST method), and merchant 160 creates these accounts. The merchant 160 receives the referral information from the central depository 140 and automatically stores the information on the merchant's server with the associated referred user account 160-120, referring site account 160-130, and referring user account 160-110. The merchant 160 tracks the referred user 120 from entry to website to sale.

In one embodiment, if the referred user 120 makes a purchase of a different item than originally referred (a second item), the merchant 160 accesses the referred users account 160-120 to determine the most recent referring party (110, 130). Optionally, the merchant 160 determines the referral fee for the second item or the referral fee for the merchant generally owed to the referring party (110, 130). Upon a sale of the second item, the merchant 160 pays the referral fee to the most recent referring party (110, 130).

Upon making a sale the merchant 160 pays the referring user 120 and referring site 130 either through the payment depository 150 or directly. The merchant 160 may send an electronic message to the central depository 140 or payment depository 150 notifying the central depository 140 or payment depository 150 of the successful purchase. In one embodiment, the referring site is the exclusive referring entity.

In an offline pay per sale technique, the central depository 140 sends the referred user 120 and referring user 110 identity to the merchant 160. The merchant 160 creates a referred user account 160-120 and stores the referring user identity and discounts with the referred user account 160-120. The merchant 160 receives an machine readable card with the referred user identity. In one embodiment, the merchant 160 receives the referred user 120 central depository identification electronically from a phone or other electronic device. The merchant accesses the merchant's system 160 to determine the identity of the referring user 110 associated with the referred user 120. The merchant 160 pays the referring user 110.

Details of Pay Per Sale Offline Approach

An offline pay per sale technique is now described. The central depository 140 or the merchant 160 sends an initial hyperlink with the referral amount to the referring user 110. An example of the hyperlink is: http://www.EXAMPLE-CENTRAL-DEPOSITORY.com/cgi-bin/routingstorage.cgi ?type=s&name=George+Beighley&Discount=.1&intitial+referral+fee=.005&central+payment+depository=CPD&URL=EXAMPLE-MERCHANT.com/lcdtv1234.html

The referring user 110 posts the hyperlink with the discount. The referred user 120 activates the hyperlink with the discount. The hyperlink is parsed by the central depository 140. If the referring user 110 posts on a referring site 130 that automatically inserts the identity of the referring site 130 into the hyperlink before displaying the hyperlink to potential referred users the hyperlink might look like the following when received by the central depository http://www.EXAMPLE-CENTRAL-DEPOSITORY.com/cgi-bin/routingstorage.cgi?type=s&name=George+Beighley&Posting+Site=Example-Referring-Site&Discount=.1&intitial+referral+fee=.005&central+payment+depository=CPD&URL=EXAMPLE-MERCHANT.com/lcdtv1234.html

The fields in this hyperlink were described above for the online pay per sale approach. The central depository 140 acquires the referred user identity from a cookie downloaded from the central depository to the referred user 120 at an earlier session or from manual entry by the referred user to the central depository. The central depository 140 stores the referral information with the referring user's and referred user's accounts 140-110 and 140-120, respectively, on database 144. The central depository 140 then reassembles the parsed information in the form of a second hyperlink which contains the discount embedded within it. An example of the second hyperlink is: http://www.EXAMPLE-MERCHANT.com/lcdtv1234.html/cgi-bin/routingstorage.cgi?type=s&name=George+Beighley&Posting+Site=Example-Referring-Site&Discount=.1&intitial+referral+fee=.005&central+payment+depository=CPD&Purchasing+User=Phyllis

The central depository automatically sends the second hyperlink to the referred user's browser, which transfers the referred user to the merchant 160.

The central depository 140 sends the merchant 160 all information necessary to create a referred user account 160-120, referring site account 160-130, and referring user account 160-110 in the form of electronic transfer of data, merchant 160 creates these accounts. The merchant 160 receives the referral information from the central depository 140 and automatically stores the information on the merchant's server with the associated referred user account 160-120, referring site account 160-130, and referring user account 160-110. The referred user 120 travels to the merchant's place of business.

Unlike the online pay per sale approach, the merchant at receives from the referring user 110 a machine readable card containing the identity of the referred user 120. In one embodiment, the merchant 160 receives the referred user 120 central depository identification electronically from a phone or other electronic device. The merchant 160 accesses referred user account 160-120 to find the identity of the referring user. The referred user 120 makes purchase. Upon making a sale the merchant 160 pays the referring user 160-110 and referring site 160-130 either through the payment depository 150 or directly. In one embodiment, the merchant 160 sends an electronic message to the central depository 140 or payment depository 150 notifying the central depository 140 or payment depository 150 of the successful purchase.

The merchant 160 may request the referred user's associated discount information for the specific merchant, and the referring user identity and/or the referring site identity, and any discounts associated with the referring user and/or referring site from the central depository 140 following the receipt of the referred user's central depository identity. The central depository 140 sends this information about the referred user to the merchant 160. The merchant automatically updates the referred user account 160-120, the referring user account 160-110, and/or the referring site account 160-130 to reflect the successful referral. Upon making a sale the merchant 160 pays the referring user 160-110 and referring site 160-130 either through the payment depository 150 or directly. In one embodiment, the merchant 160 sends an electronic message to the central depository 140 or payment depository 150 notifying the central depository 140 or payment depository 150 of the successful purchase. In one embodiment, the referring site is the exclusive referring entity.

In the pay per click approach, the merchant 160 pays the referring user 110 upon activation of a referral hyperlink by the referred user 120. The referring user identity is embedded within the referral hyperlink, which is routed through the central depository 140 to the merchant 160. Upon the receipt of the referred user 120 at the merchant's website and receipt of an electronic message from the referred user 120 containing the identity of the referring user 110 and optionally referring site 130, the merchant 160 sends payment for the referring user 110, referring site 130, and central depository 140 to the payment depository 150.

Details of Pay Per Click Approach

A pay per click technique is now described. The central depository 140 or the merchant 160 sends an initial hyperlink with the referral amount to the referring user 110. An example of the hyperlink is: http://www.EXAMPLE-CENTRAL-DEPOSITORY.com/cgi-bin/routingstorage.cgi?type=c&name=George+Beighley&Discount=.1&intitial+referral+fee=.005&central+payment+depository=CPD&URL=EXAMPLE-MERCHANT.com/lcdtv1234.html

The referral amount is the “.005” mentioned in the above hyperlink. This means the referring user is paid 0.005 cents per click. The “c” in “type=c” allows the merchant and central depository to know that the referral fee is paid upon a click. The referring user 110 posts the hyperlink with the discount. The referred user 120 activates the hyperlink with the discount. The hyperlink is parsed by the central depository 140. If the referring user 110 posts on a referring site 130 that automatically inserts the identity of the referring site 130 into the hyperlink before displaying the hyperlink to potential referred users the hyperlink might look like the following when received by the central depository: http://www.EXAMPLE-CENTRAL-DEPOSITORY.com/cgi-bin/routingstorage.cgi?type=c&name=George+Beighley&Posting+Site=Example-Referring-Site&Discount=.1&intitial+referral+fee=.005&central+payment+depository=CPD&URL=EXAMPLE-MERCHANT.com/lcdtv1234.html

The central depository 140 stores the referral information with the referring user account 140-110 on database 144. The central depository 140 then reassembles the parsed information in the form of a second hyperlink which contains the discount embedded within it. An example of the second hyperlink is: http://www.EXAMPLE-MERCHANT.com/lcdtv1234.html/cgi-bin/routingstorage.cgi?type=c&name=George+Beighley&Posting+Site=Example-Referring-Site&Discount=.1&intitial+referral+fee=.005&central+payment+depository=CPD&Purchasing+User=Phyllis

The central depository automatically sends the second hyperlink to the referred user's browser, which transfers the referred user to the merchant 160. The merchant 160 receives the referral amount from the referred user's browser and automatically stores the information on the merchant's server with the associated referred user account 160-120 and referring user account 160-110. The central depository 140 sends the merchant 160 a notice for payment to pay the referring user 110 and/or referring site 130.

Upon reaching a sufficient level or amount owed to all referring users 110 or referring sites 130 with the central depository 140, the central depository 140 may send the merchant an electronic message notifying the merchant that payment is due and the amount of payment. The merchant 160 pays the central depository 140 the referring user fee, which is then paid to the referring user 110. Optionally, the merchant 160 pays the referring user 110 directly. Optionally, the merchant 160 pays a central depository fee to the central depository 140. The merchant 160 pays the referring site 130 directly or through the payment depository 150.

In the variable referral rate approach, the referral rate may decrease with lack of sales and increase with sales. For every click that does not lead to a sale, the referring user 110 is paid successively less than before; however if the click results in a sale, the referring user 110 is paid more. This adjustment is at the discretion of the merchant and may vary with the individual user and posting conditions. The merchants are under no obligation to increase the referral rate; they are merely advised to do so in order to keep the hyperlink profitable. In one embodiment, the merchant never discloses sales data to other parties.

Details of Variable Referral Rate Approach

Details of the variable referral rate approach are now described. The central depository 140 or the merchant 160 sends an initial hyperlink with the referral amount to the referring user 110. An example of the hyperlink is: http://www.EXAMPLE-CENTRAL-DEPOSITORY.com/cgi-bin/routingstorage.cgi?type=v&name=George+Beighley&Discount=.1&intitial+referral+fee=.005&central+payment+depository=CPD&URL=EXAMPLE-MERCHANT.com/lcdtv1234.html

The referral amount is the “.005” mentioned in the above hyperlink. This means the referring user 110 is paid 0.005 cents per click. The “v” allows the merchant 160 and central depository 140 to know that the referral fee is paid upon a variable rate following the initial click or clicks. In some embodiments, the entire fee is variable with the initial fee being determined by the location of the referring site 130. In this embodiment the hyperlink may be like the following: http://www.EXAMPLE-CENTRAL-DEPOSITORY.com/cgi-bin/routingstorage.cgi?type=v&name=George+Beighley&Discount=.1 &central+payment+depository=CPD&URL=EXAMPLE-MERCHANT.com/lcdtv1234.html

The referring user 110 posts the hyperlink with the discount. The referred user 120 activates the hyperlink with the discount. The hyperlink is parsed by the central depository 140. If the referring user 110 posts on a referring site 130 that automatically inserts the identity of the referring site 130 into the hyperlink before displaying the hyperlink to potential referred users the hyperlink may look like the following when received by the central depository: http://www.EXAMPLE-CENTRAL-DEPOSITORY.com/cgi-bin/routingstorage.cgi?type=v&name=George+Beighley&Posting+Site=Example-Referring-Site&Discount=.1&intitial+referral+fee=.005&central+payment+depository=CPD&URL=EXAMPLE-MERCHANT.com/lcdtv1234.html

The central depository 140 stores the referral information at referring user account 140-110. The central depository 140 then reassembles the parsed information in the form of a second hyperlink which contains the discount embedded within it. An example of the second hyperlink is: http://www.EXAMPLE-MERCHANT.com/lcdtv1234.html/cgi-bin/routingstorage.cgi?type=v&name=George+Beighley&Posting+Site=Example-Referring-Site&Discount=.1&intitial+referral+fee=.005&central+payment+depository=CPD&Purchasing+User=Phyllis

The central depository 140 acquires the referred user identity from a cookie downloaded from the central depository to the referred user at an earlier session or from manual entry. Here, the referred user is Phyllis. The central depository 140 automatically sends the second hyperlink to the referred user's browser, which transfers the referred user 120 to the merchant 160.

The merchant 160 receives a direct communication from the central depository 140 containing the referral information. In addition, the merchant 160 receives the referral amount from the referred user's browser. The merchant 160 automatically stores the information on the merchant's server with the associated referred user 120 and referring user 110. Optionally the merchant 160 stores the identity of the referring site 130. The merchant 160 pays the referring user 110 an initial referral fee based on the nonexclusive list of the type, number of views, or category of the referring site. The merchant 160 pays the payment depository 150 the referring user fee (which is then paid to the referring user 110) upon the first click or a predetermined number of clicks. Optionally, the merchant 160 pays the referring user 110 directly. Optionally, the merchant pays a central depository fee to the central depository 140. The merchant 160 pays the referring site 130 directly or through the central depository 140.

The merchant 160 determines that a sale has been made and determines posting conditions such as referring site location. The merchant 160 adjusts the referral rate in accordance with what the expected success of the post or posts. The merchant 160 stores the updated referral rate at account 160-110. The merchant 160 sends to the central depository 140 via electronic transfer the referring user identity with the updated referral rate. The central depository 140 automatically updates and stores the referring user's updated referral rate at account 140-110. Optionally, the central depository 140 displays the updated referral rate to the referring user 110. Upon successive clicks, the merchant 160 pays the central depository 140 the referring user fee, which is then paid to the referring user 110. Optionally, the merchant 160 pays the referring user 130 directly. Optionally, the merchant 160 pays a central depository fee to the central depository 140. The merchant 160 pays the referring site 130 directly or through the payment depository 150. As long as the referring user 110 maintains a post (e.g., she does not delete the post from a posting site 130), payment may continue as described above. The referral rate is updated with every click and process is repeated.

In some embodiments, the merchant 160 pays an initial fee for a predetermined number of initial clicks, such as two clicks. For the remaining clicks up to a total of another predetermined number (e.g., ten clicks), the merchant 160 pays a set amount by paying a flat fee per click (i.e., the amount paid per click remains constant) or a variable referral rate. Following the first ten clicks, the merchant 160 pays a variable referral rate. Alternatively, after the initial fee the merchant 160 pays a variable referral rate.

Variable Referral Rate: Premium Status and Routing Method

In some embodiments, a higher referral rate is provided to those referring users who achieve a higher conversion rate. Referral hyperlinks are received by the merchant 160, and the effectiveness of that referring user 110 is monitored by the merchant site 160. For example, merchant 160 can determine whether referred user 120 completes a sale or not. The merchant may track the IP address associated with referred user 120 while on the website of merchant 160 to determine if referred user 120 completes a sale. In this way, merchant 160 can determine which referring users have a higher conversion rate than others. The merchant 160 has the option of designating the referring user 110 as a premium user and selecting an additional referral bonus the merchant is willing to pay to referring user 110 refer future ads.

For example, the merchant 160 may send an electronic message to the central depository 140 indicating that the specific referring user 110 has been approved for premium status or indicating a change in the referral rate. The central depository 140 and/or the payment depository 150 update referring user account 140-110 and/or referring user account 150-110 to reflect the change in referral rates for the merchant 160 for specific products offered by the merchant 160. The central depository 140 displays the updated referral rate on all user specific lists. Further, the central depository 140 displays the premium status to referring user 110 when she logs in to referring user account 150-110 if there has been an increase in the referral rate. The payment depository 150 may receive the updated referral rate from the merchant 160. In a further embodiment, the payment depository 150 receives the updated referral rate from the central depository 140.

In addition, when creating referral hyperlinks, the central depository 140 includes the updated referral rate in the hyperlink. If the referring user 110 has elected to route the referred user 120 to the highest referral rate, the updated referral rates to reflect premium status are used. The referred user 120 clicks on the hyperlink. The central depository 140 parses the hyperlink and determines the product and the referring user 110. The central depository 140 then searches the lists for the specific product with the associated referring user referral rates to determine the highest referral rate. The central depository 140 then routes the referred user 120 to the merchant 160 with the highest specific referral rate for that particular referring user 110.

The following is an example hyperlink for a referring site 130: http://www.EXAMPLE-CENTRAL-DEPOSITORY.com/cgi: bin/updateandstore.cgi?name=tvmagazine&discount=.1&referral+fee=.05&type=c&central+payment+depository=CPD&item=lcdtv&route=hrr

In this instance, the central depository EXAMPLE-CENTRAL-DEPOSITORY.com searches tvmagazine's account to determine the highest referral rate for tvmagazine for lcdtvs. “.05” is the premium referral rate paid to Tvmagazine.

The following is an example hyperlink for a referring user 110: http://www.EXAMPLE-CENTRAL-DEPOSITORY.com/cgi-bin/updateandstore.cgi?name=George&posting+site=tvmagazine&discount=.1&referral+fee=.05&type=c&central+payment+depository=CPD&item=lcdtv&route=hrr

In this instance, the central depository EXAMPLE-CENTRAL-DEPOSITORY.com searches George's account to determine the highest referral rate for George for lcdtvs. “.05” is the premium referral rate paid to George. “.01” is the percent that the referring site 130 takes as a posting fee.

Pay Per Impression by Referring Site Only:

The merchant 160 when creating an account with the central depository 140-160 enters the amount the merchant is willing to pay per impression to a referring site 130. The amount paid to the referring site 130 may depend on the category or type of the referring site and the number of impressions or views. Upon selecting a product for referral, the central depository 140 stores the amount paid per impression with the referring site account 140-130 on the central depository system. The referring site posts the referral hyperlink.

The referring site 130 records and stores the number of views of the referral hyperlink by possible referred users 120. The referring site 130 sends the number of views of the referral hyperlink to the central depository 140 along with the referring site identifier. The central depository stores the number of views of a referral hyperlink with the referring site account 140-130. The central depository 140 demands payment from the merchant 160 upon receiving a minimum number of views or impressions by sending the merchant an electronic message containing the referring site identity, number of views, and the amount owed. The merchant 160 pays the payment depository 150 to pay the referring site 130. Optionally, the merchant 160 pays the referring site 130 directly using any available payment method.

The merchant 160 may update the amount paid to the referring site 130 by sending an electronic communication to the central depository 140 containing the impression rate update and the identifier of the referring site.

Pay Per Impression by Referring Site and Referring User

The merchant 160 when creating an account with the central depository 140-160 enters the amount the merchant 160 is willing to pay per impression to a referring user 110. The amount paid to the referring user 130 may depend on the category or type of the referring site 130 the referring user 110 selects and the number of impressions or views. Upon selecting a product for referral, the central depository 140 stores the amount paid per impression with the referring user account 140-110 on the central depository system.

The referring site 130 informs the referring user 110 the percentage of the impression fee the referring site will take from the referring user 110. The referring site 130 sends notice to the central depository 140 of the percentage of the impression fee taken by the referring site 130 along with the referring site identifier and referring user identifier. The central depository 140 stores the percentage of the impression fee associated with the referring user's referral hyperlink with the referring sites account 140-130, referring user's account 140-110, and merchant account 140-160. The referring user 110 posts the referral hyperlink on the referring site 130.

The referring site 130 records and stores the number of views of the referral hyperlink by possible referred users 120 associated with the referring user's referral hyperlink post. The referring site 130 sends the number of views of the referral hyperlink to the central depository 140 along with the referring site identifier and referring user identifier. The central depository stores the number of views of a referral hyperlink with the referring site account 140-130, the referring user account 140-110, and the merchant account 140-160. The central depository 140 demands payment from the merchant 160 upon receiving a minimum number of views or impressions by sending the merchant an electronic message containing the referring site identity, referring user identity, number of views, and the amount owed. The merchant 160 pays the payment depository 150 to pay the referring site 130 and the referring user 110. Optionally, the merchant 160 pays the referring site 130 directly using any available payment method with instructions to pay the referring user 110. Optionally, the merchant 160 pays the referring user 110 and the referring site 130 separately and directly using any available payment method.

Account Details

Accounts at Central Depository

A single user can have both a referred user account 140-120 and a referring user account 140-110. Referring user account 140-110 stores the following information: referrals created; referrals activated (amount owed); amount paid to payment depository 150; amount received from payment depository 150; referral rate; payment means; basic identifying information. Optionally, the following may be included in referring user account 140-110: identity of the payment depository 150; identity of referred user 120; identity of referring site 130; identity of merchant 160; discount rate; identity of the product. The discount rate stored at referring user account 140-110 can be used to keep track of an additional discount available to a referred user 120 due to having activated a referral link that was published by referring user 110. For example, referred user 120 might have a 10% discount available from merchant 160 due to having clicked a referral link (published by referring user 110) corresponding to a referral of merchant 160 or of a product of merchant 160. If referring user account 140-110 has a discount rate specifying a 5% discount (e.g., because merchant 160 wanted to reward or incentivize referring user 110), then that discount may be aggregated with the 10% discount, to yield a 15% discount for referred user 120.

Referred user account 140-120 stores the following information: referrals activated; identity of referring users 110; identity of referring sites 130; discount rates; identity of the merchants 160; optionally, identity of the product; optionally, referral rates; identifying information.

Referring site account 140-130 stores the following information: referrals created; referrals activated (amount owed); amount paid to payment depository 150; amount received from payment depository 150; referral rate; payment means; basic identifying information; optionally, identity of the payment depository 150; optionally, referred users identity; optionally, referring users identity; optionally, referred merchant identities; optionally, discount rate; optionally, identity of the products. The discount rate at account 140-130 is similar to the discount rate at account 140-110, described above.

Merchant account 140-160 stores the following information: products offered for referral; price of those products; referral rate for those products; discount rate for those products; referring users who have created referral hyperlinks for the merchant; referring sites who have created referral hyperlinks for the merchant; successful activation of referral hyperlinks; identity of referred users who have activated referral hyperlinks; billing address; optionally, deposit account information, with funds to pay future referral fees; amount owed to payment depository 150; amount paid to payment depository 150; amount received by referring users, referring sites, and central depository from payment depository.

Payment depository account 140-150 stores the following information: referring users who have created referral hyperlinks for merchants directed to the payment depository; referring sites that have created referral hyperlinks for merchants directed to the payment depository; successful activation of referral hyperlinks with payment to payment depository; optionally, identity of referring user who have activated referral hyperlinks; billing address; amount owed to payment depository from all from all referring user and referring site central depository accounts and from each individual referring site account or referring user account; amount paid to payment depository from all from all referring user and referring site central depository accounts and from each individual referring site account or referring user account; amount received from payment depository from all referring user and referring site payment depository accounts and from each individual referring site account or referring user account.

Accounts at Merchant

A single user can have both a referred user account 160-120 and a referring user account 160-110. Referring user account 160-110 stores the following information: referrals created; referrals activated (amount owed); amount paid to payment depository; referral rate; central depository identity; payment means; basic identifying information; optionally, identity of the payment depository; optionally, referred user identity; optionally, referring site identity; optionally, discount rate; optionally, identity of the product.

Referred user account 160-120 stores the following information: referrals activated; identity of the referring users; identity of the referring sites; discount rates; identity of the central depository; optionally, identity of the products; successful purchases; identifying information; optionally, referral rates.

Referring site account 160-130 stores the following information: referrals created; referrals activated (amount owed); amount paid to payment depository; referral rate; central depository identity; payment means; basic identifying information; optionally, identity of the payment depository; optionally, referred user identity; optionally, referring user identity; optionally, discount rate; optionally, identity of the product.

Central depository account 160-140 stores the following information: products listed on central depository; price of products listed on central depository; referral rate for products listed on central depository; discount rate for products listed on central depository; referring users who have created referral hyperlinks for the merchant from central depository; referring sites that have created referral hyperlinks for the merchant from central depository; successful activation of advertising hyperlinks from central depository; identity of referred users who have activated referral hyperlinks from central depository; billing address; optionally, deposit account information, with funds to pay future referral fees; amount owed to central depository; amount paid to central depository; amount owed to all referring users 110 and referring sites 130 with central depository accounts 140-110 and 140-130 and to each individual referring site account 140-130 or referring user account 140-110; amount paid to all referring users 110 and referring sites 130 with central depository accounts and amount paid to each individual referring site account 140-130 or referring user account 140-110; amount received from payment depository for all referring users 110 and referring sites 130 with central depository accounts and for each individual referring site account 140-130 or referring user account 140-110.

Payment depository account 160-150 stores the following information: referring users 110 who have created advertising hyperlinks for merchants directed to the payment depository 150; referring sites 130 that have created advertising hyperlinks for merchants directed to the payment depository 150; successful activation of advertising hyperlinks with payment to payment depository 150; optionally, identity of referred users 120 who have activated advertising hyperlinks; billing address of the payment depository; amount owed to payment depository 150 for all referring user 110 and referring site 130 merchant accounts 160-110 and 160-130 and for each individual referring site account 160-130 or referring user account 160-110; amount paid to payment depository 150 for all referring user and referring site merchant accounts 160-110 and 160-130 and for each individual referring site account 160-130 or referring user account 160-110; amount received from payment depository by all referring user and referring site accounts 150-110; 150-130 and by each individual referring site account 150-130 or referring user account 150-110.

Accounts at Payment Depository

Referring user account 150-110 stores the following information: referrals created; referrals activated (amount owed by payment depository); amount paid to payment depository from merchant; amount received by the referring user from the payment depository; referral rate; central depository identity 140; payment means; basic identifying information; optionally, referred user identity 120; optionally, referring site identity 130; optionally, discount rate; optionally, identity of the product.

Referring site account 150-130 stores the following information: referrals created; referrals activated (amount owed by payment depository); amount paid to payment depository from merchant; amount received by the referring site 130 from the payment depository; referral rate; central depository identity 140; payment means; basic identifying information; optionally, referred user identity 120; optionally, referring user identity 110; optionally, discount rate; optionally, identity of the product.

Central depository account 150-140 stores the following information: optionally, products listed on central depository; optionally, price of those products; referral rate for those products; optionally, discount rate for those products; referring users 110 who have created advertising hyperlinks with instructions to pay the payment depository; referring sites 130 that have created advertising hyperlinks with instructions to pay the payment depository; successful activation of advertising hyperlinks routed through the central depository; optionally, referred users identity who have activated advertising hyperlinks; billing address; amount owed to central depository; amount paid to central depository; amount received by referring users 110, referring site 130, and central depository 140 from payment depository 150.

Merchant account 150-160 stores the following information: amount paid by merchant 160 to payment depository 150 collectively and individually; amount owed by merchant 160 to payment depository 150 collectively and individually; optionally, products for referral; optionally, price of those products; referral rate for those products; optionally, discount rate for those products; referring users 110 who have created advertising hyperlinks for the merchant with payment to the payment depository; referring sites 130 that have created advertising hyperlinks for the merchant with payment to the payment depository; successful activation of advertising hyperlinks; optionally, identity of referred users 120 who have activated advertising hyperlinks; billing address; amount received by referring users 110 and referring site 130 from payment depository 150.

Embodiment without Merchant Account

In some embodiments, no merchant referring user 160-110 or referring site 160-130 account is necessary. The referring user 110 downloads a cookie with the referring user's payment depository identification and information regarding the specific payment depository 150 included in the cookie. Alternatively, the referring user 110, upon activating an auto-advertise hyperlink (e.g., “Advertise This!”) from the central depository 140 website, enters the referring user's payment depository identity and the identity of the payment depository 150. The merchant 160 or central depository 140 automatically creates a referral hyperlink containing the specific merchant and product identification with the associated referring user's payment depository identification, and the payment routing instructions to the payment depository 150. Upon activation of the hyperlink, the merchant 160 automatically receives the referring user's payment depository identity and the identity of the specific payment depository from the hyperlink. The merchant 160 sends the payment depository 150 an electronic message that the hyperlink has been activated for the referring user 110. The merchant 160 pays the payment depository 150 upon a predetermined condition being met, e.g., when there are enough users from that payment depository 150 to prevent excess processing fees, such as 100 dollars of owed referrals. Using this technique, there is no need for a referring user or referring site merchant account 160-110 and 160-130. If routing is through central depository 140 the routed merchant 160 is sent the identity of the payment depository 150 and the referring user's payment depository identity.

Embodiment with Merchant Account

In some embodiments, the referring user 110 creates account 140-110 at the central depository 140. The referring user 110 selects an item to advertise. The central depository 140 automatically sends the merchant 160 the referring user's payment depository identifier and the identity of the payment depository 150. The merchant 160 creates a referring user account 160-110 and stores the information including the referring user's payment depository identifier and the specific payment depository 150. The merchant 160 sends the referring user's account 160-110 identification to the central depository 140 or optionally creates and sends the referral hyperlink directly to the referring user 110. The central depository 140 creates a referral hyperlink inclusive of the product, the referring user account 160-110 identifier, and optionally the following: the referring user's payment depository identifier 150-110, the payment depository identity, the referral rate, and discount rate. The central depository preforms the routing feature for this process after activation of the hyperlink and before transfer to the merchant 160. For example, the payment depository identity may be EXAMPLE-CENTRAL-DEPOSITORY.com; the referring user's payment depository identifier may be Gbeighley012; and the referring user's merchant identifier may be Gcb1234. Optionally, the referring user payment depository identifier may be the same as the referring user merchant identifier.

Redirecting Referred User to Merchant Website

In most embodiments, after activating a referral hyperlink referred user 120 is redirected from a central depository web page to a merchant web page. The referred user 120 activates a referral hyperlink to the central depository 140 posted by the referring user 110. The central depository 140 parses the hyperlink and inputs the URL address onto a non-visible dynamic web page script as indicated below. The web page is dynamic because the identity of the routing hyperlink is determined by the user's initial input. Using a redirect process in the programming language PHP, for example, the referred user 120 is routed to the merchant 160. More details on such redirection are now described.

First, the referred user activates a hyperlink such as the following: http://www.EXAMPLE-CENTRAL-DEPOSITORY.com/cgi-bin/updateandstore.cgi?name=George&discount=.1&intitial+referral+fee=.05&type=c&central+payment+depository=CPD&url=www.EXAMPLE-MERCHANT.com/lcdtv1234.html

The central depository 140 parses the hyperlink to determine the merchant's URL address, in this case: www.EXAMPLE-MERCHANT.com/lcdtv1234.html

The central depository may input the URL address into the following PHP code, which is only illustrative of the general technique used and is non-limiting.

<?php

header(‘Location: http://www.EXAMPLE-MERCHANT.com/lcdt1234.html’);

!>

The referred user 120 is routed to the merchant 160. The redirect code may be more complex than presented above to take into consideration the parsing of the initial URL and the creation of a dynamic web page, which includes the specific routing address. In the above example the specific routing address is www.EXAMPLE-MERCHANT.com.

Central Payment Depository Process:

The payment depository 150 and the central depository 140 may be two separate entities. In this embodiment, the central depository 140 collects the referral data and upon the referring user 110 or referring site 130 accumulating a certain amount of paid referral fees the central depository sends instructions to the payment depository 150 to pay the referring user 110 or referring site 130. The payment depository 150 pays the referring user 110 or referring site 130.

Central depository 140 receives referral information from referred user 120 activating referring users 110 or referring sites 130 referral hyperlinks. The central depository 140 accesses referring user database 140-110 or referring site database 140-130 to determine how much is owed from all referring users 110 or referring sites 130 by an individual merchant 160.

If merchant 160 has not paid, the central depository 140 requests payment from the merchant 160 to the payment depository 150. Optionally, the central depository 150 sends an electronic communication to the payment depository 150 informing the payment depository 150 that payment is due. The payment depository 150 requests payment from the merchant 160. The payment depository 150 receives payment from merchant 160. Optionally, the merchant 160 notifies the central depository 140 that payment has been made to the payment depository 150. Optionally, the payment depository 150 notifies the central depository 140 that they have received a payment from a merchant 160.

Upon reaching a certain amount paid to the payment depository 150 on behalf of an individual referring user 110 or referring site 130, the central depository 140 sends the payment depository 150 payment instructions in the form of an electronic message to transfer money from the payment depository 150 to the individual referring user 110 or referring site 130. The payment depository 150 transfers money to the individual referring user 110 or referring site 130.

Update Discount Rate

In some embodiments, the discount rate may be updated by merchant 160. The merchant 160 may update a discount rate stored at an account of a referring party or a referred user 120. The merchant 160 may update the referring user's 110 discount rate, e.g., upon updating the referring user's 110 referral rate. This may occur, for example, when the merchant 160 desires to provide additional incentive or reward to the referring user 110, in addition to as an alternative to the referral rate. Suppose referred user 120 is entitled to a 10% discount available due to activating a referral link corresponding to a referral of merchant 160 or a product of merchant 160. If the activated referral link was published by referring user 110, who has an available 5% discount, then that discount can be combined with the 10% discount to yield a 15% discount for referred user 120. Thus, merchant 160 is effectively able to provide a discount to referring user 110 that the referring user 110 is then able to pass on to others (such as anyone who activates a referral link, in this example referred user 120). Because referred user 120 enjoys a higher discount (15% rather than 10%) due to referring user 110 having a 5% discount, referred user 120 may be more likely to activate a referral link published by referring user 110 than a referral link published by another referring user who has a lower available discount or no available discount at all. In this scenario, referring user 110 also benefits because the increased number of referral link activations that are likely to result will generate more referral fees for referring user 110.

The merchant 160 sends the referring user's updated discount rate to the central depository 140. The central depository 140 accesses the referring user account 140-110 and updates the discount rate associated with the referring user 110 and with the specific merchant 160 or product. The central depository 140 displays the updated discount rate to the referring user 110. Upon activation of a referral hyperlink by a referred user 120, the central depository 140 accesses the referring user account 140-110 to determine the discount associated with the referral hyperlink. The central depository 140 sends the discount data to the merchant 160. In one embodiment, when creating referral hyperlinks the central depository 140 includes the discount identifier of the increased discount for the referring user 110 within the hyperlink. In this case, the hyperlink itself includes information specifying the additional discount that is available to referred user 120 due to the discount of referring user 110.

Merchant 160 may update the discount rate of referred user 120, e.g., to reward certain referred users more. Merchant 160 may add an additional discount (e.g., extra 15%) to the referred user account 160-120. The merchant 160 stores the discount on database 164 with the referred user's account or identifier 160-120. Upon a purchase, the merchant 160 accesses the referred user account 160-120 and processes the discount associated with the referred user 120.

In one embodiment, the merchant 160 sends the referred user's 120 updated discount rate and referred user identifier to the central depository 140. The central depository 140 accesses the referred user account 140-120 and updates the associated discount rate to store the referred user's discount at that account. The central depository 140 displays the referred user's discount to the referred user 120. The central depository 140 processes the referred user's discount when referred user 120 activates a link, e.g., for routing to the lowest price or based on other ranking criteria.

A merchant 160 can limit the total discount a referred user 120 can receive by sending a message to the central depository 140. In one embodiment, the message specifies that one of the discounts e.g. of the referred user personally 120, the referring user 110, or the referring site 130 is used. Additionally, the message can specify that the highest, predetermined, or lowest discount acquired by the referred user 120 may be used. In another embodiment, based on the message the central depository 140 combines all discount given to the referred user 120 to achieve the total discount for a product or merchant. If the total discount is less than a maximum threshold specified in the message received from the merchant, the central depository 140 sends the total discount to the merchant 160, e.g., through an electronic message or through a URL with a query string having the total discount embedded therein. The merchant 160 receives the total discount and automatically updates and stores the referred user's account 160-120 to reflect the discount.

A referring site 130 can perform the functions of a referring user 110 described above.

Referring Site and Merchant can Perform Similar Functions

In one embodiment, the merchant 160 serves as the referring site 130 or referring user 110. The merchant 160 performs all functions of the referring site 130 including referring the product, receiving referral fees, allowing referring users 110 to referring products. The merchant 160 performs all the functions of the referring user 110 including referring the product, and receiving referral fees.

In one embodiment, the referring site 130 performs the functions of the merchant 160. The referring site 130 offers a product for referral, performs the functions outlined by a merchant as disclosed herein, and pays referral fee in accordance with the procedures disclosed herein.

Merchant Discount and Item Discount May be Different

The merchant can specify a discount generally for the merchant and a discount for items sold by the merchant. In the merchant embodiment, the merchant receives the instructions on the selected item the referring party desires to refer. The merchant creates a referral hyperlink for the referring party containing the discount identity for the specific item and the discount identity for the merchant generally. The hyperlink may be as follows:

http://www.EXAMPLE-MERCHANT.com/lcdtv1234.html/cgi-bin/updateandstore.cgi?name=Phyllis&posting+site=tvmagazine&merchant_discount=.1&item_discount=.01&intitial+referral+fee=.05&type=c&central+payment+depository=EXAMPLE-CENTRAL-DEPOSITORY.com

The hyperlink contains the following information. The routing instructions are to the merchant's product or “www.EXAMPLE-MERCHANT.com/lcdtv1234.” The hyperlink contains the referring site identity or “Tvmagazine.” The hyperlink contains a discount for the referred user of “.1” for the merchant generally. The hyperlink contains a discount for the referred user of “.01” for the specific item (in this instance lcdtc1234) The hyperlink contains the identity of the referral rate of “.05.” The hyperlink contains the identity of the merchant: “EXAMPLE-MERCHANT.” The hyperlink contains the identity of the product: “lcdtv1234.” The hyperlink contains the identity of the referring user: “Phyllis.” The identity of the payment depository 950 is “EXAMPLE-CENTRAL-DEPOSITORY.com.”

Central Depository-Related Embodiment without Referring Site Account

In one embodiment, the central depository does not include a referring site identifier when creating the referral hyperlink. The central depository receives incoming referring site statistics including the referring site URL upon activation of the referral hyperlink. The central depository matches the referring site central depository account with the incoming URL received by the central depository. The central depository accesses the referring site's central depository account to determine the discount rate, and referral rate associated with the referring site. The central depository automatically updates and stores the referring site central depository account to reflect the activation of the referral hyperlink. Optionally, the central depository updates the referred users account to reflect activation of the referral hyperlink. The central depository sends the item identification, referral rate, discount rate, the determined referring site identification, optionally the referred user identification and all referred user discounts associated with the merchant to the merchant. The central depository routes the referred user to the merchant. The referring site URL can be tracked by using the HTTP_REFERER variable sent to the central depository upon receiving a referred user.

Merchant-Related Embodiments

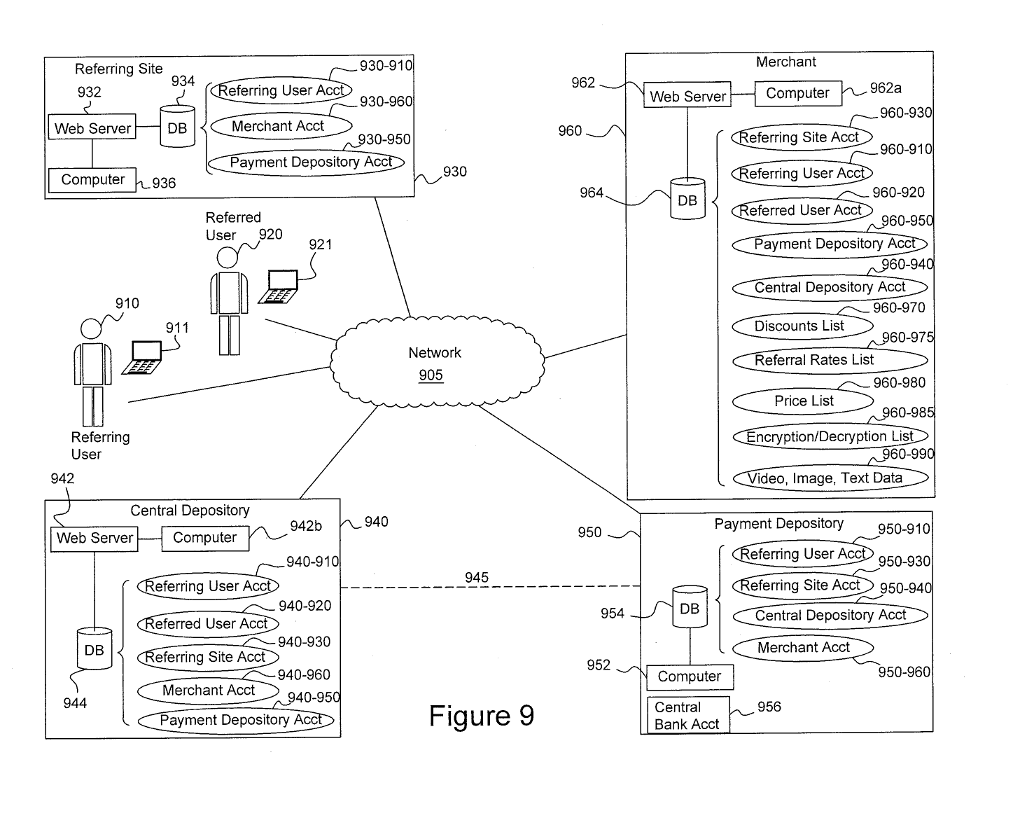

Other embodiments involve activities by a merchant. Referring to FIG. 9, a merchant 960 displays a hyperlink for a product offered by the merchant or associated by the merchant. The hyperlink allows referring sites 930 or referring users 910 to click on the hyperlink and thereby automatically create a paid referral hyperlink. The merchant 960 compiles a list of all products that referring users 910 or referring sites 930 can advertise, organized by highest referral rate, lowest price, best deal, discount lists, geographic location, category or type, or other factors. The lists contains two embodiments. In one embodiment, clicking on the merchant or product serves to automatically create a paid referral hyperlink to the product or merchant and send it to the referring user 910 or referring site 930. In another embodiment, there is a link next to the product or a merchant generally that says “advertise this item”; if clicked, the link serves to automatically create a referral hyperlink to the product or merchant and send it to the referring user 910 or referring site 930. In this embodiment, the product listing itself is a link to more information about the item. Clicking the “Advertise this Item” link instructs the merchant computer to perform the auto-advertise function.

Referring sites 930 create accounts with a merchant 960. Referring sites 930 enter identifying information including name, address, URL address, email address, password, payment information, site details. Referring sites 930 view the merchant lists and click on the “advertise this item” link. The merchant 960 receives this request and downloads the referring site identifier from a cookie or optionally, acquires the identifier by asking the referring site 930 to log into the referring site's account 960-930. In one embodiment, when clicking this link the referring site 930 receives a series of prompts to create an account and then advertise the product. The merchant 960 then searches a database 964 connected to the merchant system for the appropriate format for a referral hyperlink.

The merchant 960 then compiles the referring site identifier and the appropriate routing instructions to the specific product or merchant. The merchant 960 runs a computer program to automatically format a referral hyperlink The merchant 960 then encrypts the referral hyperlink in a predetermined format to provide secure communication between the referring site 930 and the merchant 960. The merchant 960 sends the encrypted referral hyperlink to the referring site 930 via email or other form of electronic communication. The referring site 930 displays the referral hyperlink.

Referring users 910 may create accounts with a merchant 960. Referring user 910 enters identifying information including name, address, email address, payment information, referring user details, optionally identity of referring site. The merchant 960 places a cookie on the referring user computer 910 containing the referring user identifier. Referring user 910 views the merchant lists and clicks on the “advertise this item” link. The merchant 960 receives this request and downloads the referring user identifier from a cookie or optionally, acquires the identifier by prompting the referring user to log into the referring user account 960-910. In one embodiment, if the referring user does not have an account, when clicking this link the referring user 910 receives a series of prompts from the merchant 960 to create an account and then advertise. The merchant 960 then searches a database 964 connected to the merchant system for the appropriate format for a referral hyperlink given by the merchant.

The merchant 960 then compiles the referring user identifier, the appropriate routing instructions to the specific merchant, or product, and optionally, the referring site identifier. The merchant 960 runs a computer program 962a to automatically format a hyperlink containing this information. The merchant 960 then encrypts the referral hyperlink in a predetermined format to provide secure communication between the referring user 910 and the merchant 960. The merchant then sends the encrypted hyperlink to the referring user via email, or any form of electronic communication. In one embodiment the merchant directly adds the hyperlink to the referring site 930 on behalf of the referring user 910, by sending the referral hyperlink to the referring site 930 with instructions to post on a specific web page associated with the referring user 910. Alternatively, the referring user 910 posts the referral hyperlink on the referring site 930.

Referred user 920 enters identifying information including name, address, email address, payment information. The merchant 960 downloads a cookie to the referred user computer 921 containing the referred user identifying information. The merchant 960 gives the referred user 920 a machine readable card 922. The merchant 960 creates a referred user account on database 964. The referring user 910 or referring site 930 displays the referral hyperlink to the referred user 920. The referred user 920 activates the referral hyperlink.

The merchant 960 receives the referred user identifier from a cookie contained on the referred user computer 921 or through prompts and manual entry by the referred user 920. The merchant 960 automatically parses the referral hyperlink to determine the identifier of the referring user, the referral rate, the discount rate, and the identity of product. Optionally, the merchant performs a decrypting process such as hashing to verify the referral hyperlink has not been corrupted. The merchant 960 automatically updates and stores the referred user account 960-920 to reflect any discounts associated with the referral hyperlink. The merchant 960 automatically updates and stores the referring site 960-910, referring user 960-930 account, and the payment depository account 960-950 with the referral information.

The merchant 960 pays the referring user 910 using any payment method. The merchant may pay the referring site 930 a posting fee for a post made by the referring user 910. Where there is no referring user, i.e., only a referring site 930, the merchant 960 pays the referring site 930 using any payment mechanism. In one embodiment, the merchant 960 pays a payment depository 950 for all referring users 910 and referring sites 930 using the payment depository 950. The merchant 960 pays the payment depository 950 when the collective amount owed to the payment depository 950 for all referring users 910 and referring sites 930 using the payment depository 950 for payment has reached a minimum level.

The payment depository 950 receives payment from the merchant 960. The payment depository stores the payment from the merchant owed to the referring user 910 or referring site 930 in a bank account associated with the payment depository 156. When the referring user 910 or referring site 930 has reached a minimum amount paid by all merchants to the payment depository 950 for referring products and merchants, the payment depository transfers funds from the payment depository bank account 956 to the referring user bank account 950-910 or referring site bank account 950-930.

Creation of Various Accounts

Referring Site Account

The referring site 930 creates a referral account with the merchant 960 using a web browser. The merchant internet server 962 accesses stored web page documents which can be requested, retrieved, and view by the referring site 930 using the web browser.

The referring site 930 in response to prompts from the merchant 960 enters identifying information including one or more of name, address, phone, email, URL address(es), account password, security questions, and alias email accounts. Optionally, the referring site 930 provides the identities of referring users 910. In response to further prompts the referring site 930 provides a bank account or payment address to the merchant 960. Optionally, the referring site 930 provides the identity of the payment depository 950 to the merchant 960.

A computer program 962a operating on the merchant's system 960 verifies the inputted information is complete and that there are no other accounts 960-930 with the same identifying information. The merchant 960 assigns the referring site 930 a common referring site identifier, which may be an email account name, a URL address, or could be a number or other randomly generated or user selected identification. The merchant then stores the referring site account information 960-930 in referring site database 964. The referring site 930 can create an account with the merchant 960 prior to or following the selection of an item for referral.

In one embodiment, the merchant 960 creates a web page document specifically for the referring site, consisting of the referring site's referred products, the referral rate, optionally, the amount owed from the merchant, optionally the amount owed to the referring user 910, and the posting fee rate. The merchant 960 stores the referring site web page documents on a server 962. The referring site 930 can access the referring site's web page document by entering the referring site's account information and password on the merchant's website. In one embodiment, the merchant 960 sends an identity cookie to the referring site 930 to identify the referring site 930 on any subsequent visits to the merchant's website.

Referring User Account:

In one embodiment, the referring user 910 creates an advertising or referral account with the merchant 960 using a web browser. The merchant internet server 962 accesses stored web page documents which can be requested, retrieved, and view by the referring user 910 using the web browser.

The referring user 910 in response to prompts from the merchant 960 enters identifying information including one or more of name, address, phone, email, account password, security questions, and alias email accounts. Optionally, the referring user 910 provides the identity of the referring site 930. Optionally, the posting user provides the identity of the central payment depository. In response to further prompts the referring user 910 provides a bank account or payment address or identity of the payment depository 950.

A computer program operating on the merchant's system 962a verifies the inputted information is complete and there are no other accounts 960-910 with the same identifying information. The merchant 960 assigns the referring user 910 a common referring user identifier. The common referring user identifier could simply be an email account name, or could be a number or other randomly generated or user selected identification. The merchant 960 then stores the referring user account information 960-910 in a referring user database 964. The referring user 910 can create an account with the merchant 960 prior to or following the selection of an item for referral.

The merchant 960 may create a web page document specifically for the referring user, consisting of the referring user's referred products, the referral rate, optionally the amount owed to the referring user 910, the referring site identities 930, and the posting site fee rate. The merchant 960 stores referring user web page documents on a server connected to the interne 962. The referring user 910 can access the referring user's web page document by entering the referring user's account information and password on the merchant's website. In one embodiment, the merchant 960 sends an identity cookie to the referring user 910 to identify the referring user on any subsequent visits to the merchant's site.

If the referring user 910 identifies referring sites 930, the merchant 960 searches the merchant database 964 for the referring site merchant account 960-930. If none is found, the merchant 960 automatically creates a referring site account and identifier associated with a URL address. The merchant 960 then sends via electronic message to the referring site 930 the request for payment information. The referring site 930 provides payment information, details, and optionally the identity of the payment depository 950 to the merchant 960. The merchant automatically updates the referring site's account 960-930.

Referred User Account:

Referred user 920 create an account 960-920 with the merchant using a web browser to monitor and store with greater accuracy discounts received from activating hyperlinks. Referred user 920 in response to prompts from the merchant 960 enters identifying information including one or more of name, address, phone, email, account password, security questions, and alias email accounts. The referred user optionally includes demographic information including age, height, weight, interests, wealth and favorite product(s). The referred user 920 places an identification cookie on the referred user's computer identifying the referred user to the merchant 960 upon future visits.

A computer program operating on computer 962a at the merchant 960 verifies the inputted information is complete and there are no other accounts with the same identifying information. The merchant 960 assigns the referred user 920 a common referred user identifier, which may be an email account name or may be a number or other randomly generated or user selected identifier. The merchant 960 stores the referred user account information in database 964. The referred user 920 may create an account with the merchant 960-920 prior to or following the selection of an item for referral.

The merchant may create a web page document specifically for the referred user 920, consisting of the referred users collected discounts and activated referral hyperlinks. The merchant 960 stores the referred user web page documents on server 962. The referred user 920 can access the purchasing user's web page document by entering the referred user's account information and password at the website of the merchant 960.

The merchant 960 sends the referred user 920 a machine readable card containing the referred user's common purchasing user identifier. Optionally, the merchant 960 sends the referred user 920 a common referred user identifier to be given to the merchant electronically via a phone or other electronic device. The referred user 920 can have a single account with the merchant to perform both the discount collection and referral activities. Referral activities include all activities performed by an referring user 910 or referring site 930 disclosed herein relating to the referral of products.

Central Depository Account:

In one embodiment, the central depository creates an account 960-940 with the merchant so that the merchant can send the referral information and discount information to the central depository. The central depository sends to the merchant the URL address, and other identifying information necessary to create a central depository account 960-940 with the merchant.

Method of Display:

In one embodiment, the merchant 960 has a hyperlink next to each item for sale that says: “Advertise this Item.” In one embodiment, the merchant 960 displays the referral rate and/or referral type offered to the referring site 930 or referring user 910 for referring the item next to the “Advertise this Item” button. The referral rate can specify type of payment such as variable referral rate, pay per click, pay per impression, or pay per sale. The amount can include the amount paid per sale, per click, initially, per impression or specify that the referring user receives an additional discount off select products or from the merchant. Additionally, the amount can include the factors involved in calculating the variable referral rate.

The “advertise this item” hyperlink may run a program to create a referral hyperlink directly to the merchant 960 or to the central depository 940 then to the merchant 960. Referring site 930 and referring user 910 may be two separate entities. In this section, the two entities perform the same functions to receive advertisements or referrals to add to a referring site 930. A referring site 930 or referring user 910 clicks the “Advertise this Item” link and is taken to a web page document viewed by the referring site 930 or referring user 910 on his web browser, which is sent to the referring site 930 or referring user 910 from a server 962 operated by the merchant 960. The specific item selected is stored by the merchant 960 temporarily until the referring site 930 account or referring user 930 account, and referral routing hyperlink are created by the merchant 960. The web page document prompts the referring site 930 or referring user 910 for identifying information and payment information to create a referral account 960-910; 960-930 with the merchant 960. The referring site account 960-930 or referring user account 960-910 information is stored on a database 964 connected to the merchant's system 960.

In one embodiment, the referring user 910 or referring site 930 download a cookie from the merchant 960 containing the referring user's identifier or referring site's identifier and password. Upon activation of the “Advertise this Item” hyperlink, the merchant receives the referring site identifier or referring user identifier from the cookie. In one embodiment, the merchant 960 sends a request for information to the referring user 910 or to the referring site 930. The referring site 930 or referring user 910 may send the payment information or payment depository identity 950 and referring user identity or referring site identify by means of an email address to the merchant 960. The merchant 960 creates a referring user 910 or referring site 930 merchant account 960-910; 960-930, with the merchant 960.

Following the creation of a referral account by the referring site 960-930 or referring user 960-910 the merchant 960 runs a computer program to automatically format a referral hyperlink in the format articulated below for the products or merchant. The merchant 960 sends the referral hyperlink electronically via email to the referring site 930 or referring user 910. The referring site 930 then adds the paid referral hyperlink to the referring site 930 or displays to the referred user 920 the referral hyperlink in another form of electronic transmission such as email. Alternatively, the referring user 910 then posts the referral hyperlink on a referring site 930 or displays to the referred user 920 the referral hyperlink in another form of electronic transmission such as email. Video, images, or other text may be associated with the referral hyperlink.

The merchant 960 stores the referring site account 960-930, referring user account 960-910, payment information, and optionally selected product. In one embodiment, the merchant stores the referring user account 160-110 with the selected product, referral rate and discount rate. The merchant may store at the referring site account 160-130 the selected product, referral rate and discount rate. Video, images, or other text may be associated with the referral hyperlink. If video, text, images are used in association with this referral routing hyperlink, the referred user 920 may receive from the merchant server 962 the video, image, or text, while accessing the referring site's website.

In some embodiments, the merchant maintains at least nine databases 964 on the merchant's system. First, a referring site database 960-930, which stores all referring sites identifiers, who have activated referral accounts with the merchant 960. Second, a referring user database 940-910, which stores all referring user identifiers, who have activated referral accounts with the merchant 960 and optionally, the associated referring sites 930. Third, the merchant system 960 contains a discount database, 960-970 which stores all discounts offered by the merchant and all associated products. Fourth, the merchant system contains a referral rate database, which stores all referral rates offered by the merchant and all associated products 960-975. Fifth, the merchant maintains a price listing of all products offered for sale by the merchant on a database connected to the merchant's system 960-980. Sixth, the merchant 960 maintains a payment depository database 960-950, of all the payment depositories 950. Seventh, the merchant 960 maintains a central depository database 960-940, which contains the identity of all central depositories 940 referring sites 930 or referring user's 910 might associate with. Eighth, the merchant 960 maintains a referred user database 960-920, which stores all referred user information, by referred users 920, who have created an account with the merchant 960. Ninth, the merchant's stores the encryption and decryption information on a database connected to the merchant's system 960-985. Optionally, tenth the merchant includes a central depository database containing the central depository identity and account information.

Creation of Referral Routing Hyperlinks/Advertisements by Merchant

Referral Hyperlink Method for Referring Sites Direct to Merchant:

In one embodiment, the merchant 960 creates a referral hyperlink for the referring site 930. The paid referral hyperlink contains the following embedded information: the identity of the referring site, the specific product URL address. Optionally, the referral hyperlink includes any discounts associated with the product, the referral rate associated with the product, and the payment depository identifier.

For example a referral routing hyperlink may be: http://www.EXAMPLE-MERCHANT.com/lcdtv1234.html/cgi-bin/updateandstore.cgi?name=tvmagazine&discount=.1&intitial+referral+fee=.05&type=c&payment+depository=EXAMPLE-CENTRAL-DEPOSITORY.com

The link contains the following information. The routing instructions are to the merchant's product or “www.EXAMPLE-MERCHANT.com/lcdtv1234.” The link contains the referring site identity or “Tvmagazine.” The link contains a discount for the referred user of “.1.” The link contains the identity of the referral rate of “.05” The link contains the identity of the merchant: “EXAMPLE-MERCHANT.” The link contains the identity of the product: “lcdtv1234.” The link contains the optional identity of the payment depository, “EXAMPLE-CENTRAL-DEPOSITORY”

In one embodiment, the merchant 960 runs a computer program 962a to encrypt the referral hyperlink prior to sending it to the referring site 930. The merchant 960 employs any method of hyperlink encryption available including using magnet URI links or other links defined by the contents cryptographic hash value.

The merchant 960 uses the common referring site identifier received from the referring site 960-930 database, from the referring site cookie, or from manual entry by the referring site 930. The merchant 960 uses the merchant's URL address to format the referral hyperlink. The merchant 960 uses the common product identifier to identify the product. The common product identifier can be a random number assigned to a product, or a specific name or title. The merchant 960 receives any discount information from a database connected to the merchant's system 960-970. The merchant receives any referral rate information from a database connected to the merchant's system 960-975. The format instructions are determined and stored by the merchant on the merchant's system. The identity of the payment depository 950 is stored in an account by the merchant 960-950 after the payment depository 950 creates an account 960-950 with the merchant 960. In this embodiment, the merchant 960 stores the payment depository's identifier in a database 960-950 connected to the merchant system. The merchant may store the encryption and decryption information on a database connected to the merchant's system 960-985.

The merchant sends the referral hyperlink to the referring site via electronic message. The merchant 960 sends the referring site central depository or merchant identifier, the referral rate at the time of sending, the discount rate at time of sending, the merchant identity, the product identity, and optionally the central depository identity to the referring site 930 via electronic message. The referring site 930 stores the information received from the merchant 960 on a database connect to the referring site's system 934. The referring site then adds the referral hyperlink to the referring site.

In one embodiment, the referring site 930 sends the following information to the central depository 940: the discount associated with the referring user and/or referring site, the central depository identity, the referring user identity, and/or the referring site identity, the referral rate, the merchant identity, the identity of the product, the specific web-address of the referred item. The central depository 940 creates a referring site account 940-930 on the central depository's database 944 containing the referral and discount information. The central depository 940 stores this information with the referring site account 940-930.

The referring site 930 may send this information to the central depository 940 after activation of the referral hyperlink. In this embodiment the referring site 930 additionally sends the referred user identity 920, and any discounts with the referred user 920.

Referral/Routing Hyperlink for Referring Users Direct to Merchant:

The merchant 960 may create a referral hyperlink for the referring user 910. The referral hyperlink contains the following embedded information: the referring user identity, the specific product URL address. Optionally, the referral hyperlink includes any discounts associated with the product, the referral rate associated with the product, the referring site identifier and the payment depository identifier.

For example a referral routing hyperlink may be: http://www.EXAMPLE-MERCHANT.com/lcdtv1234.html/cgi-bin/updateandstore.cgi?referring+user=Phyllis&referring+site=tvmagazine&discount=.1&intitial+referral+fee=.05&type=c&central+payment+depository=EXAMPLE-CENTRAL-DEPOSITORY.com

The link contains the following information. The routing instructions are to the merchant's product or “www.EXAMPLE-MERCHANT.com/lcdtv1234.” The link contains the referring site identity or “Tvmagazine.” The link contains the referring user identity or “Phyllis.” The link contains a discount for the referred user of “.1.” The link contains the identity of the referral rate of “.05” The link contains the identity of the merchant: “EXAMPLE-MERCHANT.” The link contains the identity of the product: “lcdtv1234.” The link contains the optional identity of the payment depository, “EXAMPLE-CENTRAL-DEPOSITORY”

In one embodiment, the merchant 960 runs a computer program 962a to encrypt the referral hyperlink prior to sending it to the referring user 910. The merchant 960 employs any method of hyperlink encryption available including using magnet URI links or other links defined by the contents cryptographic hash value.

The merchant 960 uses the common referring site identifier received from the referring site database 960-930, or from manual entry by the referring user 910. The merchant 960 uses the common referring user identifier received from the referring user database 960-910, from a referring user cookie, or from manual entry by the referring user 910. The merchant 960 uses the merchant's URL address to format the referral hyperlink. The merchant 960 uses the common product identifier to identify the product. The common product identifier can be a random number assigned to the product, or a specific name or title. The merchant 960 receives any discount information from a database 960-970 connected to the merchant's system. The merchant receives any referral rate information from a database 960-975 connected to the merchant's system. The format instructions are determined and stored by the merchant on the merchant's system. The identity of the payment depository 950 is stored in an account 960-950 by the merchant 960 after the payment depository 950 creates an account with the merchant 960. In this embodiment, the merchant 960 stores the payment depository's identifier in a database 960-950 connected to the merchant system. The merchant may store the encryption and decryption information on a database connected to the merchant's system 960-985.

The merchant 960 sends the referral hyperlink to the referring user 910 via electronic message. The referring user 910 then adds the referral hyperlink to the referring site 930. In an alternative embodiment, the merchant 960 sends the referral hyperlink to the referring site 930 with associated referring user identity. The merchant 960 sends to the referring site 930 the referring user central depository or merchant identifier, the referral rate at the time of sending, the discount rate at time of sending, the merchant identity, the product identity, optionally the central depository identity via electronic message. If the referring user 910 does not already have a referring site account the referring user creates an account 930-910 to store the referral information. The referring site 930 stores the information received from the merchant 960 on a database connect to the referring site's system 934. The referring site then adds the referral hyperlink associated with the referring user to the referring site.

In one embodiment, the referring site 930 sends the following information associated with the referring user 910 to the central depository 940: the discount associated with referring user and/or referring site, the central depository identity, the referring user identity, and/or the referring site identity, the referral rate, the merchant identity, the identity of the product, the specific web-address of the referred item.

The central depository 940 creates a referring user account 940-910 on the central depository's database 944 containing the referral and discount information. The central depository 940 stores this information with the referring user account 940-910.

The referring site 930 may send this information associated with the referring user 910 to the central depository 940 after activation of the referral hyperlink. In this embodiment, the referring site 930 sends the identity of the referred user 920 and the discounts associated with the referred user to the merchant.

Method for Referring Sites Routed Through Central Depository

In the one embodiment, the merchant 960 creates a referral hyperlink for the referring site 930 routed through the central depository 940. The referral hyperlink contains the following embedded information: the identity of the referring site, the specific product URL address, and central depository web-address. Optionally, the referral hyperlink includes any discounts associated with the product, the referral rate associated with the product, and the payment depository identifier.

For example a referral hyperlink may be: http://www.EXAMPLE-CENTRAL-DEPOSITORY.com/cgi-bin/updateandstore.cgi?name=EXAMPLE-REFERRING-SITE&discount=.1&intitial+referral+fee=.05&type=c&central+payment+depository=CPD&url=EXAMPLE-MERCHANT.com/lcdtv1234.html

The link contains the following information. The routing instructions are to the central depository: www.example-central-depository.com. The merchant's URL or “www.EXAMPLE-MERCHANT.com/lcdtv1234.” The link contains the referring site identity or “EXAMPLE-REFERRING-SITE.” The link contains a discount for the referred user of “.1.” The link contains the identity of the referral rate of “.05” The link contains the identity of the merchant: “EXAMPLE-MERCHANT.” The link contains the identity of the product: “lcdtv1234.” The link contains the optional identity of the payment depository, “CPD”

In one embodiment, the merchant 960 runs a computer program 962a to encrypt the referral hyperlink prior to sending it to the referring site 930. The merchant 960 employs any method of hyperlink encryption available including using magnet URI links or other links defined by the contents cryptographic hash value. The merchant 960 accesses the encryption listing 960-985 contained on merchant's database 964 to find the proper encryption format compatible with the central depository system 940.

The merchant 960 uses the common referring site identifier received from the referring site 960-930 database, from the referring site cookie, or from manual entry by the referring site 930. The merchant 960 uses the merchant's URL address to format the referral hyperlink. To identify the product, the merchant 960 uses the common product identifier, which may be a random number assigned to a product, or a specific name or title. The merchant 960 receives central depository referral hyperlink format instruction from the central depository account 960-940. The merchant 960 receives any discount information from a database connected to the merchant's system 960-970. The merchant receives any referral rate information from a database connected to the merchant's system 960-975. The format instructions are determined and stored by the merchant on the merchant's system. The identity of the payment depository 950 is stored in an account by the merchant 960-950 after the payment depository 950 creates an account 960-950 with the merchant 960. In this embodiment, the merchant 960 stores the payment depository's identifier in a database 960-950 connected to the merchant system. The merchant may store the encryption and decryption information on a database connected to the merchant's system 960-985.

If the referring site 930 does not have a central depository account 940-930 associated with the referring site merchant account 960-930, then the merchant 960 prompts the referring site for the referring site central depository account information.

The merchant sends the referral hyperlink to the referring site via electronic message. The merchant 960 sends the referring site central depository or merchant identifier, the referral rate at the time of sending, the discount rate at time of sending, the merchant identity, the product identity, and optionally the central depository identity to the referring site 930 via electronic message. The referring site 930 stores the information received from the merchant 960 on a database connect to the referring site's system 934. The referring site then adds the referral hyperlink to the referring site.

In one embodiment, the referring site 930 sends the following information to the central depository 940: the discount associated with the referring site, the central depository identity, the referring site identity, the referral rate, the merchant identity, the identity of the product, the specific web-address of the referred item. The central depository 940 creates a referring site account 940-930 on the central depository's database 944 containing the referral and discount information. The central depository 940 stores this information with the referring site account 940-930.

In an additional, embodiment, the referring site 930 sends this information to the central depository 940 after activation of the referral hyperlink. In this embodiment, the referring site 930 sends the identity of the referred user 920 and the discounts associated with the referred user to the merchant.

Hyperlink for Referring Users Routed Through Central Depository:

The merchant 960 may create a paid referral hyperlink for the referring user 910 routed through the central depository 940. The referral hyperlink contains the following embedded information: the referring user identity, the specific product URL address, the URL address of the central depository. Optionally, the referral hyperlink includes any discounts associated with the product, the referral rate associated with the product, the referring site identifier and the payment depository identifier.

For example, a referral routing hyperlink may be: http://www.EXAMPLE-CENTRAL-DEPOSITORY.com/cgi-bin/updateandstore.cgi?referring+user=phyllis&Referring+site=EXAMPLE-REFERRING-SITE&discount=.1&intitial+referral+fee=.05&type=c&central+payment+depository=CPD&url=EXAMPLE-MERCHANT.com/lcdtv1234.html

The link contains the following information. The routing instructions are to the central depository or www.EXAMPLE-CENTRAL-DEPOSITORY.COM. The merchant's product and routing address is included or “www.EXAMPLE-MERCHANT.com/lcdtv1234.” The link contains the referring site identity or “EXAMPLE-REFERRING-SITE.” The link contains the referring user identity or “Phyllis.” The link contains a discount for the referred user of “.1.” The link contains the identity of the referral rate of “.05” The link contains the identity of the merchant: “EXAMPLE-MERCHANT.” The link contains the identity of the product: “lcdtv1234.” The link contains the optional identity of the payment depository, “CPD”

In one embodiment, the merchant 960 runs a computer program 962a to encrypt the referral hyperlink prior to sending it to the referring user 910. The merchant 960 employs any method of hyperlink encryption available including using magnet URI links or other links defined by the contents cryptographic hash value. The merchant 960 accesses the encryption listing 960-985 contained on merchant's database 964 to find the proper encryption format compatible with the central depository system 940.

The merchant 960 uses the common referring site identifier received from the referring site database 960-930, or from manual entry by the referring user 910. The merchant 960 uses the common referring user identifier received from the referring user database 960-910, from a referring user cookie, or from manual entry by the referring user 910. The merchant 960 uses the merchant's URL address to format the referral hyperlink. The merchant 960 uses the common product identifier to identify the product. The common product identifier can be a random number assigned to the product, or a specific name or title. The merchant 960 receives central depository referral hyperlink format instruction from the central depository account 960-940. The merchant 960 receives any discount information from a database 960-970 connected to the merchant's system. The merchant receives any referral rate information from a database 960-975 connected to the merchant's system. The format instructions are determined and stored by the merchant on the merchant's system. The identity of the payment depository 950 is stored in an account 960-950 by the merchant 960 after the payment depository 950 creates an account with the merchant 960. In this embodiment, the merchant 960 stores the payment depository's identifier in a database 960-950 connected to the merchant system. The merchant may store the encryption and decryption information on a database connected to the merchant's system 960-985.

The merchant 960 sends the referral hyperlink to the referring user 910 via electronic message. The referring user 910 then adds the referral hyperlink to the referring site 930. In an alternative embodiment, the merchant 960 sends the referral hyperlink to the referring site 930 with associated referring user identity. The merchant 960 sends to the referring site 930 the referring user central depository or merchant identifier, the referral rate at the time of sending, the discount rate at time of sending, the merchant identity, the product identity, optionally the central depository identity via electronic message. If the referring user 910 does not already have a referring site account, the referring user creates an account 930-910 to store the referral information. The referring site 930 stores the information received from the merchant 960 on a database connected to the referring site's system 934. The referring site then adds the referral hyperlink associated with the referring user to the referring site.

In one embodiment, the referring site 930 sends the following information associated with the referring user 910 to the central depository 940: the discount associated with the referring user and referring site, the central depository identity, the referring user identity, and/or the referring site identity, the referral rate, the merchant identity, the identity of the product, the specific web-address of the referred item. The central depository 940 creates a referring user account 940-910 on the central depository's database 944 containing this information. Central depository 940 stores this information with referring user account 940-910.

The referring site 930 may send this information associated with the referring user 910 to the central depository 940 after activation of the referral hyperlink. In this embodiment, the referring site 930 sends the identity of the referred user 920 and the discounts associated with the referred user to the merchant.

If the referring user 910 does not have a central depository account associated with the referring user merchant account 960-910, then the merchant 960 prompts the referring user 910 for the referring user central depository account information 940-910. The merchant 960 further prompts the referring user 910 for the referring site identity 940. In this embodiment, if the referring site 930 entered by the referring user 910 does not have an account with the central depository 940-930 on record with the referring site merchant account 960-930 the merchant does not include the referring site identity in the referral hyperlink.

Association of Text, Video, or Pictures with Referral Hyperlink

The merchant 960 keeps a database of pictures, video, and text to be associated with specific referral hyperlinks. The database consists of the products or the merchant generally with an associated video, text, or picture to display. The database further consists of instructions on how to automatically format the referral hyperlink with the video, text, or picture. Upon receiving a request to format a referral link or advertisement from a referring site 930 or referring user 910, the merchant 960 sends the referring site the video, text, or picture associated with the product or merchant and/or the formatting instructions. The merchant sends the information electronically in one embodiment in the form of an electronic message. In one embodiment the video, text, and pictures are stored on the merchant's server 962 and accessed by referred users 920 when they visit a referring site 930 that has formatted the referral hyperlink to display video, text, or pictures from the merchant's server 962.

In one embodiment, the merchant 960 sends the referral link to the referring site 930 or referring user 910 without sending the associated text, video, or pictures. If this method is employed the referring site 930 prior to displaying the referral hyperlink, sends a request for associated video, text, or images to the merchant 960 for a specific product or merchant. The merchant 960 receives this request and accesses the product or merchant generally database 960-990 to receive the associated image, text, or video. The merchant 960 sends the associated text, video, or image to the referring site 930 along with the identity of the product or merchant requested.

Automatic Parsing, Update, and Storage of Referral Information

A referred user 920 accesses the referring site 930 or the referring user's post on the referring site 930. The referred user 920 activates the referral hyperlink.

Referring Site Only:

In one embodiment, the merchant 960 receives the embedded information, which can be displayed in the form of a dynamic web page operating on the merchant system which may contain the above referral information and the identity of the referred user 920. The URL may be as follows: http://www.EXAMPLE-MERCHANT.com/lcdtv1234.html/cgi-bin/updateandstore.cgi?name=tvmagazine&discount=.1&intitial+referral+fee=.05&type=c&central+payment+depository=EXAMPLE-CENTRAL-DEPOSITORY.com

In this web page the actual web address is www.EXAMPLE-MERCHANT.com/lcdtv1234.html. Lcdtv1234 is a specific type of tv. “.05” is the identity of the referral rate. “Tvmagazine” is the identity of the posting site. “.1” is the amount of the discount. “EXAMPLE-CENTRAL-DEPOSITORY” is the optional identity of the central payment depository.

Upon receiving this information from the referring site 930, the merchant 960 automatically parses this information to determine the product identification, the identity of the referring site 930, the referral rate, the discount rate and payment depository. The merchant receives the identity of the referred user 920 from a cookie contained on the referred user's computer 921, or through manual entry of referred user identity by the referred user 920. The merchant 960 automatically updates and stores this information on databases connected to the merchant's system 960-930, 960-920, 960-950.

The merchant 960 displays a dynamic web page to the referred user 920. Optionally, the merchant sends information contained in the referring site's account 960-630, and referred user's account 960-920 to the central depository 940. The central depository 940 creates a referring site account 940-930, and referred user account 940-920 and stores the information received from the merchant 960 with the account.

The merchant 960 pays the referring site 930 a referral fee. The merchant 960 pays the referring site 930 using any payment method.

Referring User

In one embodiment, the merchant 960 receives the embedded information, which can be displayed in the form of a dynamic web page operating on the merchant system which may contain the above referral information and the identity of the referred user 920. The URL would look for example like the following example: http://www.EXAMPLE-MERCHANT.com/lcdtv1234.html/cgi-bin/updateandstore.cgi?referring+user=Phyllis&referring+site=tvmagazine&discount=.1&intitial+referral+fee=.05&type=c&central+payment+depository=EXAMPLE-CENTRAL-DEPOSITORY.com

The link contains the following information. The routing instructions are to the merchant's product or “www.EXAMPLE-MERCHANT.com/lcdtv1234.” The link contains the referring site identity or “Tvmagazine.” The link contains the referring user identity or “Phyllis.” The link contains a discount for the referred user of “.1.” The link contains the identity of the referral rate of “.05” The link contains the identity of the merchant: “EXAMPLE-MERCHANT.” The link contains the identity of the product: “lcdtv1234.” The link contains the optional identity of the payment depository, “EXAMPLE-CENTRAL-DEPOSITORY”

Upon receiving this information, the merchant 960 automatically parses this information to determine the product identification, the identity of the referring site 930, the identity of the referring user 910, the referral rate, the discount rate, and optionally, the identity of the payment depository 950. The merchant receives the identity of the referred user 920 from a cookie contained on the referred user's computer 921, or through manual entry of referred user identity by the referred user 920. The merchant automatically updates this information on databases 964 connected to the merchant's system with the referring user 960-910, referring site 960-930, referred user 960-920 and payment depository 960-950 account.

The merchant 960 displays a dynamic web page to the referred user 920. Optionally, the merchant sends information contained in the referring user's account 960-910, referring site's account 960-630, and referred user's account 960-920 to the central depository 940. The central depository 940 creates a referring site account 940-930, and referred user account 940-920 and stores the information received from the merchant 960 with the account. The merchant 960 pays the referring site 930 a posting fee. The merchant 960 pays the referring site 930 using any payment method. The merchant 960 pays the referring user 910 a referral fee. The merchant 960 pays the referring user 910 using any payment method.

Optionally, the merchant 960 pays the referring site 930 with instructions to pay the referring user 910. The referring site 930 then pays the referring user 910. In one embodiment, the referring site 930 waits until a certain amount of revenue has accumulated and then pays the referring user 910. The referring site 930 pays the referring user 910 using any payment method.

The merchant 960 may pay the referring site 930 for all referring users 910 posting on the referring site 930. The merchant pays the referring site 930 once the total amount earned by all referring users 910 posting on the referring site 930 has reached an agreed upon level such as 10, 100, or 1000 dollars. The referring site 930 stores the amount owed to all referring users 910 until the amount owed to each individual referring user 910 from the referring site 930 has reached a certain minimum such as 0.5 dollars, 1 dollar, 5 dollars, or 10 dollars. Upon reaching the minimum amount owed to the referring user 910 from the referring site 930, the referring site 930 pays the referring user 910 using any payment method.

Discount Process On and Offline Merchant Only:

The referred user 920 creates an account with the merchant 960-920 so that the referred user 920 can accumulate discounts for purchase. The referred user 920 can create an account with the merchant 960-920 prior to or following the activation of a referral hyperlink. The merchant 960 creates a referred user account 960-920. Each time a referred user 920 clicks on a referral hyperlink, the merchant 960 stores the discounts offered by the merchant 960 with the referred user account 960-920. The referred user 920 can use a machine readable card 922 when purchasing an item in person to receive these discounts. In one embodiment, the merchant 960 gives the referred user 920 the machine readable card containing the referred user identity. In one embodiment, the referred user 920 receives a merchant identification which can be transmitted to the merchant 960 electronically using a phone or other electronic device. The merchant 960 stores all discounts accumulated by the referred user 920 on a database 960-920 connected to the merchant's system 964.

In one embodiment, the referred user 920 has one card with a referred user account number that is used by all merchants. When a merchant 960 receives the card upon the prospective purchase by the referred user 920, the merchant 960 accesses the merchant's own system 960-920 allowing the merchant to keep all its sales data private and not disclose it to any third parties. The merchant 960 acquires the common referred user identity from a referred user 920. Upon creating a merchant account, the referred user 920 enters the common referred user identifier. Optionally, the merchant 960 assigns the referred user 920 a specific referred user identity for the specific merchant 960. Optionally, the referred user 920 creates an account 940-920 with a central depository 940 and gives the central depository 940 identifying information. The central depository 940 assigns a common referred user identifier. The merchant 960 submits identifying information received from the referred user 920 to a central depository 940. A computer program operating on the central depository 940 searches the central depository database 940-920 for the referred user's common identifier. The central depository 940 sends the referred user common identifier to the merchant 960.

A central depository 940 or the merchant 960 sends an initial referral hyperlink with the discount amount to the referring user 910 or referring site 930. The referring user 910 or referring site 930 displays the referral hyperlink with the discount to a referred user 920. The referred user 920 activates the referral hyperlink with the discount. The merchant parses the URL address to determine referring user identity, discount amount, referral rate, payment instructions and/or optionally referring site identity. The referred user identity is received from the merchant 960 through prompts to the referred user 920, or through accessing a cookie on the referred user machine 921 with the referred user's identity. The merchant 960 stores the discount and optionally all referral information on a referred user database 960-920 with the associated referred user's account. Further, the merchant 960 stores the discount and optionally all referral information on a referring user database 960-910 with the associated referring user's account.

Upon the referred user 920 selecting an item for purchase, the merchant 960 applies the discount to the referred users purchase. If the referred user 920 has logged off the referred user 920 enters the referred user identity to the merchant 960 to receive the discounts. The merchant 960 searches the merchant system for the referred user account 960-920 and discounts associated with the referred user account. The merchant 960 then process the discounts upon purchase. The merchant 960 then sells the item after applying the discounts.

In the event that the referred user 920 travels to the merchant's place of business, the referred user 920 gives the merchant 960 the machine readable card 922 with the referred users identity contained on it. In one embodiment, the referred user 920 transmits to the merchant 960 the referred user identity electronically using a phone or other electronic device. The merchant 960 inputs the referred user identity into the merchant's system 962a. The merchant 960 searches the merchant system for the referred user account 960-920 and discounts associated with the referred user account. The merchant 960 then process the discounts upon purchase. The merchant 960 then sells the item after applying the discounts.

At the merchant's discretion, the merchant 960 may update the referred user account 960-920 to reflect an additional discount received by the referred user 920 for some or all items. The merchant 960 stores the referred user's 920 additional discount on a database connected to the merchant's system 964 with the referred user account, 960-920.

Additionally, at the merchant's discretion, the merchant 960 may update the referring user's 910 and/or referring site's 930 discount rate to reflect an additional discount received by all referred users 920 who click on the referred user's or referring site's referral hyperlink. Optionally, the referring site's discount rate may be updated for a specific referring user. The merchant stores the additional discount with the referring user's account 960-910 and/or the referring site's account 960-930. Upon receiving a referred user 920 from a referring user's or referring site's hyperlink the merchant 960 accesses the merchant's system to determine the appropriate discount the referring party is entitled to give others. The merchant 960 then updates this discount to the referred user's account 960-920. The merchant 960 stores the updated discount on the referred user's merchant account 960-920. Upon purchase the merchant 960 calculates all discounts entitled to the referred user 920 and deducts the discount from the purchase price.

The merchant 960 may combine the discounts the referred user 920 has received by activating referring user's or referring site's referral hyperlinks with any additional discounts the merchant 960 has given the referred user 920. Optionally, the merchant sets a maximum on the number of discounts the referred user can receive collectively. The merchant may select one of the discounts received by the referred user 920 by activating the referral hyperlink or the discounts given to the referred user 920 directly by the merchant 960.

The merchant 960 may send the referred user's discount data and identifying information about the referred user to a central depository 940. The central depository 940 creates a referred user account 940-920. The central depository 940 stores the discount data with the referred user account 940-920. In one embodiment, the merchant 960 sends all referral information to the central depository 940 associated with the referred user 920. The central depository 940 stores the referral and discount information with the referred user's central depository account 940-920. Optionally, the central depository stores the referral and discount information with the referring user's central depository account 940-910 and/or the referring site's central depository account 940-930.

Payment: Central Payment Depository Option:

In one embodiment, the merchant 960 pays the payment depository 950 for all referring users 910 received over a given time period, such as a day, an hour, a minute, or per certain number of transactions with a common payment depository 950 or referring site 930. The merchant may pay the payment depository 950 or referring site 930 upon the total number of referring users 910 associated with the payment depository 950 or referring site 930 has reached a specified minimum level. This allows the payment depository 950 or referring site 930 to collect payment for massive amounts of referring users 910 and prevents the merchant 960 from having to pay each referring user 910 individually. This saves the referring user 910 and the merchant 960 a great deal of processing fees by grouping the transactions into one bulk transaction to the payment depository 950 or referring site 930. This allows referring users 910 to post on a wide variety of websites and receive their entire referral fee earnings in one central location. Merchants may pool their resources and pay the referring party when the merchants collectively have reached a certain minimum owed to all referring parties with a common payment depository 950.

The payment depository 950 or referring site 930 then stores the amount owed to the referring user 910 in the referring user's payment depository account 950-910 or an account with the referring site 930-910. The payment depository 950 or referring site 930 displays all the successfully activated referral hyperlinks and the amount owed from the merchant 960. The payment depository 950 or referring site 930 displays if payment has been made to the payment depository 950 or referring site 930 by the merchant. The payment depository 950 charges a processing fee for making the transaction. Alternatively, the referring site 930 charges a posting fee for processing the transaction. The referring user 910 can request payment at any time and must pay the processing fee. Upon reaching a certain amount collected from all merchants 960, the payment depository 950 or the referring site 930 pays the referring user 910 using available payment methods. Payment is made using any payment method.

In one embodiment, the payment depository 950 is used to pay referring sites 930, which operate a great many different commonly owned sites. The payment depository 950 performs the same functions outlined in this section for referring users 910 only for referring sites 930.

At the merchant's discretion the merchant 960 may update the referral rate of the referring user 930 or referring site 910 to reflect a different amount per referral. The merchant 960 stores the updated referral amount with the referring site account 960-930 and/or referring user account 960-910. The merchant 960 then notifies the referring site 930 and/or referring user 910 of the new referral rate.

At the merchant's discretion the merchant 960 may update the discount rate the referring user 910 or referring site 930 is entitled to give the referred user 920 to reflect a different amount per referral. The merchant 960 stores the updated discount amount with the referring site merchant account 960-930 or referring user merchant account 960-910. The merchant 960 then notifies the referring site 930 or referring user 910 of the new discount rate.

In one embodiment, the merchant stores a list of the discount rate associated with the referring party on a database 964 connected to the merchant's system. Upon receiving the referred user, the merchant updates the referred user account to reflect the identity of the most recent referring party. If the referred user purchases a different item (hereinafter second item) than the item that the referred user was originally seeking by activating the hyperlink, the merchant accesses the referred users account to determine the identity of the most recent referring party. The merchant determines the discounts given to the referring party associated with the second item, which would apply to referred users who clicked on a referral hyperlink to the second item published by on behalf of the referring party. The merchant determines this information by accessing the referring party merchant account (960-910) (960-930). The merchant applies the discounts given to the referring party for the second item to the referred users purchase. The discount given to the referring party for the second item would have been initially applied to the referred users account had the referred user activated a referral hyperlink to the second item published by or on behalf of the referring party. This way the referred user gets the benefit of the discount for other items referred by the referring party without having to go click on multiple referral hyperlinks to the merchant.

The merchant may store all referring parties that have successfully referred a referred user to the merchant with the referred user's account (960-920). Upon selecting a second item for purchase, the merchant applies the highest product or merchant discount to the referred users purchase for whichever referring party has the highest discount rate. The referred user makes a purchase.

In one embodiment, the merchant sends to the central depository different discount rates associated with the referral of an item and the merchant generally for a specific referring party. Upon creating a referral hyperlink the central depository includes the referring party's discount rate for the item and the merchant. An example of such a hyperlink is: http://www.EXAMPLE-CENTRAL-DEPOSITORY.com/cgi-bin/updateandstore.cgi?name=George&posting+site=Social+Media+Site&merchant_discount=.1&item discount=.01&intitial+referral+fee=.05&type=c&central+payment+depository=CPD&url=EXAMPLE-MERCHANT.com/lcdtv1234.html

The hyperlink contains the following information. The routing instructions are to the central depository or “www.EXAMPLE-CENTRAL-DEPOSITORY.com.” The hyperlink contains the optional referring site identity or “Social_Media_Site.” The hyperlink contains the referring user identity or “George.” The hyperlink contains a discount for the referred user of “.1” for the merchant generally. The hyperlink contains a discount for the referred user of “.01” for the specific item. The hyperlink contains the identity of the referral rate of “.05.” The hyperlink contains the identity of the merchant: “EXAMPLE-MERCHANT.” The hyperlink contains the identity of the product: “lcdtv1234.” The hyperlink contains the specific web address of the desired product and merchant “EXAMPLE-MERCHANT.com/lcdtv1234.html” The hyperlink contains the identity of the central payment depository, “CPD.”

The merchant receives the referred user, and the referring party merchant and item discount the referred user is entitled to by clicking on the referral hyperlink. In one embodiment, the merchant stores a list of the discount rate associated with the referring party on a database 964 connected to the merchant's system. Upon receiving the referred user the merchant updates the referred user account (960-920) to reflect the identity of the most recent referring party. If the referred user purchases a different item (hereinafter second item) than the item that the referred user was originally seeking by activating the hyperlink, the merchant accesses the referred users account (960-920) to determine the identity of the most recent referring party. The merchant determines the discounts given to the referring party associated with the second item, which would apply to referred users who clicked on a referral hyperlink to the second item published by or on behalf of the referring party. The merchant determines this information by accessing the referring party merchant account (960-910) (960-930). The merchant applies the discounts given to the referring party for the second item to the referred users purchase. The discount given to the referring party for the second item would have been initially applied to the referred users account had the referred user activated a referral hyperlink to the second item published by or on behalf of the referring party. This way the referred user gets the benefit of the discount for other items referred by the referring party without having to go click on multiple referral hyperlinks to the merchant.

The merchant may store all referring parties that have successfully referred a referred user to the merchant with the referred user account (960-920). Upon selecting a second item for purchase, the merchant applies the highest product or merchant discount to the referred users purchase for whichever referring party has the highest discount rate. The referred user makes a purchase.

In one embodiment, the discount process performed by the referred user utilizing a central depository account may be performed on a separate website than the advertising process that referring users and referring sites employ.

The merchant or central depository may combine discounts received from multiple referring party's to achieve a total higher discount.

Merchant-Related Embodiment without Referring Site Account:

In one embodiment, the merchant does not include a referring site identifier when creating the referral hyperlink. The merchant receives incoming referring site statistics including the referring site URL upon activation of the referral hyperlink. The merchant matches the referring site merchant account with the incoming URL received by the merchant. The merchant accesses the referring sites merchant account to determine the discount rate, and referral rate associated with the referring site. The merchant automatically updates and stores the referring site merchant account to reflect the activation of the referral hyperlink. Optionally, the merchant updates the referred users account to reflect the activation of the hyperlink. The referring site URL can be tracked by using the HTTP_REFERER variable sent to the merchant.

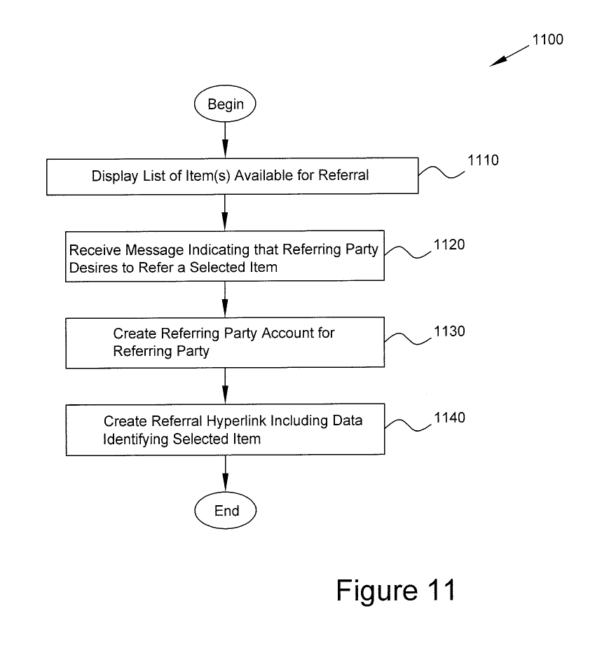

In some embodiments, a computer-implemented method is performed at a computer of a merchant (e.g., merchant 960). FIG. 11 is a flow diagram of such a method. After process 1100 begins, a list of one or more items available for referral is displayed (1110). Each item is a product offered by the merchant or associated with the merchant. A first message is received (1120) from a referring party (e.g., referring user 910 or referring site 930) indicating that the referring party desires to refer a selected item from the list. A referring party account (e.g., 960-910 or 960-930) is created (1130) at the computer of the merchant, for the referring party. A referral hyperlink is created (1140) for referral of the selected item. The referral hyperlink includes first data identifying the selected item.

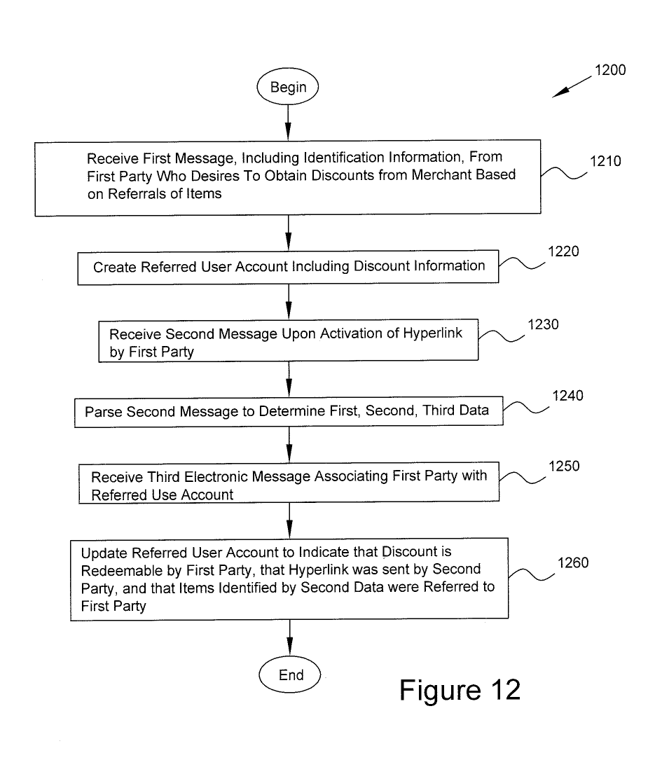

FIG. 12 is a flow diagram of a process in accordance with some embodiments. After process 1200 begins, a first electronic message is received (1210) from a first party who desires to obtain discounts from a merchant (e.g., merchant 960) based on referrals of items offered by or associated with the merchant. The first message includes first identification information for identifying the first party. A referred user account (e.g., referred user account 960-920) is created (1220) for the first party, at a computer of the merchant. The referred user account includes discount information. A second electronic message is received (1230) upon activation of a referral hyperlink by the first party. The second message includes first data identifying a second party that sent the referral hyperlink to the first party, second data identifying one or more of the items, and third data specifying a discount. The second message is parsed (1240) to determine the first, second, and third data. A third electronic message is received (1250). The third message associates the first party with the referred user account. The referred user account is updated (1260) to indicate that the discount is redeemable by the first party, that the referral hyperlink was sent by the second party, and that the items identified by the second data were referred to the first party.

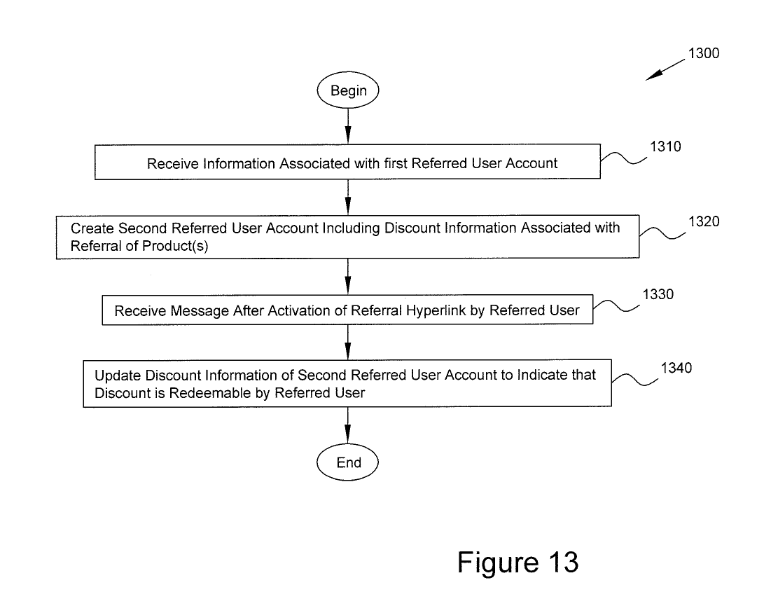

In some embodiments, a computer-implemented method is performed at a computer of a merchant (e.g., merchant 1060). FIG. 13 is a flow diagram of such a method. After process 1300 begins, information associated with a first referred user account (e.g., referred user account 1040-1020) is received (1310) from a central depository of information related to referrals (e.g., central depository 1040). The first referred user account is stored at the central depository. Based on the received information, a second referred user account (e.g., referred user account 1060-1020) is created (1320) at the computer of the merchant. The second referred user account includes discount information associated with referral of one or more products offered by or associated with the merchant. A message is received (1330) from the central depository after activation of a referral hyperlink by a referred user. The message includes first data identifying the referred user and second data specifying a discount offered to the referred user for activation of the hyperlink. The discount information of the second referred user account is updated (1340) to indicate that the discount is redeemable by the referred user.

Referring Site Related Embodiments

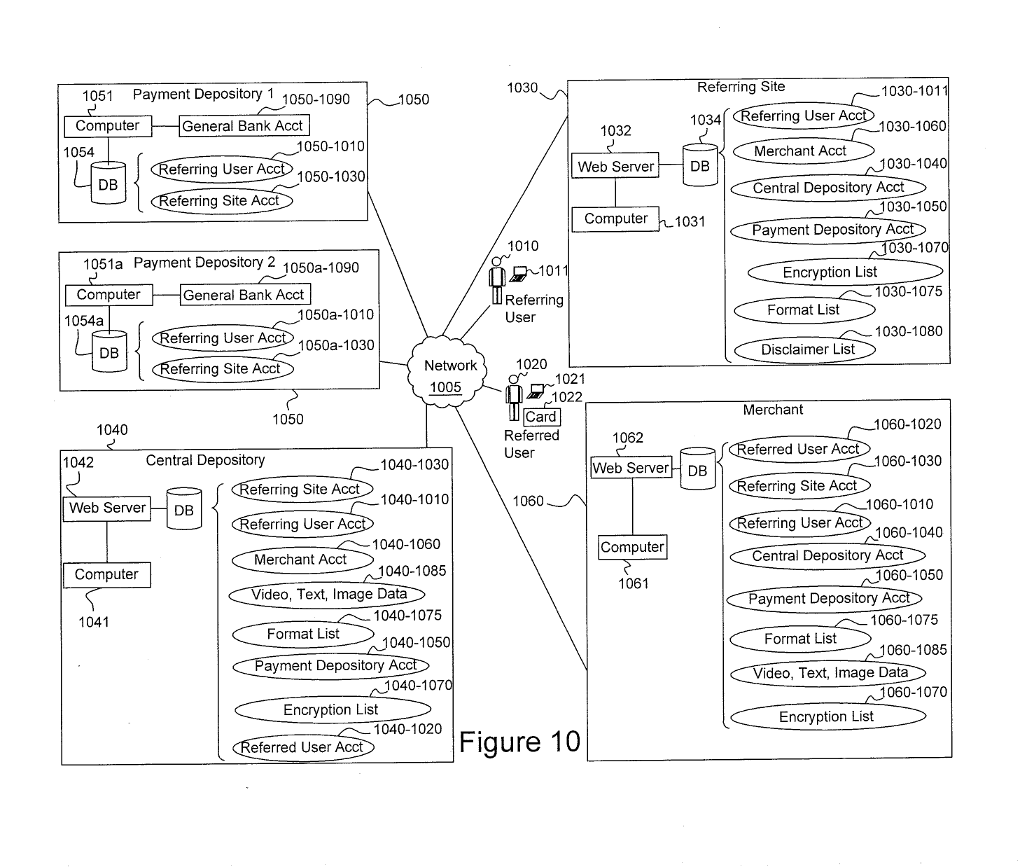

Other embodiments focus on activities by a referring site. Referring to FIG. 10, referring site 1030 creates an account with a merchant 1060-1030 or central depository 1040-1030. A central depository 1040 can be a collection of merchant advertisers 1060 that performs a routing function to a particular merchant 1060. The referring site 1030 downloads formatting instructions for referral hyperlinks from the merchant 1060-1075 or the central depository 1040-1075.

A referring user 1010 creates an account with the referring site 1030. The merchant 1060 pays the referring user 1010 a click fee for referring products or the merchant generally. The referring site 1030 agrees with the referring user 1010 to take a percentage of the click fee as a posting fee. The referring user 1010 enters sufficient information required by referring site 1030 to create a referring user account 1030-1010 with the referring site 1030. In one embodiment, the referring user 1010 enters account information including payment information to the referring site 1030 so that the referring site 1030 can pay the referring user 1010. A referring user 1010 creates a referral account with a merchant 1060 or central depository 1040. A referring user 1010 selects which advertisements or referrals the referring user desires to promote from the merchant 1060 or central depository 1040. Optionally, the referring user 1010 enters the identity of the referring site 1030 to the merchant 1060 or to the central depository 1040.

The merchant 1060 or central depository 1040 creates a referral hyperlink and sends the referral hyperlink to the referring user 1010 or alternatively directly to the referring site 1030. The referring site 1030 receives the referral in the form of the referral hyperlink from referring user 1010, merchant 1060, or central depository 1040. The referring user 1010 can further specify the specific web page, web address, or location on a particular page where the referring user 1010 desires the link to be posted. The referring site 1030 parses the referral hyperlink. The referring site 1030 runs computer program 1031 to determine the referral information contained in the hyperlink, if referring site identifier is included in the referral hyperlink, the identity of the merchant, and/or the identity of the central depository. The computer program 1031 searches the merchant server 1062 or central depository server 1042 to determine if video, text, or pictures are associated with the referral. If so, the referring site 1030 downloads the pictures, video, or text from the merchant 1060-1085 or central depository server 1040-1085 and attaches them to the referral hyperlink.

If the referring site identifier is not included, the referring site computer program 1031 uses the formatting instructions of the merchant received from the format listing 1030-1075 to add the referring site identity to the referral hyperlink. The referring site 1030 then searches a database connected to the referring site 1030 to determine if the referring site 1030 has a referring site referral merchant account 1030-1060 with the merchant 1060. If not, then the referring site 1030 sends a request to the merchant 1060 to create an account with the merchant 1060-1030. The referring site 1030 receives instructions from the merchant 1060 in the form of electronic message to create an account with the merchant 1060-1030. The referring site 1030 submits required data to the merchant 1060 about the referring site to create an account 1060-1030. Optionally, the referring site 1030 accesses the merchant's web server 1062 and responds to web page prompts to create an account 1060-1030. The merchant 1060 creates a referring site 1030 referral merchant account 1060-1030. The referring site 1030 then accesses the disclaimer listing 1030-1080 to find an appropriate disclaimer to insert when displaying the referral hyperlink and any associated video, text, or pictures.

If the referral hyperlink is encrypted, the referring site 1030 performs one of two processes. The referring site 1030 may add the referring site identifier in a non-encrypted format to the encrypted referral hyperlink in the format articulated by the merchant or central depository received from the format listing 1030-1075. Alternatively, the referring site 1030 may decrypt the referral hyperlink by accessing the decryption information contained in the encryption listing 1030-1070. The referring site 1030 adds the referring site identifier to the referral hyperlink in the format articulated by the merchant or central depository received from the format listing 1030-1075. The referring site 1030 then re-encrypts the referral hyperlink by following instructions contained in the encryption listing 1030-1070.

The referring site 1030 creates a web page with the referral hyperlink to the merchant 1060 or central depository 1040. The referred user 1020 activates the referral hyperlink. The merchant 1060 or central depository 1040 pays the referring user 1010 a click fee. The merchant 1060 or central depository 1040 pays the referring site 1030 a posting fee. Optionally, merchant 1060 or central depository 1040 pays the referring site 1030, which pays the referring user 1010.

Referring Site Account with Merchant:

The referring site 1030 creates a referral account with the merchant 1060 using a web browser. The merchant internet server 1062 accesses stored web page documents which can be requested, retrieved, and view by the referring site 1030 using the web browser. The referring site 1030 in response to prompts from the merchant 1060 enters identifying information including one or more of name, address, phone, email, URL address(es), account password, security questions, and alias email accounts. Optionally, the referring site 1030 provides the identities of referring users 1010. In response to further prompts the referring site 1030 provides a bank account or payment address to the merchant 1060. Optionally, the referring site 1030 provides the identity of the payment depository 1050 to the merchant 1060.

A computer program 1062a operating on the merchant's system 1060 verifies the inputted information is complete and there are no other accounts 1060-1030 with the same identifying information. The merchant 1060 assigns the referring site 1030 a common referring site identifier, which may be an email account name, a URL address, or could be a number or other randomly generated or user selected identification. The merchant 1060 then stores the referring site account information 1060-1030 in a referring site database 1064. In one embodiment, the merchant 1060 creates a web page document specifically for the referring site, including the referring site's referred products, the referral rate, optionally, the amount owed from the merchant, optionally the amount owed to the referring user, and the posting fee rate. The merchant 1060 stores the referring site web page documents on a server 1062 connected to the internet. The referring site 1030 can access the referring site's web page document by entering the referring site's account information and password on the merchant's website.

In one embodiment, the merchant 1060 sends an identity cookie to the referring site 1030 to identify the referring site 1030 on any subsequent visits to the merchant's website.

Upon creating an account with the merchant 1060, the merchant 1060 sends the referring site 1030 the proper hyperlink format for referral links. The referring site 1030 stores this format information in a database 1030-1075 connected to the referring site's system.

Optionally, the merchant 1060 sends the referring site 1030 the decryption and encryption process and instructions. The referring site 1030 stores this information in a database 1030-1070 connected to the referring site's system. Optionally, the merchant 1060 sends the referring site 1030 a disclaimer for any referrals related to that merchant. The referring site 1030 stores this information in a database 1030-1080 connected to the referring site's system. In one embodiment, the same general disclaimer is used for all merchants.

Referring Site Account with Central Depository:

The referring site optionally performs the above functions for a central depository serving as an intermediary between the referring site and the merchant. Upon creating an account with the central depository 1040, the central depository 1040 sends the referring site 1030 the proper hyperlink format for referral links. The referring site 1030 stores this format information in a database 1030-1075 connected to the referring site's system. Optionally, the central depository 1040 sends the referring site 1030 the decryption and encryption process and instructions. The referring site 1030 stores this information in a database 1030-1070 connected to the referring site's system.

Optionally, the central depository 1040 sends the referring site 1030 a disclaimer for any referrals related to any merchant the referring site has selected to refer. The referring site 1030 stores this information in a database 1030-1080 connected to the referring site's system. In one embodiment, the same general disclaimer is used for all merchants. In one embodiment, the central depository 1040 additionally sends the referring site 1030 a central depository disclaimer, which disclaims the central depository from liability concerning any statements made by the referring site 1030 associated with the referral hyperlinks.

Referring User Account with Merchant

In one embodiment, the referring user 1010 creates an advertising or referral account with the merchant 1060 using a web browser. The merchant internet server 1062 accesses stored web page documents which can be requested, retrieved, and view by the referring user 1010 using the web browser.

The referring user 1010 in response to prompts from the merchant 1060 enters identifying information including one or more of name, address, phone, email, account password, security questions, and alias email accounts. Optionally, the referring user 1010 provides the identity of the referring site 1030. Optionally, the posting user provides the identity of the central payment depository. In response to further prompts the referring user 1010 provides a bank account or payment address or identity of the payment depository 1050.

A computer program operating on the merchant's system 1062a verifies the inputted information is complete and there are no other accounts 1060-1010 with the same identifying information. The merchant 1060 assigns the referring user 1010 a common referring user identifier, which may be an email account name, or could be a number or other randomly generated or user selected identification. The merchant 1060 then stores the referring user account information 1060-1010 in a referring user database 1064.

In one embodiment, the merchant 1060 creates a web page document specifically for the referring user, including the referring user's referred products, the referral rate, optionally the amount owed to the referring user 1010, the referring site identities 1030, and the posting site fee rate. The merchant 1060 stores referring user web page documents on a server connected to the internet 1062. The referring user 1010 can access the referring user's web page document by entering the referring user's account information and password on the merchant's website. In one embodiment, the merchant 1060 sends an identity cookie to the referring user 1010 to identify the referring user on any subsequent visits to the merchant's site.

If the referring user 1010 identifies referring sites 1030, the merchant 1060 searches the merchant database 1064 for the referring site merchant account 1060-1030. If none is found, the merchant 1060 automatically creates a referring site account and identifier associated with a URL address. The merchant 1060 then sends via electronic message to the referring site 1030 the request for payment information. The referring site 1030 provides payment information, details, and optionally the identity of the payment depository 1050 to the merchant 1060 in the form of an electronic message. The merchant automatically updates and stores the referring site's account 1060-1030. The referring user optionally performs the above functions for a central depository serving as an intermediary between the posting site and the merchant.

Referring User Account and Agreement with Referring Site

The referring user 1010 creates an account 1030-1010 with the referring site 1030. The referring user 1010 agrees with referring site 1030 to give the referring site 1030 a percentage of the click fee as a posting fee. The referring site 1030 internet server 1032 accesses stored web page documents which can be requested, retrieved, and view by the referring user 1010 using a web browser.

The referring user 1010 in response to prompts from the referring site 1030 enters identifying information including one or more of name, address, phone, email, account password, security questions, all alias email accounts. In response to further prompts the referring user 1010 provides a bank account or payment address. In one embodiment, in response to further prompts the referring user 1010 enters the referring user's central depository identifier and optionally all the referring user's merchant identifiers.

A computer program 1031 operating on the referring site's system verifies the inputted information is complete and there are no other accounts with the same identifying information. The referring site 1030 assigns the referring user 1010 a referring user identifier associated with the referring site 1030. The referring user identifier could simply be an email account name, referring user's central depository identifier, referring user's merchant identifier, or could be a number or other randomly generated or user selected identification. The referring site 1030 then stores the referring user account information in a referring user database 1030-1010.

In one embodiment, the referring site 1030 creates a web page document specifically for the referring user 1010, including the referring user's referred hyperlinks posted on the referring site 1030, optionally, the referral rate, the amount owed to the referring user, the merchant identifiers, the central depository identifier, and the referring site fee rate. The referring site 1030 stores referring user web page documents on a server 1032 connected to the internet. The referring user 1010 can access the referring user's web page document by entering the referring user's account information and password on the referring site 1030. In one embodiment, the referring site 1030 sends an identity cookie to the referring user 1010 to identify the referring user 1010 on any subsequent visits to the referring site 1030. The central depository 1040 may perform the functions of the referring site in addition to performing the central depository functions.

Referring Site Auto Advertise Function

This invention specifically encompasses a referring site displaying the auto-advertise hyperlink or the “Advertise this” button for referring users 1010 to click on. Upon activating the auto-advertise hyperlink the referring site 1030 sends the referring user's identity to the central depository 1040 to create a central depository identity and account 1040-1010 for the referring user 1010. The central depository 1040 sends the referring users 1010 identity to the referring site 1030. The referring site 1030 creates a referral hyperlink routed to the central depository 1040 for the referring user. In an alternative embodiment, the central depository creates a referral hyperlink for the referring user and sends it to the referring site 1030. The referring site 1030 sends the referral hyperlink to the referring user 1010. In an alternative embodiment the merchant 1060 performs the functions described by the central depository in this paragraph.

Receipt of Advertisement from Merchant or Central Depository or Referring Site

The referring user 1010 visits a merchant's site 1060 or a central depository site 1040 and selects which products and/or merchants the referring user 1010 desires to promote. The referring user 1010 has selects which media the referring user 1010 would like to promote the product and/or merchant including as an internet message board post, a social media post, a comment post, or other form of submitting referrals to be displayed on a referring site 1030. Optionally, the referring user 1010 submits to the merchant 1060 or the central depository 1040 the identity of the referring site 1030.

The referring site 1030 receives a referral hyperlink from the referring user 1010, the merchant 1060, or the central depository 1060. A referral hyperlink may be: http://www.EXAMPLE-MERCHANT.com/lcdtv1234.html/cgi-bin/updateandstore.cgi?referring+user=Phyllis&discount=.1&intitial+referral+fee=.05&type=c&central+payment+depository=EXAMPLE-CENTRAL-DEPOSITORY.com

The link contains the following information. The routing instructions are to the merchant's product or “www.EXAMPLE-MERCHANT.com/lcdtv1234.” The link contains the referring user identity or “Phyllis.” The link contains a discount for the referred user of “.1.” The link contains the identity of the referral rate of “.05” The link contains the identity of the merchant: “EXAMPLE-MERCHANT.” The link contains the identity of the product: “lcdtv1234.” The link contains the optional identity of the payment depository, “EXAMPLE-CENTRAL-DEPOSITORY”

In one embodiment, the referring site 1030 receives images, video, or text associated with the link from the referring user 1010, the merchant 1060, or the central depository 1040. The referring site 1030 receives the images, video, or text from the referring user 1010 input. The referring site 1030 may receive the images, video, or text from the merchant 1060. The referring site 1030 accesses the merchant server 1062 requesting the associated video, text, and/or images. The merchant server 1062 accesses the text, video, and image database 1060-1085 contained on the merchant's system. The merchant 1060 sends to the referring site 1030 the video, text, and/or image. In one embodiment, upon request from the referring user 1010 the merchant 1060 sends to the referring site 1030 the associated video, text and/or image with the referral hyperlink.

The referring site 1030 may receive the images, video, or text from the central depository 1040. The referring site 1030 accesses the central depository server 1042 requesting the associated video, text, and/or images. The central depository server 1042 accesses the text, video, and image database 1040-1085 contained on the central depository's system. The central depository 1040 sends to the referring site 1030 the video, text, and/or image. In one embodiment, upon request from the referring user 1010 the central depository 1040 sends to the referring site 1030 the associated video, text and/or image with the referral hyperlink.

Information Received from Merchant and then Sent to Central Depository

In one embodiment, the merchant 1060 sends the paid referral hyperlink to the referring site 1030 via electronic message. The merchant 1060 sends the referring site central depository or merchant identifier, the referral rate at the time of sending, the discount rate that the referring site 1030 is entitled to give referred users 1020 that click on the referral hyperlink at time of sending, the merchant identity, the product identity to the referring site 1030 via electronic message. Optionally, the merchant 1060 sends an additional discount rate associated with all referred users 1020. The referring site 1030 stores the information received from the merchant 1060 on a database connect to the referring site's system 1034. The referring site then adds the referral hyperlink to the referring site.

The referring site 1030 may send the discount associated with the referring site and/or referring user, the referring site identity, optionally the referring user identity, the referral rate, the central depository identity, the merchant identity, the identity of the product, the specific web-address of the referred item to the central depository 1040. The central depository 1040 creates a referring site account 1040-1030 on the central depository's database 1044 and stores the discount associated with referring site, the referring site identity, the referral rate, the central depository identity, the merchant identity, the identity of the product, the specific web-address of the referred item information to the merchant 1060 with the referring sites account 1040-1030. The central depository 1040 creates a referring user account 1040-1010 on the merchant's database 1044 containing this information and the referring user identity, referral rate, discount, and posting fee rate. The central depository 1040 stores this information with the referring user account 1040-1010.

In an additional, embodiment, the referring site 1030 sends this information to the central depository 1040 after activation of the referral hyperlink. In this embodiment, the referring site 1030 also sends the discounts associated with the referred user 1020 and the referred user 1020 identity. The discount associated with the referred user includes the discount the referring site 1030 was entitled to give the referred user 1020 by clicking on the referral hyperlink, and any other discounts for the merchant 1060 the referred user has accumulated. In this embodiment, the referring site 1030 receives from the merchant 1060 all discounts the referred user 1020 has accumulated and the referring site 1030 sends the total discount for the referred user 1020 to the central depository 1040.

Information Received from Central Depository and then Sent to Merchant

In one embodiment, the central depository 1040 sends the paid referral hyperlink to the referring site 1030 via electronic message. The central depository 1040 sends the referring site central depository or merchant identifier, the referral rate at the time of sending, the discount rate that the referring site 1030 is entitled to give referred users 1020 that click on the referral hyperlink at time of sending, the merchant identity, the product identity to the referring site 1030 via electronic message. Optionally, the central depository 1040 sends an additional discount rate associated with all referred users 1020. The referring site 1030 stores the information received from the central depository 1040 on a database connect to the referring site's system 1034. The referring site then adds the referral hyperlink to the referring site.

The referring site 1030 may send the discount associated with the referring site, the referring site identity, the referral rate, the central depository identity, the merchant identity, the identity of the product, the specific web-address of the referred item to the merchant 1060. The merchant 1060 creates a referring site account 1060-1030 on the merchant's database 1064 containing the discount associated with referring site, the referring site identity, the referral rate, the central depository identity, the merchant identity, the identity of the product, the specific web-address of the referred item information to the merchant 1060. The merchant 1060 creates a referring site account 1060-1030 on the merchant's database 1064 containing this information. The merchant 1060 stores this information with the referring site account 1060-1030.

The referring site 1030 may send this information to the merchant 1060 after activation of the referral hyperlink. The referring site 1030 also sends the discounts associated with the referred user 1020 and the referred user 1020 identity. The discount associated with the referred user includes the discount the referring site 1030 was entitled to give the referred user 1020 by clicking on the referral hyperlink, and any other discounts for the merchant 1060 the referred user has accumulated. The referring site 1030 receives from the central depository 1040 all discounts the referred user 1020 has accumulated and the referring site 1030 sends the total discount for the referred user 1020 to the merchant 1060.

Parsing, Alteration, and Display of Referral Hyperlinks or Advertisements.

Prior to posting a link and after receiving the input with instructions to display the referral hyperlink from the referring user 1010, the referring site 1030 executes a computer program 1031 to search the inputted post looking for key elements that indicate the post is a referral hyperlink. A computer program 1031 operating on the referring site's system looks for http:// or www or other identifying information to indicate that the post is a paid referral post.

Following receipt from the referring user 1010, the merchant 1060, or a central depository 1040 of a referral hyperlink, a computer program 1031 operating on the referring site's system parses the referral hyperlink to determine identity of merchant, the web address, optionally, the referring user merchant identifier, referring user central depository identifier, the referral rate, the discount rate, and/or the referring user referring site identifier. Optionally, the referring site 1030 parses the link and receives instructions to download pictures, text, or video from the merchant 1060 or central depository 1040. Further, the referring site 1030 parses the link to determine if the identity of the referring site 1030 has been included. If the referral hyperlink has been encrypted, the referring site 1030 accesses the encryption listing 1030-1070 contained in the referring site database 1034. A computer program 1031 operating on the referring site's system decrypts the referral hyperlink. The computer program 1031 then parses the link.

If the referring site merchant identifier or central depository identifier has not been included in the referral hyperlink, then a computer program 1031 operating on the referring site's system accesses the format listing 1030-1075 contained in the referring site's database 1034 to determine the proper format for the referral hyperlink. In the event that the referring site 1030 does not have format instructions for the central depository format or the merchant format, the referring site 1030 sends an electronic message requesting format instructions to the central depository 1040 or the merchant 1060. The central depository 1040 or merchant 1060 sends the format instructions to the referring site 1030. The referring site 1030 stores the format instructions in a database connected to the referring site's system 1034 with the format listing 1030-1075.

A computer program 1031 operating on the referring site's system then adds the referring site merchant identifier or central depository identifier to the referral hyperlink in the appropriate place as determined by the format. The computer program follows the instructions of the merchant 1060 or central depository 1040 and automatically adds the identity of the referring site 1030 to the referral hyperlink. For a merchant direct referral hyperlink, the original unaltered referral hyperlink may be as follows:

http://www.EXAMPLE-MERCHANT.com/lcdtv1234.html/cgi-bin/updateandstore.cgi?referring+user=Phyllis&discount=.1&intitial+referral+fee=.05&type=c&central+payment+depository=EXAMPLE-CENTRAL-DEPOSITORY.com

The link contains the following information. The routing instructions are to the merchant's product or “www.EXAMPLE-MERCHANT.com/lcdtv1234.” The link contains the referring user identity or “Phyllis.” The link contains a discount for the referred user of “.1.” The link contains the identity of the referral rate of “.05” The link contains the identity of the merchant: “EXAMPLE-MERCHANT.” The link contains the identity of the product: “lcdtv1234.” The link contains the optional identity of the payment depository, “EXAMPLE-CENTRAL-DEPOSITORY.” While the direct to merchant link is illustrated above, links may be routed through the central depository.

Following parsing and alteration, the referral hyperlink may appear as follows: http://www.EXAMPLE-MERCHANT.com/lcdtv1234.html/cgi-bin/updateandstore.cgi?referring+user=Phyllis&referring+site=tvmagazine&discount=.1&intitial+referral+fee=.05&type=c&central+payment+depository=EXAMPLE-CENTRAL-DEPOSITORY.com

The link contains the added referring site identity or “tvmagazine,” which was added by the referring site's computer program 1031. By adding the referring site 1031 to the referral hyperlink the merchant 1060 is able to determine the appropriate referring site merchant identifier so the merchant 1060 can pay the referring site 1030 a posting fee. While the direct to merchant link is illustrated above, links may be routed through the central depository.

In one embodiment if the referring site 1030 desires to receive a posting fee, the posting fee amount is added to the referral hyperlink. The posting fee would be a percentage of the referring user's 1010 fee. The altered referral hyperlink may be as follows: http://www.EXAMPLE-MERCHANT.com/lcdtv1234.html/cgi-bin/updateandstore.cgi?referring+user=Phyllis&referring+site=tvmagazine&discount=.1&intitial+referral+fee=.05&posting+fee=.35&type=c&central+payment+depository=EXAMPLE-CENTRAL-DEPOSITORY.com

The referral hyperlink contains the added posting fee value of 0.35 or 35% of the fee paid to the referring user 1010. This means that 35% of the fee paid to the referring user 1010, the merchant pays to the referring site 1030.

In one embodiment, if the referring site 1030 desires to receive the referring fees from a payment depository 1050 the referring site 1030 alters the referral hyperlink to include the identifier of the payment depository. The referring site 1030 gives the merchant 1060 or the central depository 1040 the payment identification of the payment depository 1050 when creating a merchant account 1060-1030 or a central depository account 1040-1030. The altered referral hyperlink may be as follows: http://www.EXAMPLE-MERCHANT.com/lcdtv1234.html/cgi-bin/updateandstore.cgi?referring+user=Phyllis&referring+site=tvmagazine&discount=.1&intitial+referral+fee=.05&posting+fee=.35&type=c&central+referring+user+payment+depository=EXAMPLE-CENTRAL-DEPOSITORY.com&referring+site+payment+depository=EXAMPLE-PAYMENT-DEPOSITORY-2.COM

The following information “EXAMPLE-PAYMENT-DEPOSITORY-2.COM” or referring site 1030 payment depository 1050 is automatically added to the hyperlink by the referring site 1031 computer program. Additional, the computer 1031 operating on the referring site's system, runs a program to alter the referral hyperlink to distinguish between the referring user payment depository and referring site payment depository. The computer 1031 operating on the referring site's system does this by changing the central payment depository category to referring user payment depository category and adding the referring site payment depository category and value. This process provides the merchant 1060 with instructions to pay the referring site 1030 a posting fee via the referring site payment depository or“EXAMPLE-PAYMENT-DEPOSITORY-2.COM.” While the direct to merchant link is illustrated above, links may be routed through the central depository.

In one embodiment, the referring site 1030 alters the referral hyperlink to include a discount associated with the referring site 1030. In this embodiment the referring site 1030 can offer discounts to referred users 1020 for visiting the referring site 1030 and clicking on referral hyperlinks. The referring site 1030 agrees with merchant 1060 to offer a discount on merchant's products. A referring user 1010 then inputs the referral hyperlink for the specific merchant 1060, which has entered an agreement with the referring site 1030 to allow the referring site 1030 to add an additional discount. A computer program 1031 operating on the referring site's system then adds the referring site discount to the referral hyperlink in the appropriate place as determined by the format listing 1030-1075. The computer program follows the instructions of the merchant 1060 or central depository 1040 contained in the format listing 1030-1075 and automatically adds the referring site discount 1030 to the referral hyperlink. The hyperlink including the referring site discount may be as follows:

http://www.EXAMPLE-MERCHANT.com/lcdtv1234.html/cgi-bin/updateandstore.cgi?referring+user=Phyllis&referring+site=tvmagazine&discount=.1&intitial+referral+fee=.05 &referring+site+discount=.05 &posting+fee=.35 &type=c&central+referring+user+payment+depository=EXAMPLE-CENTRAL-DEPOSITORY.com&referring+site+payment+depository=EXAMPLE-PAYMENT-DEPOSITORY-2.COM

The category “referring+site+discount” and the value 0.05 or 5% have been included in the referral hyperlink. Upon activation the merchant receives the discount information. The merchant automatically updates and stores the discounts with the referred users account 1060-1020. The merchant 1060 processes the discounts upon payment.

The central depository may store the discounts. The original unaltered hyperlink may appear as follows: http://www.EXAMPLE-CENTRAL-DEPOSITORY.com/cgi-bin/routingstorage.cgi?name=George+Beighley&Discount=.1&intitial+referral+fee=.005&central+payment+depository=CPD&URL=EXAMPLE-MERCHANT.com/lcdtv1234.html

The hyperlink includes the following: address of the central depository 1040; identification of CGI base directory; routing storage program identification; question mark to transfer information; referring user 1010 identity; discount rate for referred user offered by merchant 1020; initial referral fee identity of payment depository 1050; web address of the referred product page, which the central depository 1040 transfers the referred user 1020 to following the automatic update of the referral information by the central depository 1040.

The central depository receives the additional referring site discount when the referred user 1020 activates the referral hyperlink. The central depository stores this information with the referred user account 1040-1020, the referring party account 1040-1030 or 1040-1010. In one embodiment the merchant 1060 sends the central depository 1040 notice that the referring party 1030, 1010 is entitled to an additional discount using the referring site discount variable insertion process. In a second embodiment, the central depository 1040 sends the merchant 1060 notice of an additional discount for the referring party 1030, 1010 via electronic transfer e.g. email or GET message. The merchant 1060 sends a confirmation message to the central depository 1040 and the referring party's account 1040-1010, 1040-1030 is updated to reflect the ability to have an added discount using the referring site discount variable insertion process. The central depository 1040 may send the merchant 1060 the entire discount information associated with all the discounts the referred user has accumulated without asking for confirmation of the additional discount.

The hyperlink following the process would appear as follows: http://www.EXAMPLE-CENTRAL-DEPOSITORY.com/cgi-bin/routingstorage.cgi?name=George+Beighley&Discount=.1&intitial+referral+fee=.005&referring+site+discount=.05&central+payment+depository=CPD&URL=EXAMPLE-MERCHANT.com/lcdtv1234.html

The category “referring+site+discount” and the value 0.05 or 5% have been included in the referral hyperlink. Upon activation by the referred user 1020, the central depository 1040 automatically updates and stores the referred user's account to reflect the additional discount on a database connected to the central depository's system 1040-1020. The central depository 1020 sends the referred user's discount information to the merchant 1060. The merchant 1060 receives the discount information from the central depository 1040. The merchant 1060 automatically updates and stores the discount information with the referred user's merchant account 1060-1020. The merchant 1060 processes the discounts prior to purchase.

The referring site 1030 and the merchant 1060 agree to update the referring site's 1030 merchant discount the referring site 1030 is entitled to give referred users 1020. The merchant updates the referring sites discount rate and sends the updated rate to the central depository. Second, the referring site 1030 and the merchant 1060 agree that the referring site 1030 can add an additional discount on to certain or all items associated with the merchant using the variable insertion process. The referring site 1030 selects the items for additional discount and adds the additional referring site variable discount to the referral hyperlink.

The referring site 1030 may add a disclaimer prior to displaying the referral hyperlink to referred users 1020. A computer 1031 operating on the referring site's system runs a computer program to search the disclaimer listing 1030-1080 contained on the referring site database 1034 to find the disclaimer associated with the particular merchant 1060. Optionally, the merchant 1060 or the central depository 1040 sends the disclaimer to the referring site 1030 when the referring site 1030 creates a merchant account 1060-1030 or central depository account 1040. The referring site 1030 may send a request to the merchant 1060 prior to displaying the referral hyperlink for the necessary disclaimer. The merchant 1060 sends the disclaimer to the referring site 1030. Alternatively, the referring site 1030 sends a request to the central depository 1040 prior to displaying the referral hyperlink for the necessary disclaimer. The central depository 1040 sends the disclaimer to the referring site 1030. The disclaimer disclaims the merchant 1060, the central depository, and/or the referring site 1030 from any liability resulting from misrepresentations by the referring user regarding the products or merchants.

The disclaimer can contain the language informing the user of the status of the referring user 1030 as a paid endorser and that any contents not specifically made by the merchant 1060 or central depository 1040 regarding the product or merchant could be considered false and untrue. Further, In one embodiment, the disclaimer can provide a hyperlink to a page where the referred user 1020 can view accurate statements about the product and report abuse, fraudulent, or misleading remarks by the referring user 1010.

The disclaimer language could resemble the following:

“The referring user is a PAID ENDORSER. Any statements, representations, warranties, or typical experiences made about the product, central depository, or merchant not specifically disclosed on the merchant's website, www.EXAMPLE-MERCHANT.com, may be FALSE and NOT ACCURATE. The merchant, referring site, and central depository do not warrant, represent, or endorse any comments made by the PAID ENDORSER not specifically disclosed on the merchant's web page. To report fraudulent, or misleading advertising please notify the referring site at SAFEADS@referringsite.com, SAFEADS@centraldepository.com, or SAFEADS@example-merchant.com.

The referring site 1030 then searches a database 1034 connected to the referring site's system to determine if the referring site 1030 has a referring site merchant account 1030-1060 with the merchant 1060. If not, then the referring site 1030 sends a request to the merchant 1060 to create an account 1060-1030 via electronic message. The referring site 1030 receives instructions from the merchant 1030 in the form of electronic message including the data needed to create an account 1060-1030 and the referring site 1030 receives format instructions 1075 for a referral hyperlink. The referring site 1030 submits required data about the referring site 1030 to the merchant 1060 to create a referring site merchant account 1060-1030. The merchant 1060 creates a referring site merchant account 1060-1030 stored on a database 1064 contained on the merchant's system.

Monitoring Traffic

The referring site 1030 monitors the number of times that the referral hyperlink is activated by referred users 1020. The referring site 1030 monitors the number of times the referral hyperlink is activated by monitoring the outgoing traffic of the referring site 1030. The referring site 1030 displays the number of activations and number of views of the referring users post on the referring user's account 1030-1010. The referring site 1030 creates a web document with the referral success statistics and views for the referring user 1010 and stores this web document on a server 1032 connected to the referring site's system and the internet. The referring site 1030 automatically updates and stores the web page document and the referring user account 1030-1010 upon every view or activation of the referral hyperlink. The referring site 1030 demands payment from the merchant 1060 of a posting fee or impression fee. In one embodiment, the referring site 1030 demands payment on behalf of the referring user 1010 for a click fee associated with every activation of the referral hyperlink.

The referring site 1030 may demand payment from the merchant 1060 for every impression or view of the referring user's post containing the referral hyperlink. The referring site 1030 sends the merchant 1060 notice of the number of views of the referring user's post containing the referral hyperlink. The referring site 1030 receives payment for every view or impression from the merchant. In one embodiment, the referring site 1030 sends the central depository 1040 information about the number of views of the referral hyperlink posted by the referring user 1010.

Payment

A referred user 1020 views the referring user's post on the referring site 1030. The referred user activates the referral hyperlink associated with the referring user 1010 and is automatically transferred to the merchant's web page or central depository's web page. In one embodiment, the information contained in the query sting of the URL in the referral hyperlink can be displayed in the form of a dynamic web page operating on the merchant system 1060, which contains the above information.

Upon receiving this information, the merchant 1060 automatically parses the information to determine the product identification, the identifier of the referring site's account with the merchant 1060-1030, the identity of the referring user's account with the merchant 1060-1010, the referral rate, the discount rate. The merchant 1060 automatically updates and stores this information on databases connected to the merchant's system 1064. The merchant stores the referring user 1010 with the associated referring site 1030 information on a database 1060-1030 connected to the merchant's system.

If the referral hyperlink is encrypted the merchant 1060 decrypts the referral hyperlink. The merchant 1060 accesses the encryption listing 1060-1070 contained on the merchants database 1064 to find decryption information. The merchant 1060 decrypts the referral hyperlink. Then the merchant 1060 parses the decrypted referral hyperlink. The merchant 1060 then automatically updates and stores the referral information with the referring user account 1060-1010, the referring site account 1060-1030, the payment depository account 1060-1050, and optionally the central depository account 1060-1040. The merchant 1060 pays the referring site 1030 a posting fee. The merchant 1060 pays the referring site 1030 using any payment method.

The merchant 1060 pays the referring user 1010 a referral fee inclusive of the following possible payment schemes: pay per sale, pay per click, variable referral rate, and pay per impression. The merchant 1060 pays the referring user 1010 using any payment method.

Optionally, the merchant 1060 pays the referring site 1030 with instructions to pay the referring user 1010. The merchant 1060 can pay the referring site 1030 for all of the referring user's referrals associated with the referring site 1030. The referring site 1030 then pays the individual referring users 1010. In one embodiment, the referring site 1030 waits until a certain amount of revenue has accumulated and then pays the referring user 1010. The referring site 1030 pays the referring user 1010 using any payment method.

Alternatively, the referred user 1020 may be transferred to the central depository 1040 and then routed by the central depository 1040 to the specific merchant 1060. Upon receiving the referred user 1020 and referral information from the central depository 1040, the merchant 1060 pays the referring site 1030 a posting fee and the referring user 1010 a referral fee, using any payment method. The referred user 1020 may receive a machine readable identification card 1022 from the central depository 1040 or merchant 1060 to process discounts for offline purchases.

Payment Depository Option

In one embodiment, the merchant 1060 pays the payment depository 1050 for all referring users 1010 received over a given time period, or per certain number of transactions with a common payment depository 1050 or directly to the referring site 1030. The merchant 1060 may pay the payment depository 1050 or referring site 1030 when the total number of referring users 1010 associated with the payment depository 1050 or referring site 1030 has reached a minimum level. This allows the payment depository 1050 or referring site 1030 to collect payment for massive amounts of referring users 1010 and prevents the merchant 1060 from having to pay each referring user 1010 individually. This saves the referring user 1010 and the merchant 1060 processing fees by grouping the transactions into one bulk transaction to the payment depository 1050 or referring site 1030. The payment depository function 1050 allows referring users 1010 to post on various websites and receive their entire referral fee earnings in one central location. The referring site 1030 function allows referring user 1010 the ease of keeping all her earnings with a particular site in the same location.

The payment depository 1050 or referring site 1030 then stores the amount owed to the referring user 1010 in the referring user's payment depository account 1050-1010 or an account with the referring site 1030-1010. The payment depository 1050 or referring site 1030 displays all the successfully activated referral hyperlinks and the amount owed from the merchant 1060. The payment depository 1050 or referring site 1030 displays if payment has been made to the payment depository 1050 or referring site 1030 by the merchant. The payment depository 1050 charges a processing fee for making the transaction. Alternatively, the referring site 1030 charges a posting fee for processing the transaction. The referring user 1010 can request payment at any time and pays the processing fee.

In the one embodiment, upon reaching a certain amount collected from all merchants 1060, the payment depository 1050 or the referring site 1030 pays the referring user 1010 using available payment methods. The payment depository 1050 may be used to pay referring sites 1030, which operate a great many different commonly owned sites. The payment depository 1050 performs similar functions outlined in this section for referring users 1010 but for referring sites 1030.

If a referring user 1010 does not have an account with the payment depository 1050 that is used by the referring site 1030, the referring site 1030 submits referring user identification and payment data to the payment depository 1050. Optionally, the referring user 1010 enters the payment information and creates an account with the payment depository 1050. Until the funds are claimed by the referring user 1010, the payment depository 1050 stores all unclaimed funds in a general bank account 1050-1090 and the amount owed to the referring user with the referring user's referring site account identifier. When the referring user 1010 creates an account with the payment depository 1050 and logs into the referring user's 1010 referring site account to verify her identity, all referring user owed funds stored in the general bank 1050-1090 account are transferred to the referring user's account 1050-1010.

Search Engine Referring Site Embodiment

In some embodiments, the referring site 1030 uses a crawl program to acquire referral links to merchants 1060 or the central depository 1040. A search engine referring site 1030 acquires referral hyperlinks to merchant websites 1060 offering discounts or referral fees using a crawl process. The crawler searches the merchant's website 1060 or the central depository website 1040 for web pages associated with a merchant 1060 who offers discounts or referral fees associated with referring the webpage or item 1060 to other users. In one embodiment the referring site 1030 would add the referring site identifier to the referral hyperlink prior to publishing the link. In another embodiment, the search engine referring site 1030 does not add a referring site identifier and relies on the HTTP_REFERER function of the browser for the merchant to determine the identity of the referring site 1030. The referral fee the search engine referring site and the discount rate the search engine referring site can give referred users for activating the referral hyperlink is determined by the information stored with the referring sites central depository account 1040-1030 or referring sites merchant account 1060-1040. The search engine referring site 1030 displays the referral hyperlink to first users, who if activate the referral hyperlink become referred users 1020. In one embodiment, the search engine referring site 1030 gives priority of display of referral hyperlinks to merchants 1030 who offer the referring site 1030 higher referral rates or discount rates.

In some embodiments, merchants 1060 or a central depository 1040 submit via electronic transfer the referral hyperlink to the search engine referring site 1030. In one embodiment the referring site can alter the referral hyperlink to include the referring site identity. In another embodiment the merchant 1060 or a central depository 1040 adds the referring site identity to the referral hyperlink. The referral fee the search engine referring site and the discount rate the search engine referring site can give referred users for activating the referral hyperlink is determined by the information stored with the referring sites central depository account 1040-1030 or referring sites merchant account 1060-1040. The search engine referring site 1030 displays the referral hyperlink to first users, who if activate the referral hyperlink become referred users 1020.

In this way, search engines and other referring sites can incorporate the discount and referral process disclosed herein in a simplified manner.

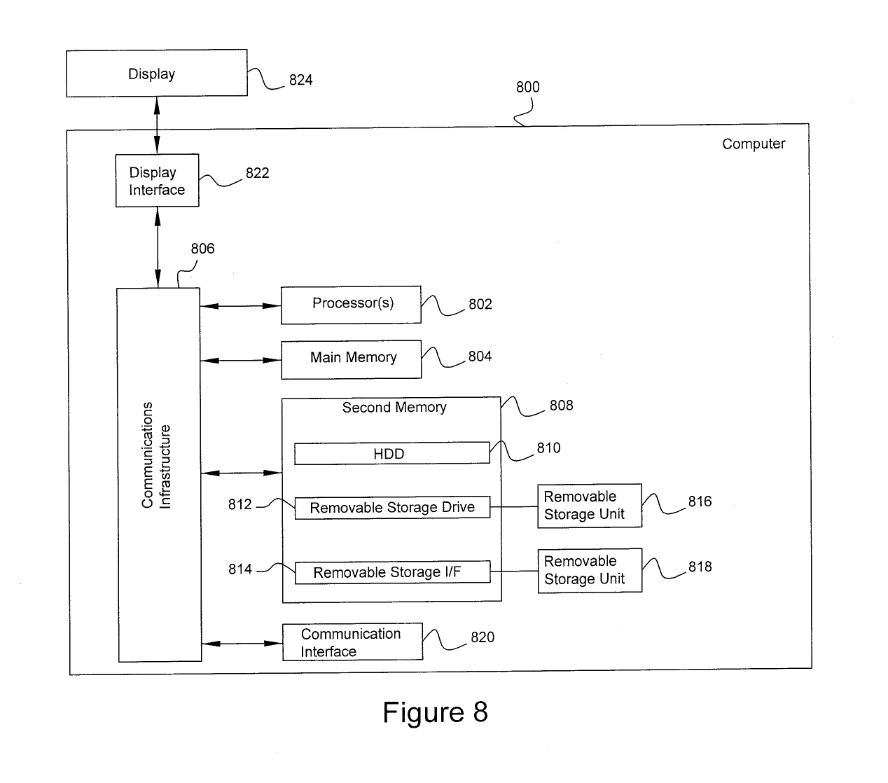

FIG. 8 illustrates one example of an architecture of a computer system 800 in accordance with some embodiments. Computer system 800 may be illustrative of computers 111 or 121, or computers at referring site 130, central depository 140, payment depository 150, or merchant 160, or similar computers in FIG. 9 or 10. As illustrated in FIG. 8, computer system 800 may include one or more processors 802. Each processor 802 is connected to a communication infrastructure 806 (e.g., a communications bus, cross-over bar, or network). Computer system 800 may include a display interface 822 that forwards graphics, text, and other data from the communication infrastructure 806 (or from a frame buffer not shown) for display on the display unit 824.

Computer system 800 may also include a main memory 804, such as a random access memory (RAM), and a secondary memory 808. The secondary memory 808 may include, for example, a hard disk drive (HDD) 810 and/or removable storage drive 812, which may represent a floppy disk drive, a magnetic tape drive, an optical disk drive, a memory stick, or the like as is known in the art. The removable storage drive 812 reads from and/or writes to a removable storage unit 816. Removable storage unit 816 may be a floppy disk, magnetic tape, optical disk, or the like. As will be understood, the removable storage unit 816 may include a computer readable storage medium having tangibly stored therein (embodied thereon) data and/or computer software instructions, e.g., for causing the processor(s) to perform the operations of the above-described computer-implemented methods for electronic referral.

In alternative embodiments, secondary memory 808 may include other similar devices for allowing computer programs or other instructions to be loaded into computer system 800. Secondary memory 808 may include a removable storage unit 818 (which may be similar to removable storage unit 816) and a corresponding interface 814, which may be similar to removable storage drive 812. Examples of such removable storage units include, but are not limited to, USB or flash drives, which allow software and data to be transferred from the removable storage unit 818 to computer system 800.

Computer system 800 may also include a communications interface 820. Communications interface 820 allows software and data to be transferred between computer system 800 and external devices such as a server. Examples of communications interface 820 may include a modem, Ethernet card, wireless network card, a Personal Computer Memory Card International Association (PCMCIA) slot and card, or the like. Software and data transferred via communications interface 820 may be in the form of signals, which may be electronic, electromagnetic, optical, or the like that are capable of being received by communications interface 820. These signals may be provided to communications interface 820 via a communications path (e.g., channel), which may be implemented using wire, cable, fiber optics, a telephone line, a cellular link, a radio frequency (RF) link and other communication channels.

In this document, the terms “computer program medium” and “computer readable storage medium” refer to media such as media at removable storage drive 812, or a hard disk installed in hard disk drive 810, or removable storage unit 816. These computer program products provide software to computer system 800. Computer programs (also referred to as computer control logic) may be stored in main memory 804 and/or secondary memory 808. Computer programs may also be received via communications interface 820. Such computer programs, when executed by a processor, enable the computer system 800 to perform the features of the methods discussed herein. For example, main memory 804, secondary memory 808, or removable storage units 816 or 818 may be encoded with computer program code (instructions) for performing the above-described computer-implemented methods for electronic referral.

In an embodiment implemented using software, software instructions may be stored in a computer program product and loaded into computer system 800 using removable storage drive 812, hard drive 810, or communications interface 820, for example. In other words, the computer program product, which may be a computer readable storage medium, may have instructions tangibly embodied thereon. The software instructions, when executed by a processor 802, cause the processor 802 to perform the functions of (operations of) methods described herein. In another embodiment, the method may be implemented primarily in hardware using, for example, hardware components such as a digital signal processor comprising application specific integrated circuits (ASICs). In yet another embodiment, the method is implemented using a combination of both hardware and software.

While examples of various embodiments have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A computer-implemented method performed at a computer of a merchant, the method comprising:
displaying a list of one or more items available for referral, wherein each item is a product offered by the merchant or associated with the merchant;
receiving a first message from a referring party indicating that the referring party desires to refer a selected item from the list;
creating a referring party account, at the computer of the merchant, for the referring party;
creating a referral hyperlink for referral of the selected item, wherein the referral hyperlink includes first data identifying the selected item.

2. The method of claim 1, wherein the hyperlink further includes at least one of second data identifying the referring party and third data identifying a web address of the merchant.

3. The method of claim 1, further comprising sending the hyperlink to the referring party.

4. The method of claim 3, further comprising updating the referring party account to reflect creation of the referral hyperlink.

5. The method of claim 1, wherein the referring party is one of a referring site and an administrator of the referring site.

6. The method of claim 1, wherein the referring party is a referring user.

7. The method of claim 1, wherein the referral hyperlink further includes second data specifying a discount, wherein the discount is available to the referred user if the referred user activates the hyperlink, the method further comprising:
receiving a second message from a referred user upon activation of the referral hyperlink by the referred user;
automatically parsing the second message to identify the first and second data;
updating the referring party account, based on the first data, to reflect activation of the referral hyperlink; and
updating a referred user account at the computer of the merchant, based on the second data, to indicate that the discount is redeemable by the referred user; and
sending to the referred user a web page of the website.

8. The method of claim 7, further comprising paying the referring party at least in part for referral of the selected item.

9. The method of claim 7, further comprising:
sending a payment, at least in part for referral of the selected item, to a payment depository of information related to referrals; and
instructing the payment depository to forward to the payment to the referring party.

10. The method of claim 9, further comprising sending other payments to the payment depository for referrals of other items, offered by or associated with the merchant or other merchants, that are selected.

11. The method of claim 7, further comprising paying the referring party based on referral of the selected item and a variable referral rate, the method further comprising:
varying the variable referral rate;
storing the varied referral rate at the computer of the merchant; and
notifying the referring party of the varied referral rate.

12. The method of claim 1, further comprising:
sending information associated with the referring party account to a central depository of referral information; and
sending the referral hyperlink to the referring party, wherein the referral hyperlink further includes second data identifying a web address of the central depository.

13. The method of claim 1, further comprising displaying a referral rate associated with each item, wherein the referral rate is payable to the referring party for referral of said item.

14. The method of claim 1, further comprising:
receiving a second message from the referred user upon activation of the referral hyperlink by the referred user;
automatically parsing the second message to identify the first and second data; and
sending the first data to the central depository.

15. A method comprising:
receiving a first electronic message from a first party who desires to obtain discounts from a merchant based on referrals of items offered by or associated with the merchant, the first message including first identification information for identifying the first party;
creating, for the first party, a referred user account at a computer of the merchant, the referred user account including discount information;
receiving a second electronic message upon activation of a referral hyperlink by the first party, the second message including:
first data identifying a second party that sent the referral hyperlink to the first party,
second data identifying one or more of the items, and
third data specifying a discount;
parsing the second message to determine the first, second, and third data;
receiving a third electronic message associating the first party with the referred user account; and
updating the referred user account to indicate that the discount is redeemable by the first party, that the referral hyperlink was sent by the second party, and that the items identified by the second data were referred to the first party.

16. The method of claim 15, wherein the second electronic message is received from the first party.

17. The method of claim 15, further comprising sending, to the first party, second identification information for identifying the referred user account.

18. The method of claim 17, wherein sending includes sending a machine readable card to the first party, the card having stored thereon the second identification information.

19. A computer-implemented method performed at a computer of a merchant, the method comprising:
receiving, from a central depository of information related to referrals, information associated with a first referred user account, wherein the first referred user account is stored at the central depository;
creating at the computer of the merchant, based on the received information, a second referred user account including discount information associated with referral of one or more products offered by or associated with the merchant;
receiving, from the central depository, a message after activation of a referral hyperlink by a referred user, the message including first data identifying the referred user and second data specifying a discount offered to the referred user for activation of the hyperlink; and
updating the discount information of the second referred user account to indicate that the discount is redeemable by the referred user.

20. The method of claim 19 further comprising:
varying a discount rate associated with at least one of the referred user and a referring party that presented the hyperlink to the referred user;
storing the varied discount rate at at least one of the second referred user account and a referring party account, wherein the referring party account is located at the computer of the merchant; and
sending the varied discount rate to the central depository.
